(19) United States
(12) Patent Application Publication
(10) Pub. No.: US 2017/0024657 A1
(43) Pub. Date: Jan. 26, 2017

(54) FUZZY AUTOSUGGESTION FOR QUERY PROCESSING SERVICES

(71) Applicant: YP LLC, Tucker, GA (US)

(72) Inventors: Sudheer Sahu, Encinitas, CA (US); Guobin He, San Diego, CA (US); Vaibhav Chaudhary, Cupertino, CA (US); Krishna Krishnamaneni, Culver City, CA (US); Deepak Agrawal, Mountain View, CA (US)

(21) Appl. No.: 14/805,320

(22) Filed: Jul. 21, 2015

(51) Int. Cl. G06N 7/02; G06F 17/30

(52) U.S. Cl. CPC G06N 7/02; G06F 17/30864

(57) ABSTRACT

Systems and methods of generating geo-aware fuzzy autosuggestions for a search engine are disclosed. Transmissions received by a server system may be processed, the transmissions indicating characters received via a user interface as user input for a search query to a searching service. Information about a geographical location received by the server system may be processed, and a geographical area may be identified. A data store may be searched with an exact matching method to identify exact matches of the first set of characters with candidate data from the data store for geo-specific suggestions. Fuzzy searching operations may be performed based on the geographical area and the first set of characters. Geo-specific suggestions may be selected based on the fuzzy searching operations and may be transmitted to the end-user device to cause indication as a user-selectable option via the user interface to complete the search query.

### BACKGROUND

Certain embodiments of the present disclosure relate generally to query processing, and in particular to systems and methods for fuzzy autosuggestion systems.

Users sometimes may click wrong buttons on the keyboard or may not remember what a provider name exactly is and they just type something close. The errors in users' input may include wrong characters, wrong word order, etc. There is a need for improvements in systems so that such situations may be addressed. This and other needs are addressed by the present disclosure.

### BRIEF SUMMARY

Certain embodiments of the present disclosure relate generally to query processing, and in particular to systems and methods for fuzzy autosuggestion systems.

In one aspect, a method is provided to generate geo-aware fuzzy autosuggestions for a search engine. A first set of transmissions from an end-user device and received by a server system may be processed, the first set of transmissions indicating a first set of characters that are received via a user interface as user input for a search query to a searching service, where the processing is prior to completion of the search query and prior to entry of one or more additional characters subsequent to the first set of characters. Information about a geographical location received by the server system may be processed. A geographical area may be identified at least partially based on the information about the geographical location. Based at least in part on one or more identifiers for the geographical area, a data store of the server system may be searched with an exact matching method to identify exact matches of the first set of characters with candidate data from the data store for one or more geo-specific suggestions, where each geo-specific suggestion of the one or more geo-specific suggestions corresponds to one or more respective geolocations within the geographical area. Results of the searching may be compared to a results threshold and, consequent to determining that the results threshold is not satisfied, the server system may initiate fuzzy searching of the data store based at least in part on the first set of characters to generate a first set of one or more geo-specific suggestion. A first set of fuzzy searching operations may be performed by the server system based at least in part on the identifiers for the geographical area and the first set of characters, where the first set of fuzzy searching operations is at least partially a function of a number of characters corresponding to the search query. The first set of fuzzy searching operations may include one or a combination of the following. Based at least in part on the number of characters corresponding to the user input for the search query, a first fuzzy matching method may be selected from a plurality of fuzzy matching methods. The data store of the server system may be searched with the first fuzzy matching method to identify non-exact matches of the first set of characters with the candidate data from the data store, and, based at least in part on the non-exact matches, candidate data sets corresponding to the first set of one or more geo-specific suggestions may be selected, where each geo-specific suggestion of the first set of one or more geo-specific suggestions corresponds to one or more respective geolocations within the geographical area. The candidate data sets corresponding to the first set of one or more geo-specific suggestions may be ranked based at least in part on a respective modification distance between each geo-specific suggestion of first set of one or more geo-specific suggestions and the user input for the search query. A second set of candidate data sets corresponding to a second set of one or more geo-specific suggestions may be selected based at least in part on the ranking. At least one geo-specific suggestion of the second set of one or more geo-specific suggestions may be transmitted by the server system to the end-user device to cause indication of the at least one geo-specific suggestion as a user-selectable option via the user interface to complete the search query with the at least one geo-specific suggestion in a search query field for a search engine and/or to submit the at least one geo-specific suggestion to the search engine as a selected search query.

In another aspect, one or more non-transitory, processor-readable media having processor-readable instructions thereon which, when executed by one or more computers or other processing devices of a server system, are provided to cause the server system to perform one or a combination of the following. A first set of transmissions from an end-user device and received by a server system may be processed, the first set of transmissions indicating a first set of characters that are received via a user interface as user input for a search query to a searching service, where the processing is prior to completion of the search query and prior to entry of one or more additional characters subsequent to the first set of characters. Information about a geographical location received by the server system may be processed. A geographical area may be identified at least partially based on the information about the geographical location. Based at least in part on one or more identifiers for the geographical area, a data store of the server system may be searched with an exact matching method to identify exact matches of the first set of characters with candidate data from the data store for one or more geo-specific suggestions, where each geo-specific suggestion of the one or more geo-specific suggestions corresponds to one or more respective geolocations within the geographical area. Results of the searching may be compared to a results threshold and, consequent to determining that the results threshold is not satisfied, fuzzy searching of the data store based at least in part on the first set of characters may be initiated to generate a first set of one or more geo-specific suggestion. A first set of fuzzy searching operations may be performed based at least in part on the identifiers for the geographical area and the first set of characters, where the first set of fuzzy searching operations is at least partially a function of a number of characters corresponding to the search query. The first set of fuzzy searching operations may include one or a combination of the following. Based at least in part on the number of characters corresponding to the user input for the search query, a first fuzzy matching method may be selected from a plurality of fuzzy matching methods. The data store of the server system may be searched with the first fuzzy matching method to identify non-exact matches of the first set of characters with the candidate data from the data store, and, based at least in part on the non-exact matches, candidate data sets corresponding to the first set of one or more geo-specific suggestions may be selected, where each geo-specific suggestion of the first set of one or more geo-specific suggestions corresponds to one or more respective geolocations within the geographical area. The candidate data sets corresponding to the first set of one or more geo-specific suggestions may be ranked based at least in part on a respective modification distance between each geo-specific suggestion of first set of one or more geo-specific suggestions and the user input for the search query. A second set of candidate data sets corresponding to a second set of one or more geo-specific suggestions may be selected based at least in part on the ranking. At least one geo-specific suggestion of the second set of one or more geo-specific suggestions may be transmitted to the end-user device to cause indication of the at least one geo-specific suggestion as a user-selectable option via the user interface to complete the search query with the at least one geo-specific suggestion in a search query field for a search engine and/or to submit the at least one geo-specific suggestion to the search engine as a selected search query.

In yet another aspect, a system to generate geo-aware fuzzy autosuggestions for a search engine is provided. The system may include a server system that includes one or more servers communicatively coupled to one or more network interfaces to facilitate access to a network. The server system may include one or more data stores communicatively coupled to the one or more servers, the one or more data stores storing candidate data for geo-specific suggestions. The one or more servers may perform one or a combination of the following. A first set of transmissions from an end-user device and received by a server system may be processed, the first set of transmissions indicating a first set of characters that are received via a user interface as user input for a search query to a searching service, where the processing is prior to completion of the search query and prior to entry of one or more additional characters subsequent to the first set of characters. Information about a geographical location received by the server system may be processed. A geographical area may be identified at least partially based on the information about the geographical location. Based at least in part on one or more identifiers for the geographical area, a data store of the server system may be searched with an exact matching method to identify exact matches of the first set of characters with candidate data from the data store for one or more geo-specific suggestions, where each geo-specific suggestion of the one or more geo-specific suggestions corresponds to one or more respective geolocations within the geographical area. Results of the searching may be compared to a results threshold and, consequent to determining that the results threshold is not satisfied, fuzzy searching of the data store based at least in part on the first set of characters may be initiated to generate a first set of one or more geo-specific suggestion. A first set of fuzzy searching operations may be performed based at least in part on the identifiers for the geographical area and the first set of characters, where the first set of fuzzy searching operations is at least partially a function of a number of characters corresponding to the search query. The first set of fuzzy searching operations may include one or a combination of the following. Based at least in part on the number of characters corresponding to the user input for the search query, a first fuzzy matching method may be selected from a plurality of fuzzy matching methods. The data store of the server system may be searched with the first fuzzy matching method to identify non-exact matches of the first set of characters with the candidate data from the data store, and, based at least in part on the non-exact matches, candidate data sets corresponding to the first set of one or more geo-specific suggestions may be selected, where each geo-specific suggestion of the first set of one or more geo-specific suggestions corresponds to one or more respective geolocations within the geographical area. The candidate data sets corresponding to the first set of one or more geo-specific suggestions may be ranked based at least in part on a respective modification distance between each geo-specific suggestion of first set of one or more geo-specific suggestions and the user input for the search query. A second set of candidate data sets corresponding to a second set of one or more geo-specific suggestions may be selected based at least in part on the ranking. At least one geo-specific suggestion of the second set of one or more geo-specific suggestions may be transmitted to the end-user device to cause indication of the at least one geo-specific suggestion as a user-selectable option via the user interface to complete the search query with the at least one geo-specific suggestion in a search query field for a search engine and/or to submit the at least one geo-specific suggestion to the search engine as a selected search query.

In various embodiments, the transmitting the at least one geo-specific suggestion of the second set of one or more geo-specific suggestions to the end-user device may be performed prior to entry of additional characters subsequent to the first set of characters. In various embodiments, the user-selectable option may be presented as a type-ahead user-selectable option in the search query field. In various embodiments, the information about the geographical location corresponds to one or a combination of: location information automatically gathered based at least in part on communication of a wireless device component; user-indicated information received via the user interface as indicative of the geographical location for the search query; location information previously associated with one or both of an end-user identifier and an end-user device identifier; and/or location information inferred from the one or more characters corresponding to the search query.

In various embodiments, after entry of the first set of characters, consequent to a time threshold for the server system to transmit geo-specific suggestions being satisfied, a second set of fuzzy searching operations may be performed by the server system based at least in part on the identifiers for the geographical area and the first set of characters, where the second set of fuzzy searching operations is different from first set of fuzzy searching operations. Based at least in part on the second set of fuzzy searching operations, candidate data sets corresponding to a third set of one or more geo-specific suggestions may be selected. At least a second geo-specific suggestion of the third set of one or more geo-specific suggestions may be transmitted by the server system to the end-user device to cause indication of the second geo-specific suggestion as a second user-selectable option via the user interface to complete the search query with the second geo-specific suggestion in the search query field for the search engine and/or to submit the second geo-specific suggestion to the search engine as the selected search query.

In various embodiments, after entry of a second set of characters, the second set of characters including the first set of characters, consequent to a resource threshold for the server system to transmit geo-specific suggestions being satisfied, a third set of fuzzy searching operations may be performed by the server system based at least in part on the identifiers for the geographical area and the second set of characters, where the third set of fuzzy searching operations is different from first set of fuzzy searching operations and the second set of fuzzy searching operations. Based at least in part on the third set of fuzzy searching operations, candidate data sets corresponding to a fourth set of one or more geo-specific suggestions may be selected. At least a third geo-specific suggestion of the fourth set of one or more geo-specific suggestions may be transmitted by the server system to the end-user device to cause indication of the third geo-specific suggestion as a second user-selectable option via the user interface to complete the search query with the third geo-specific suggestion in the search query field for the search engine and/or to submit the second geo-specific suggestion to the search engine as the selected search query.

In various embodiments, a second transmission from the end-user device and received by the server system subsequent to the first set of transmissions may be processed, the second transmission indicating an additional character received via the user interface as user input for the search query to the searching service, where the processing the second transmission is prior to completion of the search query and prior to entry of one or more additional characters subsequent to the additional character. A second set of fuzzy searching operations may be performed by the server system based at least in part on the identifiers for the geographical area, the first set of characters, and the additional character, where the second set of fuzzy searching operations is at least partially a function of a second number of characters corresponding to the first set of characters and the additional character. The second set of fuzzy searching operations may include one or a combination of the following: selecting, based at least in part on the second number of characters, a second fuzzy matching method from the plurality of fuzzy matching methods, the second fuzzy matching method being different from the first fuzzy matching method; and based at least in part on the second set of fuzzy searching operations and the second fuzzy matching method, selecting candidate data sets corresponding to a third set of one or more geo-specific suggestions. At least a second geo-specific suggestion of the third set of one or more geo-specific suggestions may be transmitted by the server system to the end-user device to cause indication of the second geo-specific suggestion as a second user-selectable option via the user interface to complete the search query with the second geo-specific suggestion in the search query field for the search engine and/or to submit the second geo-specific suggestion to the search engine as the selected search query.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the following appended figures.

FIG. 1 is a high-level block diagram of a system, in accordance with certain embodiments of the present disclosure.

FIG. 2 shows a diagram of an architecture stack of the interaction infrastructure, in accordance with certain embodiments of the present disclosure, in accordance with certain embodiments of the present disclosure.

FIG. 3A is a block diagram of a system including one non-limiting example of a client device that corresponds to a mobile communication device, in accordance with certain embodiments of the present disclosure.

FIG. 3B depicts a high-level block diagram of a system for communication routing and tracking, in accordance with certain embodiments of the present disclosure.

FIG. 4 shows a diagram of a portion of the architecture stack of the interaction infrastructure including certain aspects of an application/device layer, an application services system, and a data management system, in accordance with certain embodiments of the present disclosure.

FIG. 5 shows a diagram of another portion of the architecture stack of the interaction infrastructure including certain aspects of the application services system, in accordance with certain embodiments of the present disclosure.

FIG. 6 shows a diagram of another portion of the architecture stack of the interaction infrastructure including certain aspects of a master data management system, in accordance with certain embodiments of the present disclosure.

FIG. 7 shows a diagram of another portion of the architecture stack of the interaction infrastructure including certain aspects of the application services management and master data management layers, in accordance with certain embodiments of the present disclosure.

FIG. 8 shows a diagram of another portion of the architecture stack of the interaction infrastructure including certain aspects of an information orchestration layer, in accordance with certain embodiments of the present disclosure.

FIG. 9 shows a diagram of another portion of the architecture stack of the interaction infrastructure including certain aspects of a content provisioning management system, in accordance with certain embodiments of the present disclosure.

FIG. 10 shows a diagram of another portion of the architecture stack of the interaction infrastructure including certain aspects of a communication management system, in accordance with certain embodiments of the present disclosure.

FIG. 11 illustrates certain aspects of lead routing data flow, in accordance with certain embodiments of the present disclosure.

FIG. 12 shows a diagram of aspects of the communication management system, in accordance with certain embodiments of the present disclosure.

FIG. 13 illustrates an example method of providing for autosuggestion, in accordance with certain embodiments of the present disclosure.

FIG. 14A illustrates a graphical user interface that may be used in implementations, in accordance with certain embodiments of the present disclosure.

FIG. 14B illustrates another graphical user interface that may be used in implementations, in accordance with certain embodiments of the present disclosure.

FIG. 15 illustrates an example method of providing for spellchecking in a geographical area, in accordance with certain embodiments of the present disclosure.

FIG. 16 illustrates an example method of providing for geo-aware search features corresponding to a geographical area, in accordance with certain embodiments of the present disclosure.

FIG. 17 illustrates an example method of providing for autosuggestion query features, in accordance with certain embodiments of the present disclosure.

FIG. 18 is a block diagram that illustrates an example method of indicia gathering, in accordance with certain embodiments of the present disclosure.

FIG. 19 illustrates an example method directed to further features for autosuggestion query features, in accordance with certain embodiments of the present disclosure.

FIG. 20 illustrates an example functional model for assessing, scoring, and ranking suggestions, in accordance with certain embodiments of the present disclosure.

FIG. 21 illustrates an example method of generating fuzzy autosuggestions for a search engine, in accordance with certain embodiments of the present disclosure.

FIG. 22 illustrates an example method of generating geo-aware fuzzy autosuggestions for a search engine following initiation of fuzzy searching, in accordance with certain embodiments of the present disclosure.

FIG. 23 illustrates an example method of fuzzy matching operational dynamics to generate geo-refined fuzzy autosuggestions for a search engine following initiation of fuzzy searching, in accordance with certain embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Certain embodiments according to the present disclosure provide for geo-refined fuzzy autosuggestion search engine services. Geo-refined fuzzy autosuggestion search engine services according to certain embodiments of the present disclosure provide for extensive coverage and optimize user experiences by providing suggestions that are relevant to the input query and that correspond to providers having geolocations proximate to the geolocation of interest to the end-user. Accordingly, certain embodiments provide for technical improvements in autosuggestion search engine services that redound in certain advantages in efficiency, accuracy, and speed that can be passed on to the user in facilitating optimized user experiences. Certain embodiments may eliminate excessive delay in processing candidate data, analyzing candidate data, selecting candidate suggestion data sets in a geo-aware manner, and transferring candidate suggestion data sets to facilitate presentation of candidate suggestions. Certain embodiments result in increased efficiency of processing, analyzing, selecting, and transferring candidate suggestion data sets. Likewise, certain embodiments result in increased accuracy of selected and transferred candidate suggestion data sets. Certain embodiments may optimize user experience by improving accuracy of search result matching, by improving personalization of search results, and by improving efficiency of processing operations whilst optimizing balancing of dynamic constraints and fuzzy matching operational variables.

The technical improvements of certain embodiments according the present disclosure result in optimized user experiences. For example, a couple hundred millisecond time window could negatively impact user experience. Accordingly, certain embodiments may eliminate delay and may process candidate data, analyze candidate data, select candidate suggestion data sets, and transfer candidate suggestion data sets to facilitate presentation of candidate suggestions within time windows less than a couple hundred milliseconds. In various embodiments, the time windows may be approximately 100 ms, 50 ms, and/or less. With some embodiments, an average time window may be approximately 50 ms; in other embodiments, the average time window may be different.

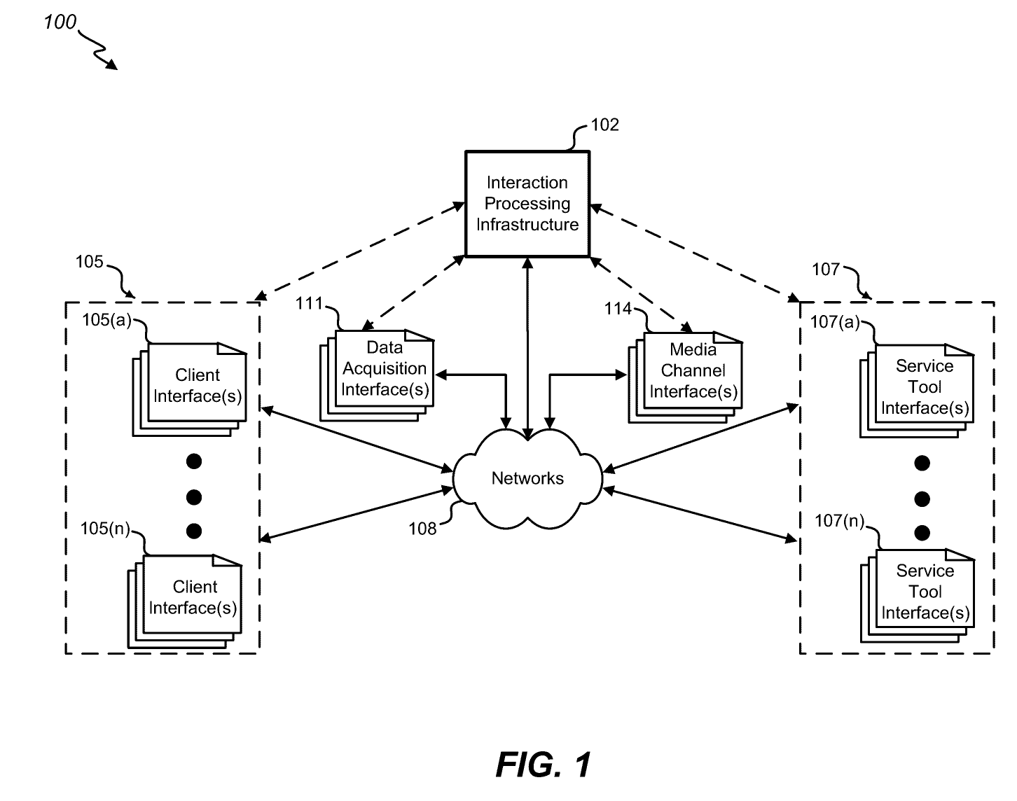

Various embodiments will now be discussed in greater detail with reference to the accompanying figures, beginning with FIG. 1.

FIG. 1 depicts a high-level block diagram of a system 100, in accordance with certain embodiments of the present disclosure. The system 100 may allow for interaction between two or more of an interaction processing infrastructure 102 (sometimes referenced herein as interaction infrastructure 102), client interfaces 105, service tool interfaces 107, data acquisition interfaces 111, and/or media channel interfaces 114. As depicted, components of the system 100 may be communicatively coupled or couplable to one or more networks 108.

The one or more networks 108 may be a suitable means to facilitate data transfer in the system 100 and could include multiple networks and/or network components. In various embodiments, the one or more networks 108 may be implemented with, without limitation, one or more of the Internet, a wide area network (WAN), a local area network (LAN) such as one based on Ethernet, Token-Ring and/or the like, a wireless network (e.g., a network operating under Bluetooth®, any of the Institute of Electrical and Electronics (IEEE) 802.11 suite of protocols, and/or any other wireless protocol), a wireless local area network (WLAN), a cellular network, such as through 4G, 3G, GSM (Global System for Mobile Communications), etc., another wireless network, a gateway, a public switched telephone network (PSTN), and/or any other appropriate architecture or system that facilitates the communication of signals, data, and/or message. In various embodiments, the one or more networks 108 may transmit data using any suitable communication protocol(s), such as, without limitation, TCP/IP (transmission control protocol/Internet protocol), SNA (systems network architecture), IPX (Internet packet exchange), AppleTalk, and/or the like. In various embodiments, the one or more networks 108 and its various components may be implemented using hardware, software, and communications media such wires, optical fibers, microwaves, radio waves, and other electromagnetic and/or optical carriers; and/or any combination of the foregoing and/or the like. In some embodiments, the network 108 may include a telephone network that may be circuit switched, package switched, or partially circuit switched and partially package switched. For example, the telephone network may partially use the Internet to carry phone calls (e.g., through VoIP).

The interaction processing infrastructure 102 may facilitate searching of one or more information repositories in response to data received over the one or more networks 108 from any one or combination of the interfaces. In various embodiments, the interaction processing infrastructure 102 may include a set of devices configured to process, transform, encode, translate, send, receive, retrieve, detect, generate, compute, organize, categorize, qualify, store, display, present, handle, or use information and/or data suitable for the embodiments described herein. For example, servers of the infrastructure 102 may be used to store software programs and data. Software implementing the systems and methods described herein may be stored on storage media in the servers. Thus, the software may be run from the storage media in the servers. In some embodiment, software implementing the systems and methods described herein may be stored on storage media of other devices described herein.

The interaction processing infrastructure 102 may be implemented in or with a distributed computing and/or cloud computing environment with a plurality of servers and cloud-implemented resources. The interaction processing infrastructure 102 may include processing resources communicatively coupled to storage media, random access memory (RAM), read-only memory (ROM), and/or other types of memory. The interaction processing infrastructure 102 may include various input and output (I/O) devices, network ports, and display devices.

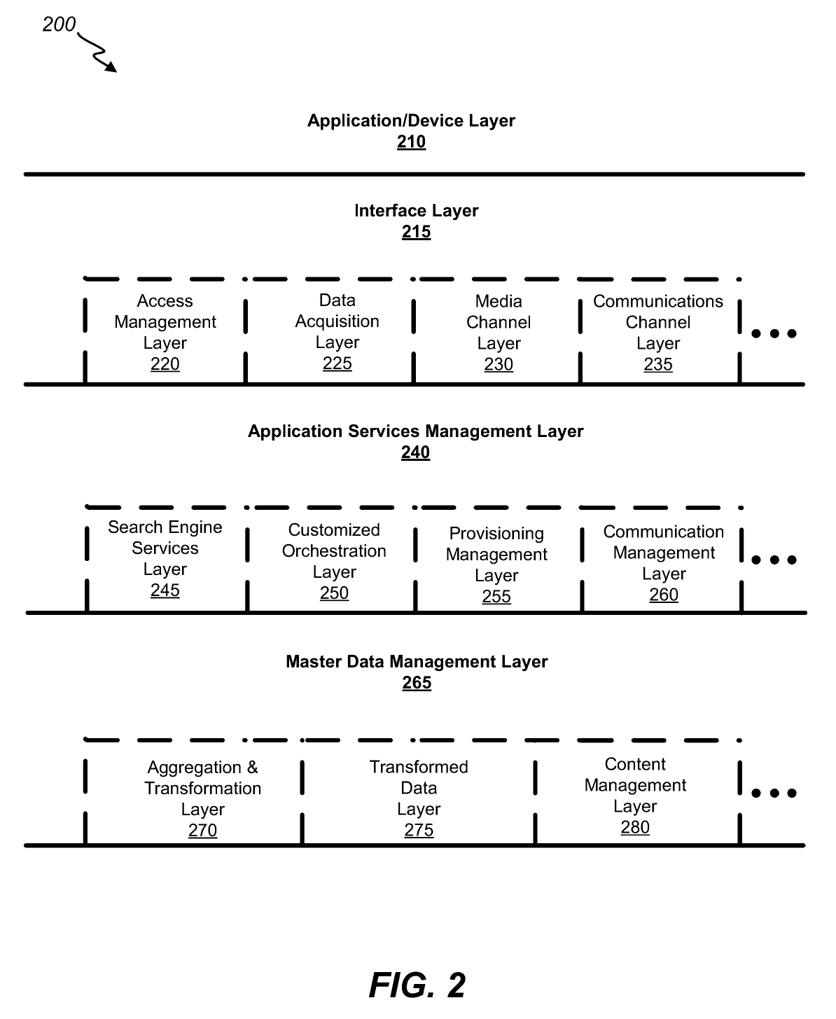

In certain embodiments, the interaction processing infrastructure 102 may be communicatively coupled or couplable to one or more data sources via one or more data acquisition interfaces 111. The one or more data sources may include any suitable source of data to facilitate embodiments disclosed further herein. In various embodiments, the one or more data sources may include one or more of a database, a website, any repository of data in any suitable form, and/or a third party system. In various embodiments, the one or more data sources may correspond to one or more social media websites and/or photo-sharing websites. With some embodiments, the data sources may include one or more mobile computing device locator services that provide information regarding the location of one or more client devices 205 and/or 207 (depicted in FIG. 2). With some embodiments, the data sources may provide various details relating to call data. With some embodiments, the data sources may provide caller name information from calling name delivery (CNAM), also known as caller identification or caller ID, may be used to determine particular details about the caller. With some embodiments, the data sources may provide information about the area of a caller. With some embodiments, the data sources may provide demographic data about an area.

In various embodiments, the data from the one or more data sources may be retrieved and/or received by the interaction processing infrastructure 102 via the one or more data acquisition interfaces 111 through network(s) 108 and/or through any other suitable means of transferring data. In some embodiments, the interaction processing infrastructure 102 and the data sources could use any suitable means for direct communication. According to certain embodiments, data may be actively gathered and/or pulled from one or more data sources, for example, by accessing a third party repository and/or by “crawling” various repositories. Certain data pulled and/or pushed from the one or more data sources may be transformed and the transformed data and/or other data generated based thereon may be made available by the interaction processing infrastructure 102 for users of client devices 205 and/or 207. In alternative embodiments, data from the one or more data sources may be made available directly to client devices 205 and/or 207.

In some embodiments, the one or more data acquisition interfaces 111 may be implemented in similar manner to interfaces 105 and/or 107 or any other suitable interface. In some embodiments, the one or more data acquisition interfaces 111 may include one or more application programming interfaces (APIs) that define protocols and routines for interfacing with the data sources. The APIs may specify application programming interface (API) calls to/from data source systems. In some embodiments, the APIs may include a plug-in to integrate with an application of a data source system. The one or more data acquisition interfaces 111, in some embodiments, could use a number of API translation profiles configured to allow interface with the one or more additional applications of the data sources to access data (e.g., a database or other data store) of the data sources. The API translation profiles may translate the protocols and routines of the data source system to integrate at least temporarily with the system and allow communication with the system by way of API calls. Data, as referenced herein, may correspond to any one or combination of raw data, unstructured data, structured data, information, and/or content which may include media content, text, documents, files, instructions, code, executable files, images, video, audio, and/or any other suitable content suitable for embodiments of the present disclosure.

According to certain embodiments, the interaction processing infrastructure 102 may include or provide a service management platform. A provider may access the interaction processing infrastructure 102 via a service tool interface 107. An end user may access the interaction processing infrastructure 102 via a client interface 105. The interaction processing infrastructure 102 may facilitate searching of one or more information repositories in response to information received over the network 108 from the client interfaces 105 and/or service tool interfaces 107.

The client interfaces 105 and/or service tool interfaces 107 may allow for transfer of and access to information in accordance with certain embodiments disclosed herein. In various embodiments, the client interface(s) 105 and/or service tool interface(s) 107 may include one or more suitable input/output modules and/or other system/devices operable to serve as an interface between a service provider(s) and the provider management platform. The client interfaces 105 and/or service tool interfaces 107 may facilitate communication over the network 108 using any suitable transmission protocol and/or standard. In various embodiments, the interaction infrastructure 102 may include, provide, and/or be configured for operation with the client interfaces 105 and/or service tool interfaces 107, for example, by making available and/or communicating with one or more of a website, a web page, a web portal, a web application, a mobile application, enterprise software, and/or any suitable application software. In some embodiments, a client interface 105 and/or service tool interface 107 may include an API to interact with the interaction infrastructure 102.

In some embodiments, a client interface 105 and/or a service tool interface 107 may include a web interface. In some embodiments, the client interface 105 and/or service tool interface 107 may include or work with an application made available to one or more interfaces, such as a mobile application as discussed herein. In some embodiments, the client interface 105 and/or service tool interface 107 may cause a web page to be displayed on a browser of a service provider. The web page(s) may display output and receive input from a user (e.g., by using Web-based forms, via hyperlinks, electronic buttons, etc.). A variety of techniques can be used to create the web pages and/or display/receive information, such as JavaScript, Java applications or applets, dynamic HTML and/or AJAX technologies. Accordingly, the interaction processing infrastructure 102 may have web site(s)/portal(s) giving access to such information, such as a provider portal.

In various embodiments, a client interface 105 and/or a service tool interface 107 may include providing one or more display screen images that may each include one or more user interface elements. A user interface may include any text, image, and/or device that can be displayed on a display screen for providing information to a user and/or for receiving user input. A user interface may include one or more widgets, windows, dashboards, text, text boxes, text fields, tables, grids, charts, hyperlinks, buttons, lists, combo boxes, checkboxes, radio buttons, and/or the like.

In certain embodiments, a client interface 105 and/or a service tool interface 107 may include a computing device of an end user and/or a service provider. In certain embodiments, a client interface 105 and/or a service tool interface 107 may include a mobile computing device that may be any portable device suitable for sending and receiving information over a network in accordance with embodiments described herein.

Certain embodiments may provide a multi-channel communication regime to coordinate multiple communication channels used by end users and providers. Multiple communication pipes within a communication pipe could be implemented according to certain embodiments. Some embodiments may implement a greater number of communication channels. For example, one set of channels could be used for an end user to request help, and one set of channels could be used for a provider to respond to the end user. The system can use web communication, text communication, voice communication, e-mail communication, push notification, and/or the like.

According to certain embodiments, the interaction processing infrastructure 102 may be or include a content provisioning platform. In some embodiments, the interaction processing infrastructure 102 may provide for the selection, generation, and provision of content objects to one or more client interfaces 105. In certain embodiments, providers may have content objects that may be placed in a web page made available to one or more client interfaces 105. In certain embodiments, providers may have content objects that may be displayed with an application made available to one or more client interfaces 105, such as a mobile application according to various embodiments. In some embodiments, placement of the content objects could be in accordance with one or more paid placement arrangements and one or more content presentation models.

Content objects may be included in a results page responsive to a keyword search initiated by an end user via, for example, a webpage and/or a mobile application. The search may be performed by an online search engine facilitated by the interaction processing infrastructure 102. A content object of provider may be included within a results page with results identified and/or compiled by the search engine and sent via the network 108 to the client interface 105 of the end user that initiated the search.

An end user, in various embodiments, may correspond to an end user of products, services, and/or information. A provider, in various embodiments, may correspond to (and may be variously referenced herein by) any one or combination of a service provider, a product provider, a merchant, a commercial entity, an advisor, a representative, and/or the like. End users may use one or more client interfaces 105; providers may use one or more service tool interfaces 107.

FIG. 2 shows a diagram of an architecture stack 200 of the interaction infrastructure 102, in accordance with certain embodiments of the present disclosure. While architecture stack 200 is illustrated as having a particular structure, it should be understood that certain embodiments may include other structures, including those with more or less layers than illustrated, in varying orientations and divisions. The architecture stack 200 may be implemented across a plurality of systems and/or subsystems corresponding to the interaction infrastructure 102. In some embodiments, a multi-layer part of the architecture stack 200 may be implemented at a single system or device within the interaction infrastructure 102.

The different layers of the architecture stack 200 are described generally herein with reference to FIG. 2 and in detail with reference to subsequent figures. From a high level perspective, the architecture stack 200 may include an application and/or device layer 210, an application services management layer 240, and/or a master data management layer 265. The application and/or device layer 210, the application services management layer 240, and/or the master data management layer 265 may include or otherwise interface with any of various sublayers. In some embodiments, the application and/or device layer 210, the application services management layer 240, and/or the master data management layer 265 may share resources and services with any one or combination of sublayers; and, in some embodiments, certain sublayers may share resources and services with certain other sublayers.

The application/device layer 210 may include user devices and applications for interacting with the other elements of the architecture stack 200 via the elements of an interface layer 215. For example, the applications may include web-based applications, entity portals, mobile applications, widgets, and the like for requesting services from and/or otherwise accessing the interaction infrastructure 102. These applications may run on one or more user devices. The user devices may be any suitable user device as detailed herein.

The interface layer 215 of the architecture stack 200 may provide interfaces for a user device to interact with the other elements of the architecture stack 200. For example, clients, entities, administrators, and others serviced by and/or otherwise associated with the interaction infrastructure 102 may utilize one or more user devices interacting within the application/device layer 210 to request services and/or access from an application services management layer 240. In some examples, a web-based search interface, a mobile application search interface, an orchestration platform interface, a provider dashboard interface, and/or the like may be provided.

In various embodiments, the interface layer 215 may include or otherwise interface with any one or combination of an access management layer 220, a data acquisition layer 225, a media channel layer 220, a communications channel layer 235, and/or the like layer in accordance with embodiments disclosed herein.

The architecture stack 200 may include an access management layer 220. The access management layer 220 may include elements to manage access to services and/or data. For example, the access management layer 220 may include elements to verify user login credentials, IP addresses associated with a user device, device IDs, telephone numbers, locations, and/or the like in order to provide certain services and/or access.

The architecture stack 200 may include a data acquisition layer 225. In some embodiments, the data acquisition layer 225 may be included in the application services management layer 240. The data acquisition layer 225 may receive data from various data sources to facilitate various embodiments disclosed herein. The any one or combination of data sources disclosed herein and/or the like, with aggregation being facilitated in some embodiments with any one or combination of interfaces 105, 107, 111, 114 and/or client devices 205, 207.

The architecture stack 200 may include a media channel layer 220. The media channel layer 220 may provide interfaces for the interaction infrastructure 102 to utilize various media channels. For example, services may be provided to clients, entities, administrators, and others serviced by and/or otherwise associated with the interaction infrastructure 102 by way of media channels of many various types including websites, mobile applications, social/provider network websites, cable and satellite television, telephone systems, video distribution, and print (e.g., newspapers and magazines).

The architecture stack 200 may include a communications channel layer 235. The communications channel layer 235 may provide interfaces for the interaction infrastructure 102 to centrally manage services based on real-time communications. For example, services may be provided to clients, entities, administrators, and others serviced by and/or otherwise associated with the interaction infrastructure 102 by way of tracking and/or handling of communications such as telephone calls, video calls, messages, chats, video conferencing, and/or the like in response to content objects presented through the various media channels.

In various embodiments, the application services management layer 240 may include or otherwise interface with any one or combination of a search engine services layer 245, a customized orchestration layer 250, a content provisioning management layer 255, a communications management layer 260, and/or the like layer in accordance with embodiments disclosed herein. In various embodiments, the search engine services layer 245 may include elements to provide effective search services to end users, providers, and/or internal elements and/or users of the interaction infrastructure 102. In some embodiments, the search services may include geo-aware search services. The geo-aware search services may provide fast and efficient access to information tailored to particular geographies. In various embodiments, the master data management layer 265 may include or otherwise interface with any one or combination of an aggregation and transformation layer 270, a transformed data layer 275, a content management layer 280, and/or the like layer in accordance with embodiments disclosed herein.

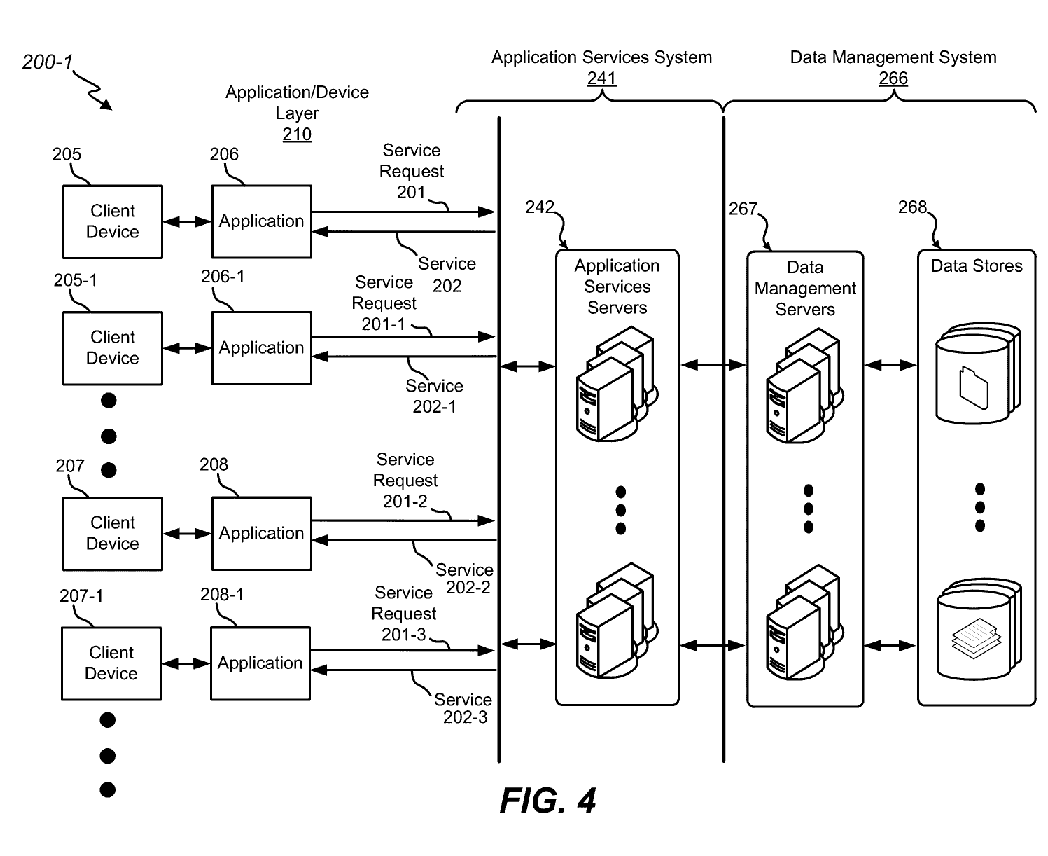

FIG. 4 shows a diagram of a portion 200-1 of the architecture stack 200 of the interaction infrastructure 102, in accordance with certain embodiments of the present disclosure. The portion 200-1 at least partially includes the application/device layer 210, as wells as an application services system 241 and a data management system 266 of the interaction infrastructure 102. In some embodiments, the application services system 241 may correspond at least partially to the interface layer 215 and the application services management layer 240. In some embodiments, the data management system 266 may correspond at least partially to the master data management layer 265.

The application services system 241 may interface with the application/device layer 210 and the data management system 266. In some embodiments, the application services system 241 may include at least part of the application/device layer 210. The application services system 241 could be a middle tier of the interaction infrastructure 102 in some embodiments, with the data management system 266 corresponding to a back-end in some embodiments.

The application services system 241 and the data management system 266 each may be or include a server system 242 and a server system 267, respectively, that include one or more servers. In various embodiments, the server systems 242, 267 may include one or more computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, the server systems 242, 267 may be adapted to run one or more services, operations, processing, or software applications described herein. The server systems 242, 267 may run an operating system including any of those discussed above, as well as any commercially available server operating system. The server systems 242, 267 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Entity Machines), and the like.

In some embodiments, the server systems 242, 267 may include one or more applications to analyze and consolidate data feeds and/or event updates received from various data sources. As an example, data feeds and/or event updates may include, but are not limited to, application 206, 208 updates, Twitter® feeds, Facebook® updates, updates (real-time and/or otherwise) received from one or more third party information sources and/or continuous data streams, which may include real-time events related to sensor data applications, and/or the like. The server system 242 may also include one or more applications to display the data feeds and/or real-time events via the client devices 205, 207 and/or devices internal to the interaction infrastructure 102.

The application services system 241 and/or the data management system 266 may also include one or more data stores 268. The data stores 268 may include various forms of data storage including solid state storage, disk storage, databases (including relational, column, document, key-value and graph type databases) and cache. The data stores 268 may reside in a variety of locations, such as on a non-transitory storage medium local to (and/or resident in) the server systems 242, 267 and/or remote from the server systems 242, 267 and in communication with the server systems 242, 267 via a network-based or dedicated connection. In certain embodiments, the data stores 268 may reside in a storage-area network (SAN). Similarly, any necessary files for performing the functions attributed to the server systems 242, 267 may be stored locally on the server systems 242, 267 and/or remotely, as appropriate. In one set of embodiments, the data stores 268 may include relational databases that are adapted to store, update, and retrieve data in response to SQL-formatted commands. It should be appreciated that information corresponding to the repositories may be stored elsewhere and/or in other ways, or may not be stored, depending on the implementations chosen. Likewise, while various segregations of data corresponding to the repositories are provided herein, it should be appreciated that such examples are non-limiting, and some or all the data may be handled in any suitable manner.

In certain embodiments, the interaction infrastructure 102 may be implemented in or with a distributed computing and/or cloud computing environment with a plurality of servers and cloud-implemented processing, memory, and data resources. Thus, with accretion of service information, the system may allow for scaling out with additional processing resources, server resources, data storage resources, data management resources, and the like. Some embodiments may use different types of servers to service different types of client device 205, 207.

The interaction infrastructure 102 may provision services facilitated by one or more components of the interaction infrastructure 102, and, in some embodiments, one or more of the services may be offered as cloud services. A specific instantiation of a service 202 provided by the interaction infrastructure 102 may be referred to herein as a service instance 202. In some examples, a service 202 provided by the interaction infrastructure 102 may include provisioning of content objects, facilitating real-time communications, exposing features of a provider platform, exposing features of an orchestration platform, providing protected computer network access to data generated and/or transformed, and stored by the infrastructure system 102, for example, via a hosted database, a hosted web server, a hosted application server, a software application, and/or the like. In certain embodiments, the interaction infrastructure 102 may include a suite of applications, middleware, and database service offerings that are delivered to clients and/or providers.

In the illustrated embodiment, one or more client devices 205, 207 may be used by users to interact with the interaction infrastructure 102. Although only a limited number of the client devices 205, 207 is shown, any number of client devices 205, 207 may be supported. In various embodiments, the client devices 205 and/or 207 may correspond to devices supporting and/or accessing a client interface 105 and/or a service tool interface 107. In some embodiments, the client devices 205 and/or 207 may correspond to devices supporting and/or accessing a data acquisition interface 111 and/or a media channel interface 114.

In various embodiments, the client devices 205 and/or 207 may be configured to operate a client application such as a web browser, a proprietary client application, a web-based application, an entity portal, a mobile application, a widget, or some other application, which may be used by a user of the client device 205, 207 to interact with the interaction infrastructure 102 to use services provided by the interaction infrastructure 102. The client devices 205 and/or 207 may be portable handheld devices (e.g., an iPhone®, cellular telephone, an iPad®, computing tablet, a personal digital assistant (PDA)) or wearable devices (e.g., Google Glass® device), running software such as Microsoft Windows Mobile®, and/or a variety of mobile operating systems such as iOS, Windows Phone, Android, BlackBerry 10, Palm OS, and/or the like, and being Internet, e-mail, short message service (SMS), Blackberry®, and/or other communication protocol enabled. In some embodiments, one or more of the client devices 205 and/or 207 can be general purpose personal computers including, by way of example, personal computers and/or laptop computers running various versions of Microsoft Windows®, Apple Macintosh®, and/or Linux operating systems. In some embodiments, one or more of the client devices 205 and/or 207 can be workstation computers running any of a variety of commercially-available UNIX® or UNIX-like operating systems, including without limitation the variety of GNU/Linux operating systems, such as for example, Google Chrome OS. Alternatively, or in addition, one or more of the client devices 205 and/or 207 may be any other electronic device, such as a thin-client computer, an Internet-enabled gaming system (e.g., a Microsoft Xbox gaming console with or without a Kinect® gesture input device), and/or a personal messaging device, capable of communicating over network(s) 108.

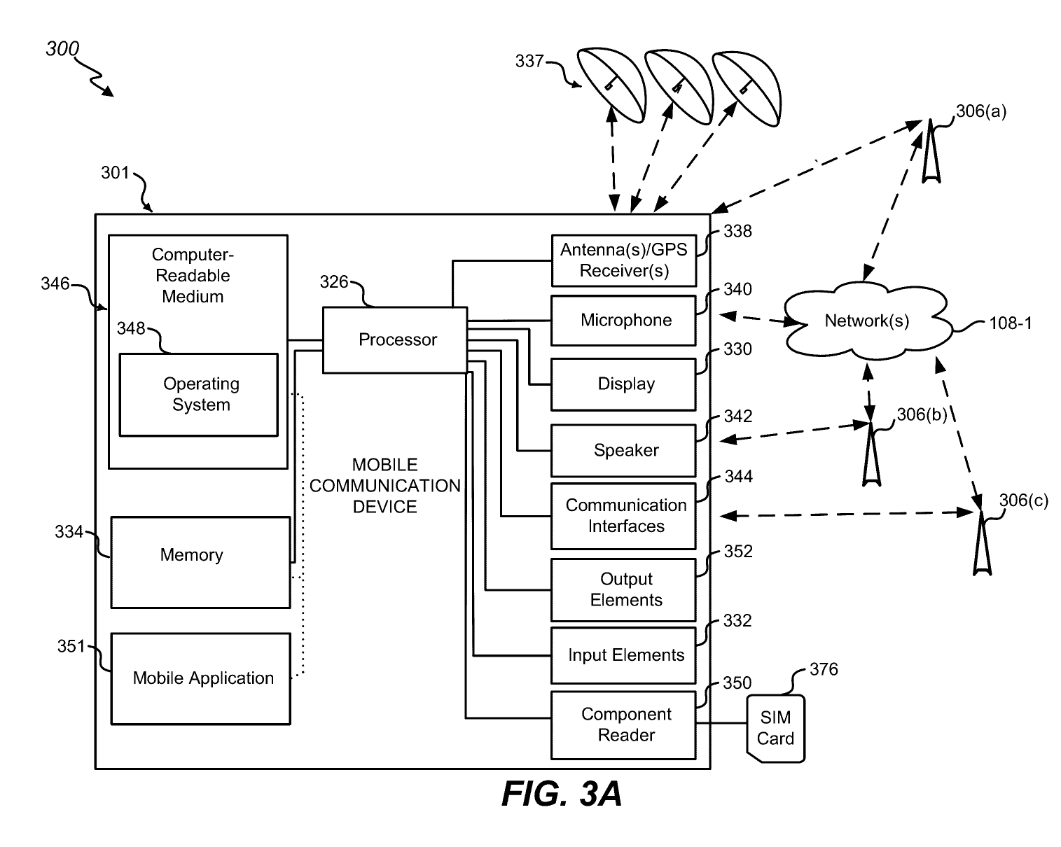

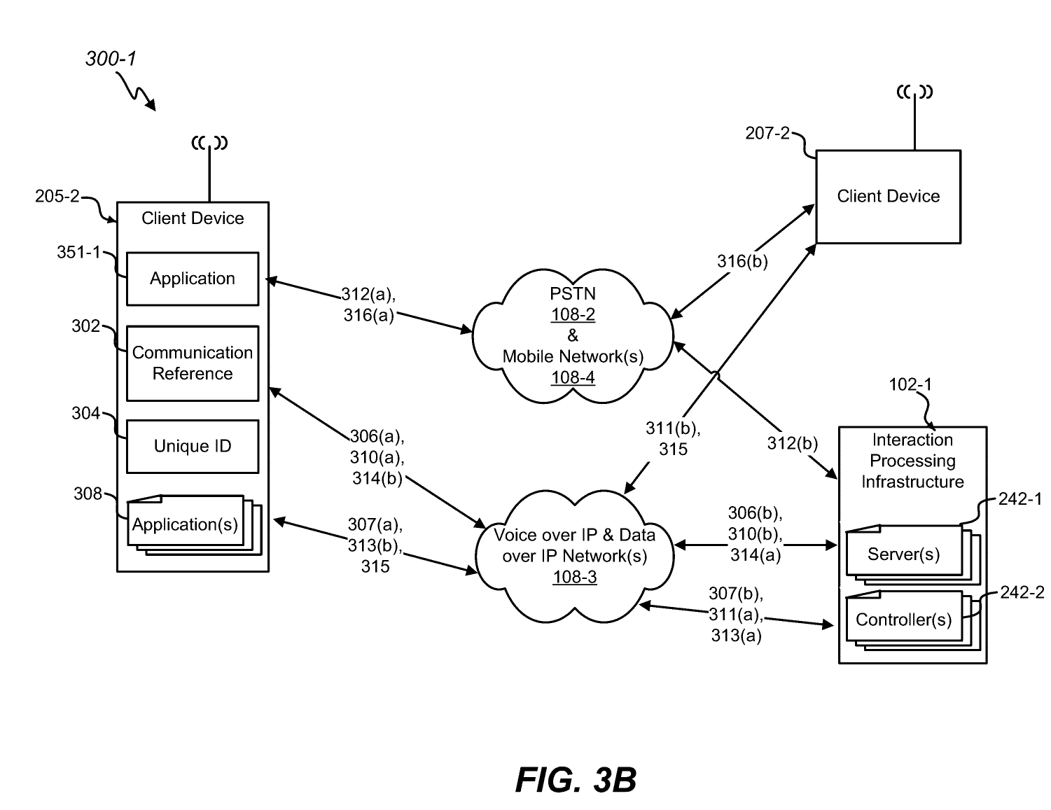

FIG. 3A is a block diagram of a system 300 including one non-limiting example of a client device 205 and/or 207 that corresponds to a mobile communication device 301, in accordance with certain embodiments of the present disclosure. The mobile communication device 301 may be a portable device suitable for sending and receiving information over a network in accordance with embodiments described herein. For example without limitation, in various embodiments, the mobile communication device 301 may include one or more variously referenced as a mobile phone, a cellular telephone, a smartphone (for example without limitation, a smart phone such as: the iPhone® phone available from Apple Inc. of Cupertino, Calif.; Android™ operating system-based phones, available from as Google of Mountain View, Calif.; and/or the like), a handheld mobile device, a tablet computer, a web pad, a personal digital assistant (PDA), a notebook computer, a handheld computer, a laptop computer, a vehicle computer, and/or the like.

In some embodiments, the mobile communication device 301 may be provided with a mobile application 351, which may correspond to a client application configured to run on the mobile communication device 301 to facilitate various embodiments of this disclosure. In various embodiments, the mobile application 351 may correspond to application 206 and/or 208. For example without limitation, the mobile application 351 may transform the mobile communication device 301 into a communication tracking facilitator. The mobile application 351 and the mobile communication device 301 may cooperate with the interaction infrastructure 102 to facilitate tracking and/or handling of communications (e.g., calls, messages, chats, video conferencing, and/or the like) in response to content objects presented through the mobile communication device 301. The mobile application 351 can be a computer program that can be installed and run on the mobile communication device 301.

In various embodiments, mobile communication device 301 configured with the mobile application 351 may provide one or more display screens that may each include one or more user interface elements. A user interface may include any text, image, and/or device that can be displayed on a display screen for providing information to a user and/or for receiving user input. A user interface may include one or more widgets, text, text boxes, text fields, tables, grids, charts, hyperlinks, buttons, lists, combo boxes, checkboxes, radio buttons, and/or the like. As shown in FIG. 3, the mobile communication device 301 includes a display 320 and input elements 332 to allow a user to input information into the mobile communication device 301. By way of example without limitation, the input elements 332 may include one or more of a keypad, a trackball, a touchscreen, a touchpad, a pointing device, a microphone, a voice recognition device, or any other appropriate mechanism for the user to provide input. Further, the mobile communication device 301 the input elements 332 may include a communication component reader 350 for accepting a communication component such as a SIM card 376.

In some embodiments, the interaction infrastructure 102 may provide content objects of any suitable type to a user of the mobile communication device 301 through the mobile application 351. The mobile application 351 can include a utility that communicates with the interaction infrastructure 102 to control downloading, displaying, caching, and/or other operations concerning the handling of content objects. The mobile application 351 and the mobile communication device 301 may cooperate with the interaction infrastructure 102 to facilitate communication tracking in response to content objects displayed through the one or more additional applications.

In some embodiments, the client device 205 and/or 207 may include one or more additional applications, for example, that may be provided by one or more intermediaries and/or may provide functionality relating to one or more intermediaries. A intermediary may be any entity, including, for example, a news content provider, a social networking company, any entity, a gaming company, a music vendor, a multimedia content provider, and/or the like. Content objects (e.g., media objects, multimedia objects, electronic content objects, and/or the like) of any of various types may be displayed through the one or more additional applications. The mobile application 351 and the mobile communication device 301 may cooperate with the interaction infrastructure 102 to facilitate communication tracking in response to content objects displayed through the one or more additional applications. In some embodiments, the mobile application 351 could include a toolkit with client-side utility for interfacing with the one or more additional applications to facilitate tracking and/or call handling responsive to presented content. In some embodiments, the one or more additional applications could include the toolkit. In some embodiments, the mobile application 351 could be grafted into the one or more additional applications to provide tracking and/or communication handling functionalities. In some embodiments, the mobile application 351 could use a number of API translation profiles configured to allow interface with the one or more additional applications.

The user selection of a user-selectable option corresponding to a content object may involve any one or combination of various user inputs. The user selection may be in the form of a keyboard/keypad input, a touch pad input, a track ball input, a mouse input, a voice command, etc. For example, the content object may be selected by the user by pointing and clicking on the content object. As another example, the content object may be selected by an appropriate tap or movement applied to a touch screen or pad of the mobile communication device 301. The selection of a content object may initiate a voice call, video call, message, chat, and/or other communication. In some embodiments, a telephone number may be presented in content information in a format such that, when the user selects a communication reference, the client device (e.g., a cellular phone or a computer) dials a telephone number corresponding to the communication reference. For example, the call could have been initiated by end user selecting a click-to-call option displayed via the user device. In some embodiments, user devices can automatically dial the telephone number. For example, a Dual Tone Multi-Frequency (DTMF) generator can dial a phone number. In some embodiments, the user device may initiate the phone call through a VoIP system.

In some embodiments, the mobile application 351 can run continuously (e.g., in the background) or at other times, such as when the mobile application 151 is launched by an end user. In certain embodiments, the mobile application 351 can automatically run each time that a user accesses the one or more additional applications or selects a content object. The mobile application 351 may be provided in any suitable way. For non-limiting example, the mobile application 351 may be made available from the interaction infrastructure 102, a website, an application store, etc. for download to the mobile communication device 301; alternatively, it may be pre-installed on the mobile communication device 301. In some embodiments, the mobile application 351 can be pre-installed on the device platform by a mobile communication device manufacturer or carrier. In some embodiments, a mobile application 351 can be downloaded and installed by an end-user on their client device 205 and/or 207.

The mobile communication device 301 includes a memory 334 communicatively coupled to a processor 336 (e.g., a microprocessor) for processing the functions of the mobile communication device 301. The mobile communication device 301 may include at least one antenna 338 for wireless data transfer to communicate through a cellular network, a wireless provider network, and/or a mobile operator network, such as GSM, for example without limitation, to send and receive Short Message Service (SMS) messages or Unstructured Supplementary Service Data (USSD) messages. The mobile communication device 301 may also include a microphone 340 to allow a user to transmit voice communication through the mobile communication device 301, and a speaker 342 to allow the user to hear voice communication. The antenna 338 may include a cellular antenna (e.g., for sending and receiving cellular voice and data communication, such as through a network such as a 3G or 4G network). In addition, the mobile communication device 301 may include one or more interfaces in addition to the antenna 338, e.g., a wireless interface coupled to an antenna. The communications interfaces 344 can provide a near field communication interface (e.g., contactless interface, Bluetooth, optical interface, etc.) and/or wireless communications interfaces capable of communicating through a cellular network, such as GSM, or through Wi-Fi, such as with a wireless local area network (WLAN). Accordingly, the mobile communication device 301 may be capable of transmitting and receiving information wirelessly through both short range, radio frequency (RF) and cellular and Wi-Fi connections.

Additionally, the mobile communication device 301 can be capable of communicating with a Global Positioning System (GPS) 337 in order to determine to location of the mobile communication device 301. The antenna 338 may be a GPS receiver or otherwise include a GPS receiver. In various embodiments contemplated herein, communication with the mobile communication device 301 may be conducted with a single antenna configured for multiple purposes (e.g., cellular, transactions, GPS, etc.), or with further interfaces (e.g., three, four, or more separate interfaces).

The mobile communication device 301 can also include at least one computer-readable medium 346 coupled to the processor 336, which stores application programs and other computer code instructions for operating the device, such as an operating system (OS) 348. In some embodiments, the mobile application 351 may be stored in the memory 334 and/or computer-readable media 346. In some embodiments, the mobile application 351 may be stored on the SIM card 376. In some embodiments, mobile communication device 301 may have cryptographic capabilities to send encrypted communications and/or messages protected with message hash codes or authentication codes. Again, the example of mobile communication device 301 is non-limiting. Other devices, such as those addressed herein, may interact with the interaction infrastructure 102.

The mobile communication device 301 may access the network 108 through a wireless link to an access point. For example, a mobile communication device 301 may access the network 108 through one or more of access point 306(a), access point 306(b), access point 306(c), and/or any other suitable access point(s). The access points 306 may be of any suitable type or types. For example, an access point 306 may be a cellular base station, an access point for wireless local area network (e.g., a WiFi access point), an access point for wireless personal area network (e.g., a Bluetooth access point), etc. The access point 306 may connect the mobile communication device 301 to the network 108, which may include the Internet, an intranet, a local area network, a public switched telephone network (PSTN), private communication networks, etc. In some embodiments, access point(s) 306 may be used in obtaining location information for the mobile communication device 301, as described further herein.

FIG. 3B depicts a high-level block diagram of a system 300-1 for communication routing and tracking, in accordance with certain embodiments of the present disclosure. Certain embodiments may allow for tracking of a great number of providers, where the tracking not limited by a telephone number inventory. Previously, call tracking numbers were essential for call tracking, being the only means to tie an offline activity to a phone call that can be tracked. Static phone numbers were provisioned for call tracking so that, when a call to a particular number came through the PSTN, the provider to which the number was assigned had to be determined. However, certain embodiments may provide for technological improvements that allow for control over sequences of activities after a user initiates a response to a particularized content object.

The client device 205 configured with the application 351-1 may be configured to associate the application 351-1 with a communication reference 302 of the client device 205. In some embodiments, the communication reference 302 is a telephone number associated with the client device 205. In some embodiments, the application 351-1 may gather the telephone number from the device, a carrier associated with device subscriber, or via input of the end-user. In some embodiments, the application 351-1 may register unique identification information 304 associated with the client device 205. For example without limitation, the application 351-1 may gather the information 304 from the client device 205. In some embodiments, unique identification information 304 may be gathered from a SIM card 376 or another card of the client device 205. In some embodiments, unique identification information 304 may be gathered from other components of the client device 205.

The unique identification information 304 may be sent by the client device 205 to the infrastructure 102. The unique identification information 304 could include any suitable subscriber identity information. In some embodiments, the unique identifier may include an IMSI. In some embodiments, the unique identifier may be derived from the IMSI such that the actual IMSI is not sent. In some embodiments, a hash code based on the IMSI may be sent. The unique identifier may indicate associated network location information in some embodiments.

In some embodiments, to provision tracking service, the client device 205 configured with the application 351-1 may send provisioning information to the infrastructure 102. The provisioning information may indicate communication reference information 302. For example without limitation, as indicated by interactions 306(a) and 306(b), the client device 205 may send phone number information to the infrastructure 102. In some embodiments, the provisioning information could be sent to a MSC/HLR, which could then convey the information to the infrastructure 102. In some embodiments, the provisioning information could be sent via SMS messaging, as indicated by interactions 312(a) and 312(b). For example without limitation, SMS messaging may be sent to the infrastructure 102 via one or more of a home carrier MSC, a home carrier SMSC, an intercarrier SMS gateway, serving carrier SMSC, a mobile network 108-4, a serving carrier MSC/VLR, and/or the like.

Provisioning could be initiated with launching/installing the application 351-1. The provisioning information may be sent to the infrastructure 102 via an Internet Protocol (IP) message via one or more IP networks, such as network(s) 108-3. In some embodiments, the provisioning information may include the subscriber's Mobile Directory Number (MDN) for CDMA networks or Mobile Subscriber Integrated Services Digital Network Number (MSISDN) for GSM networks. In some embodiments, the client device 205 configured with the application 351-1 may also send provisioning information that includes the device's unique equipment identity 304. When necessary, the infrastructure 102 could request the subscriber's unique subscriber identity from the home location register associated with the MDN or MSISDN. The infrastructure 102 may store the provisioning information in one or more data repositories 140. In some embodiments, after the infrastructure 102 receives the provisioning information, it may send a confirmation message to the application 351-1, as indicated by interfaces 314(a) and 314(b).

As discussed herein, in some embodiments, the infrastructure 102 may provide particularized content objects through the application 351-1. In some embodiments, particularized content objects may be displayed through the one or more additional applications 308 of the client device 205, such as a browser, an SMS application, a push notification, an email application, a social media application, etc. In some embodiments, the application 351-1 could include a toolkit with client-side utility for interfacing with the one or more additional applications to facilitate tracking and/or call handling responsive to presented particularized content objects. Various embodiments may present particularized content objects in any one or combination of ways. In some embodiments, the one or more additional applications 308 could include a toolkit for interfacing with the application 351-1. In some embodiments, the application 351-1 could be grafted into the one or more additional applications to provide tracking and/or call handling functionalities. In some embodiments, the application 351-1 could use one or more API translation profiles configured to allow interface with the one or more additional applications 308.

The end-user may select a user-selectable call option presented with the client device 205 responsive to a particularized content object presented via the client device 205 either via the application 351-1 or via another application, in accordance with various embodiments. In some embodiments, the user-selectable call option and the particularized content object may be integrated, for example without limitation, with a particularized content object with a click-to-call option. In some embodiments, responsive to the user selection, a call may be placed to a provider communication device 207, as indicated by interactions 316(a) and 316(b).

Responsive to the user selection, the client device 205 configured with the application 351-1 may send one or more communications corresponding to the particularized content object, via a data network, to the infrastructure 102, as indicated by interactions 310(a) and 310(b). By way of example without limitation, the one or more communications may include one or more IP messages sent via one or more IP networks, such as network(s) 108-3. The one or more messages may convey tracking information. The tracking information could indicate call information. By way of example without limitation, the call information could correspond to the telephone number, the subscriber identity, the device identification, the IMSI, and/or any suitable information associated with the client device 205.

In some embodiments, particularized content objects are presented to a user via the application 351-1 such that the application 351-1 is configured to gather tracking information about those particularized content objects. In some embodiments, calls are placed or at least initiated via the application 351-1 such that the application 351-1 is configured to gather tracking information about those calls. In some embodiments, the application 351-1 receives, pulls, extracts, and/or listens to information from one or more applications 308 of the client device 205 to gather tracking information, where particularized content objects are presented via the one or more applications 308 and/or calls are placed or at least initiated via the one or more applications 308. In some embodiments, tracking information may include call information gathered from a phone application 308 of the client device 205.

The call information could include information indicating a successfully connected call, a call duration, an indication that a call was not connected, information indicating a call was missed by the callee, an indication that a busy tone was received, an indication that a call was dropped, and/or the like. The call information could include a callee communication reference. For example without limitation, callee communication reference information could include one or more of a telephone number, IP address, etc. of the provider/service provider/representative linked to the particularized content object and/or the like.

In some embodiments, the application 351-1 may be configured to gather call information about call-backs from provider representatives. Having logged the callee communication reference, the application 351-1 could identify an incoming call from the previously called representative. In various embodiments, in the same or similar manner with respect to tracking information for calls initiated by the user, any suitable tracking information about the call-back may be collected.

In some embodiments, tracking information may be inferred, for example, in the absence of explicit tracking information. For example without limitation, the application 351-1 and/or the infrastructure 102 may infer from a short call duration that a call was missed by a representative of a provider. The application 351-1 and/or the infrastructure 102 may infer from subsequent user selections of the application 351-1 and/or other applications 308 within a short time period after the initial user selection that a call was potentially missed by a representative of a provider. Accordingly, the application 351-1 may send one or more communications via a data network that include any suitable tracking information to inform the infrastructure 102, which may include application server(s), network switch(es), etc., about user action relating to particularized content objects.

In various embodiments, tracking information may include any suitable about particular particularized content objects. Tracking information could include, for example without limitation, any reference information for the particularized content object and/or other information identifying a particularized content object, a provider, etc. In some embodiments, tracking information could include information relating to content of particularized content objects, for example without limitation, content details such as a value and/or offer associated with a particularized content object; a date associated with a particularized content object, such as an expiration date, an effective offer date or date range; products and/or services to which a particularized content object is directed; and/or the like.

In some embodiments, tracking information could include information relating to time information associated with a particularized content object. For example without limitation, tracking information could include any information relating a time when a particularized content object was presented to a user. In some embodiments, tracking information could include information relating to particularized content object presentation details. For example without limitation, tracking information could include any information relating to the time, manner, and/or place of presentation of a particularized content object. Tracking information could include any information indicating the intermediary of a particularized content object. In some embodiments, tracking information could include location information relating to location of the client device 205. In some embodiments, certain features discussed with reference to client device 205 could likewise apply to the provider communication device 207, which could have installed thereon an application 351 to facilitate the features.

In some embodiments, the infrastructure 102-1 receives, places, and/or routes telephone calls over packet switched networks. In some embodiments, the infrastructure 102 may provide packet-switched connections between callers and provider representatives, which correspond to the destinations of click-to-call requests. In some embodiments, the infrastructure 102 can place and/or receive direct VoIP calls to/from the callers/provider representatives. In some embodiments, the infrastructure 102 may use the data network 108-3 completely (along with one or more access points 306 via 3G/4G/Wi-Fi, e.g.), as opposed to through the PSTN 108-2, thereby excluding other carriers from handling the call. With the servers/switches of the infrastructure 102 routing calls via the data network 108-3, complete call tracking may be achieved without the need of a call tracking number. Accordingly, certain embodiments may allow for tracking of a great number of providers, where the tracking not limited by a telephone number inventory.

In some embodiments, the client device 205 configured with the application 351-1 may provide a softphone dedicated to the device that facilitates communications with provider representatives and the infrastructure 102, as well as call tracking, via the data network 108-3. In some embodiments, the client device 205 configured with the application 351-1 may send provisioning information to the infrastructure 102-3 that may indicate communication reference information 302 and/or identification information 304, as discussed herein. The communication reference information 302 may be stored in the application 351-1 and/or the infrastructure 102-3. In some embodiments, communication reference information 302 could correspond to dedicated reference information for a softphone dedicated to the device.

In some embodiments, to make a voice connection responsive to a click-to-call selection by the user of the client device 205, one or more IP messages may be sent via one or more access points to one or more servers/switches of the infrastructure 102, as indicated by interactions 307(a) and 307(b). The one or more IP messages may indicate the communication reference information 302, the identification information 304, and/or another identifier (which could be an authentication token/key, in some embodiments) from which phone number information of the client device 205 may be identified and/or determined. The one or more IP messages could indicate the phone number information for a provider representative corresponding to the particularized content object selected. Alternatively, an identifier of the provider representative and/or particularized content object could be indicated, and the infrastructure 102 could determine the phone number information for the corresponding provider representative, e.g., based on information stored for the provider. In some embodiments, one or more SIP requests may be sent via one or more access points to one or more servers/switches of the infrastructure 102. By routing of the messaging to the infrastructure 102, other telecommunication carriers could be excluded.

In some embodiments, the infrastructure 102 can place separate VoIP calls over the IP network(s) 108-3 to the provider representative (311(a), (b)) and the caller (313(a), (b)), and then bridge the calls (315). Accordingly, each of the provider representative and the caller receives an inbound call (311(a), (b)) placed via the packet switched network 108-3, and the infrastructure 102 joins the separate calls. In some embodiments, the two calls are merged responsive to the each of the caller and the provider representative accepting the call.

In some embodiments, to make a voice connection responsive to a click-to-call selection by the user of the client device 205, the infrastructure 102 can route a VoIP call established with the caller over the IP network(s) 108-3 to the provider representative. Accordingly, only the provider representative receives an inbound call. For example without limitation, a SIP request from the client device 205 could be reconfigured and redirected based at least in part on the phone number of the provider representative. A SIP request could be configured so that response messaging is routed to the client device 205 and/or the infrastructure 102. In some embodiments, the call from the caller is connected to the provider representative responsive to the provider representative accepting the call.

In various embodiments, the infrastructure 102 may interface with the caller and/or the provider representative using one or more suitable types of internet telephony systems, such as, for example, SIP-based internet telephony, H.323-based internet telephony, and/or the like. Accordingly, various embodiments of the infrastructure 102 may support multiple, different types of internet telephony systems. In some embodiments, the infrastructure 102 may include one or more servers 242-1 and one or more controllers 242-2, which may be SIP servers and session border controllers, in order to interface with the IP network(s) 108-3, control messaging, and facilitate set-up, voice conversation, and tear-down of VoIP calls to or from the infrastructure 102. The one or more controllers 242-2 could handle processing and routing of incoming requests from the client device 205.

In various embodiments, the application 351-1 and/or the infrastructure 102 may track information about calls, which information may include any suitable about particular particularized content objects, as discussed herein. For example without limitation, the application 351-1 and/or the infrastructure 102 may be configured to track information relating to particularized content objects and calls to facilitate the gathering, processing, evaluating, and presenting of information for a provider interface, as discussed in the following. In some embodiments, certain features discussed with reference to client device 205 could likewise apply to the provider communication device 207, which could have installed thereon an application 351 to facilitate the features.

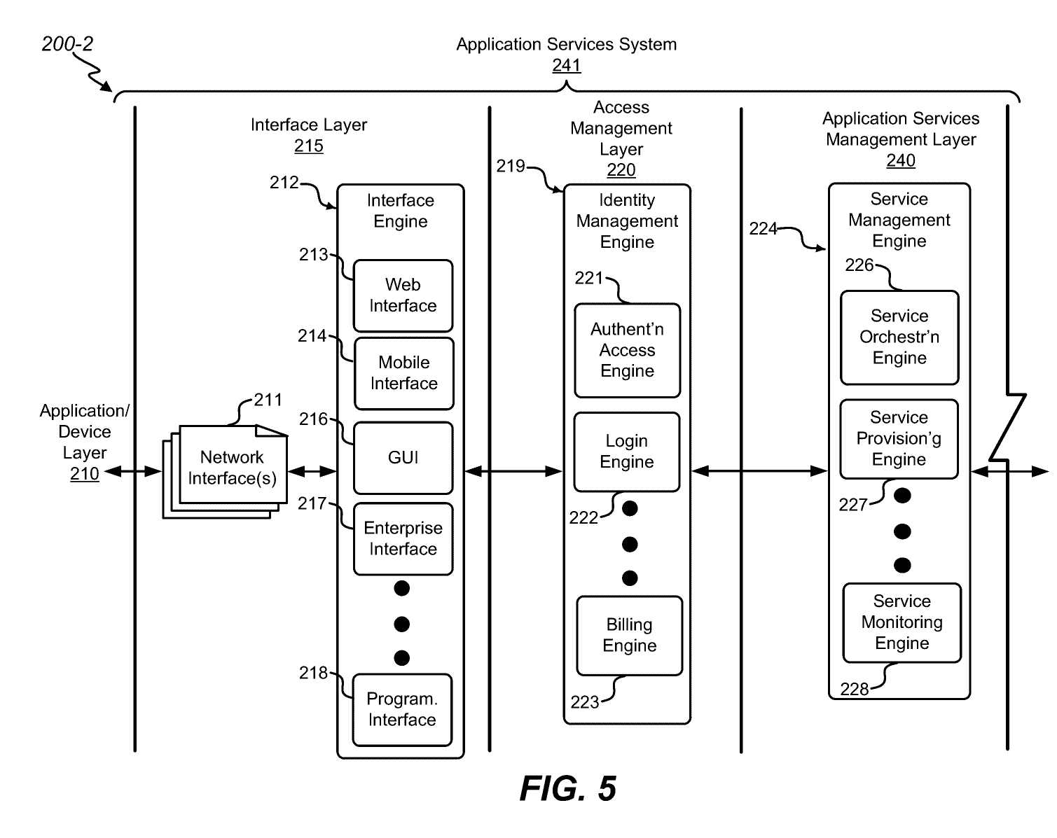

FIG. 5 shows a diagram of a portion 200-2 of the architecture stack 200 of the interaction infrastructure 102, in accordance with certain embodiments of the present disclosure. The portion 200-2 at least partially includes the interface layer 215, the access management layer 220, and the application services management layer 240. In some embodiments, the application services system 241 may correspond at least partially to the interface layer 215, the access management layer 220, and the application services management layer 240. While engines, repositories, and other components are described separately in this disclosure, it should be appreciated that the components may be combined and/or implemented differently in any combination to provide certain features in various embodiments. In various embodiments, different processes running on one or more shared resources may implement some of the components.

The interaction processing infrastructure 102 may include one or more network interfaces 211 communicatively coupled to one or more servers, which may include communication servers, web servers, gateways, application servers, database servers, and/or one or more other types of servers. The network interface(s) 211 may include any suitable input/output module or other system/device operable to serve as an interface between one or more components of the interaction infrastructure 102 and the network 108. The interaction infrastructure 102 may use the network interfaces 211 to communicate over the network 108 using any suitable transmission protocol and/or standard.

The interface layer 215 may include one or more interface engines 212. The interface engine 212 may be configured to generate one or more interfaces 105, 107, 111, 114 (e.g., web interfaces 213, mobile app interfaces 214, graphical user interfaces 216, enterprise application interfaces 217, programmatic interfaces 218, and/or the like) to enable data to flow to client devices 205, 207 via respective applications 206, 208. In various embodiments, the interfaces of interface engine 212 may be embodied in hardware and/or software. The interface engine 212 may include logic to send, present, and receive information, with one or more of the interfaces to/from one or more end users, service providers, and/or data sources. The interface engine 212 may utilize one or more network interfaces to transceive information through the network 108. The interaction infrastructure 102 may pull and/or push information from those entities.

Generally, interfaces may be configured to receive user input, present dynamic presentations that depend on user input, and otherwise respond to user input. In some examples, such input may be provided via one or more input devices (e.g., a keyboard, touchscreen, joystick, mouse, microphone, devices capable of capturing inputs, and the like) operated by one or more users of user devices. Output may be provided via one or more output devices (e.g., a display or speaker). The web interfaces 213 and mobile interfaces 214 may include any suitable web interface and mobile interface configured to interact with elements of the interaction infrastructure 102. The graphical user interfaces 216 may include any suitable graphical user interface configured to interact with elements of the interaction infrastructure 102. The enterprise interface 217 may include internal interfaces for accessing element of the interaction infrastructure 102 via an internal network of an enterprise. The programmatic interfaces 218 may include one or a combination of an API, a programmatic user interface, and/or other similar interfaces for defining core functions for accessing elements of the interaction infrastructure 102. A programmatic interface 218, for example, may specify software components in terms of associated operations.

Elements of the interface layer 215, for example, the interface engine 212, may communicate with calls and inputs directed to and/or received from the access management layer 220. In some embodiments, the access management layer 220 may include one or more identity management engines 219. Generally, the identity management engine 219 can be configured to provide identity services, such as access management and authorization services for end users and/or providers serviced by the interaction infrastructure 102. In some embodiments, the identity management engine 219 may control information about end users and providers that utilize the services provided by the interaction infrastructure 102. The control information may include information that authenticates the identities of end users and/or providers and that specifies authorized actions with respect to various system resources and services.

In some embodiments, the identity management engine 219 may include logic for implementing account features in various embodiments. By way of example without limitation, the identity management engine 219 may include logic one or more aspects of: handling user registration; managing account creation, updates, authentication, handling; and/or the like. The identity management engine 219 may be configured for acquiring, processing, formatting, and/or storing authentication information in the one or more authentication information repositories 257 (described further below).

In some embodiments, the identity management engine 219 may include a plurality of engines configured to manage different aspects of interacting with elements of the interaction infrastructure 102, such as user interactions with applications serviced by the interaction infrastructure 102. The engines may include, for example, an authentication access engine 221, a login engine 222, and a billing engine 223. The different engines of the identity management engine 219 can define routines, protocols, standards, and/or the like for interacting with elements of the interaction infrastructure 102. The authentication access engine 221 may evaluate rules and conditions under which users may access elements of the interaction infrastructure 102. These rules and conditions may be user-defined (e.g., by an administrator or reviewer), learned over time, and/or may be dynamically updated and/or evaluated based on characteristics of the user or the user's device attempting to access the interaction infrastructure 102. The login engine 222 may evaluate the rules and conditions under which users are able to log in to the interaction system or access applications associated with the interaction system. Thus, while authentication access engine 221 may evaluate the rules to determine which users may access the interaction infrastructure 102, the login engine 222 may evaluate the particular credentials, profiles, etc. associated with each authenticated user.

The application services management layer 240 may include one or more service management engines 224. The service management engines 224 may include one or more service orchestration engines 226, one or more service provisioning engines 227, and/or one or more service monitoring engines 228. By way of example without limitation, in some embodiments, a client device 205 or 207 running an application 206 or 208 may interact with the interaction infrastructure 102 by transmitting a service request 201 to the interaction infrastructure 102 for one or more services provided by the interaction infrastructure 102. In some embodiments, the service request 201 may be received via an interface facilitated by the interface engine 212. The service request 201 may be processed by the service management engine 224 and, consequent to the processing, information identifying one or more services and, in some embodiments, information uniquely identifying a user. The service orchestration engine 226 may utilize the information to orchestrate the provisioning of services and resources responsive to the service request 201. In some embodiments, the service orchestration engine 226 may orchestrate the provisioning of services and resources using the service provisioning engine 227. In certain embodiments, the service orchestration engine 226 may enable the management of processes associated with each service request 201 and may apply entity logic to determine whether and how a service 202 should be provisioned. The service orchestration engine 226 may send a request to the service provisioning engine 227 to prompt the service provisioning engine 227 to allocate resources and configure those resources needed for the service 202. The service 202 may be tracked by the service monitoring engine 228. In some instances, the service monitoring engine 228 may be configured to collect usage statistics for the services 202.

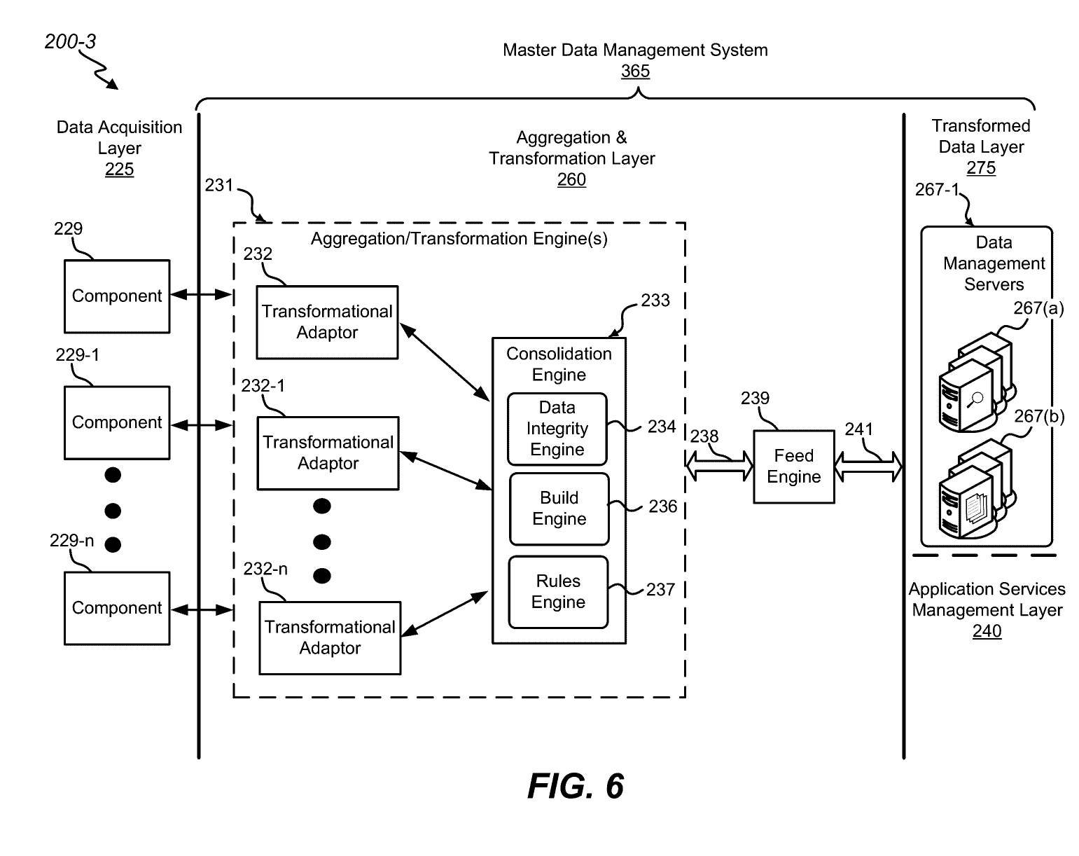

FIG. 6 shows a diagram of another portion 200-3 of the architecture stack 200 of the interaction infrastructure 102, in accordance with certain embodiments of the present disclosure. In particular, the portion 200-3 at least in partially includes the data acquisition layer 225, the aggregation and transformation layer 260, and the transformed data layer 275. The data acquisition layer 225 may receive data from components 229. In various embodiments, the components 229 may correspond to any one or combination of data sources disclosed herein and/or the like, with aggregation being facilitated in some embodiments with any one or combination of interfaces 105, 107, 111, 114 and/or client devices 205, 207. In some embodiments, the components 229 may correspond to data sources from which relevant suggestions for particular geographies may be mined for autosuggestion embodiments disclosed herein. In some embodiments, the components 229 may include complimentary layers to facilitate data transmission, such as a transmission layer, generation layer, and/or a receiving layer to communicate and/or receive data via the data acquisition layer 225. In various embodiments, the input from the components 229 may correspond to any one or combination of raw data, unstructured data, structured data, information, and/or content which may include media content, text, documents, files, instructions, code, executable files, images, video, audio, and/or any other suitable content suitable for embodiments of the present disclosure. For example, data from 20, 200, or any number of different sources may be merged together with data generated internally, data previously received, data from third parties, etc. The data could relate to end users, providers, entities, geographic locations, demographic information, and/or the like. For example, the aggregation and transformation layer 260 may identify which data and records are about the same entity and may merge attributes from different sources into one composite object that can be used by the application services as a basis for services provided.

The aggregation and transformation layer 260 may provide a pipeline that processes data input from the components 229, applies rules, transforms the data, feeds the transformed data to the transformed data layer 275 and/or the application services management layer 240. In some embodiments, aggregation and transformation layer 260 may facilitate the aggregation and transformation of data to facilitate the autosuggestion embodiments disclosed herein. The aggregation and transformation layer 260 may include one or more aggregation and/or transformation engines 231. In various embodiments, the aggregation and/or transformation engine 231 may correspond to an integral engine or separate engines working in conjunction. The aggregation/transformation engine 231 may transform, translate, or otherwise adjust data collected. [0003] In some embodiments, two or more of the components 229 may generate data according to different formats. The data can then be transformed, translated, or otherwise adjusted by the engine 231. For example, acquired data may be converted from a first format to a second format using one or more conversion rules, which may be user-defined, heuristic, and/or machine-learned. In some embodiments, the transformation engine 231 may perform similar operations with respect to other data generated by elements of the interaction infrastructure 102.

In some embodiments, the aggregation and/or transformation engines 231 may include one or more transformational adaptors 232. In some embodiments, one or more transformational adaptors 232 may be associated with the components 229 to effect the transformations. The transformational adaptors 232 may be implemented, in various embodiments, in hardware and/or software. In some embodiments, a transformational adaptor 232 may include a hardware device and/or software component that transforms, translates, converts, or otherwise adjusts the acquired data. In various embodiments, the adjustment operations may be executed within the data acquisition layer 225 and/or the transformation layer 260.

A consolidation engine 233 may process manifold data sets that may, for instance, come from different sources or the same source, for example, by way of one or more updates to data previously provided by a particular source, and the consolidation engine 233 may consolidate the data sets to form a composite data set, such as candidate data for autosuggestions particularized to specific geographical areas. The consolidation may include organizing, categorizing, qualifying, and/or comparing the sets of information; detecting, identifying, and/or handling errors/discrepancies; and/or otherwise processing the data sets. In some embodiments, the consolidation engine 233 may identify subset of entities that are more important than the rest, may process data to identify relations to at least one entity of the subset of entities, and may process data having such relation first. In some embodiments, the consolidation engine 233 may only consolidate the data having such relation and may disregard and/or dispose of data that does not possess such relation.

With certain embodiments, a data integrity engine 234 with one or more processors may check data sets to ensure quality of the data. In some embodiments, quality of suggestions (e.g., search results corresponding to suggestions) may be assessed. The data integrity engine 234 may assess each piece of information relating to an aspect (e.g., data relating to a listing of information for an entity, such name, location, reviews, ratings, etc.) and may assign a weight to the information according to a score. Any suitable scoring system may be used. Missing information, for example, could have a lower score than non-missing information; and the missing information could be scored even lower, the more important the information is to the aspect. Information may be weighted according to the source. For example, in some instances, information relating to a company that is gathered from the company's website may be weighted higher or lower relative to information gathered from a third party's website; tracking data gathered from an end-user device, for example, may be considered more reliable than corresponding/conflicting information from a third party directory service. Scoring profiles (e.g., compiled for end users, providers, entities, etc.) based the information based upon the underlying reliability of information may avoid provisioning of misdirected, redundant, unwanted, and/or unnecessary services.

In certain embodiments, the data integrity engine 234 may examine items of information and assign scores according to how important such information is to services, generally. The data integrity engine 234 may take into account service categories. Data pertinent to service categories may be prepared as a basis for provisioning services corresponding to particular categories. In certain embodiments, the data integrity engine 234 may adjust scoring of information in view of a specific services and/or specific categories of services. In certain embodiments, the data integrity engine 234 may examine items of information in view of a specific services and/or specific categories of services upfront, thereby rendering subsequent readjustment unnecessary. Based on the scoring, certain data may be discarded or flagged for possible follow-up and/or prompting for further information and/or clarifying information may be identified, generated, and/or provided. Accordingly, composite content can be made more reliably with possible follow-up and/or prompting for a data source to link to for more missing information.

In various embodiments, a rules engine 237 may be configured to create and manage entity rules, condition-response rules, alert/reports rules, data-formatting rules, data-sharing rules, transmission rules, aggregation rules, user authorization rules, and other similar rules. Such rules may be user-defined, fixed, heuristics, learned by elements of the interaction infrastructure 102, and any combination of the foregoing. In some embodiments, the rules engine 237 may be included in the consolidation engine 233. In some embodiments, the rules engine 237 may be separate from the consolidation engine 233.

A build engine 236 may assess quality of the data and/or the data sources. The build engine 236 may build one best data set that relates to a particular entity and/or geography (e.g., suggestion data pertinent to a particular geography). In some embodiments, the build engine 236 may build multiple high-quality data sets that relate to a particular entity, but are tailored for different purposes (e.g., different locations, intermediary channels, medial channels, and/or the like).

A feed engine 239 may be configured to process received input 238 from the aggregation/transformation engine 231. In some embodiments, the feed engine 239 may be integral with the aggregation/transformation engine 231. The feed engine 239 may generate one or more feeds 241 transferred to the transformed data layer 275 (e.g., for storage) and/or the application services management layer 240 (e.g., for more immediate use, by the content provisioning management layer 255 or another application service). In some embodiments, the feed engine 239 may generate a single feeder 241—a universal feed object—to feed the transformed data layer 275 and/or the application services management layer 240. The feed engine 239 may feed transformed data (which may include transformed information and/or transformed content in some embodiments).

In some embodiments, the feed engine 239 may implement a feeding process that feeds transformed data (which may include information and/or content in some embodiments) based on a last finishing point of a previous feeding process. The feed engine 239, in some embodiments, may push the transformed data/content/information into one or more temporary indexes. In some embodiments, the feed engine 239 may further transform the transformed data/content/information into a feed object with a data-interchange format that facilitates parsing. The feed engine 239 and/or the aggregation/transformation engine 231 may translate the data into understandable data, information, and/or content. The transformed data, information, and/or content may be directed to certain tables and/or data stores 268 based on the type of and/or an entity category to which the data, information, and/or content relates. For example, in some embodiments, the master data management system 365 may manage provider content and feed into search indexes and the content provisioning system. In some embodiments, the master data management system 365 may manage feeding of suggestion data into data stores and indexes to facilitate fuzzy autosuggestion embodiments disclosed herein.

The feeding process may include multiple processes, in some embodiments. For example, the feed engine 239 may spin out two processes: one process for communicating with a search server system 267(a); and one process for communicating with a document server system 267(b). The search server system 267(a) and/or the document server system 267(b) may process the temporary index and determine which data is absent from the data stores 268. Consequent to determining which data is needed, the data may be fed to the data stores 268.

In some embodiments, the data may be feed to the search server system 267(a) and/or the document server system 267(b) on a periodic basis (e.g., every 15 minutes or any other time period). The search server system 267(a), in some embodiments, may only retain in its search indexes information needed for retrieving suggestions and/or content objects (e.g., documents) and ranking the content objects. Thus, with such embodiments, other information not necessary for retrieval and ranking (e.g., images corresponding to an entity). The document server system 267(b) may have every entity attribute indexed for information retrieval. This bifurcation may allow for the interaction infrastructure 102 to perform super-fast retrieval. The search server system 267(a), in some embodiments, may perform matching, sorting, and/or the like, and hence may be CPU heavy. The document server system 267(b), in some embodiments, may be a disk I/O intense system and can handle those kinds of loads.

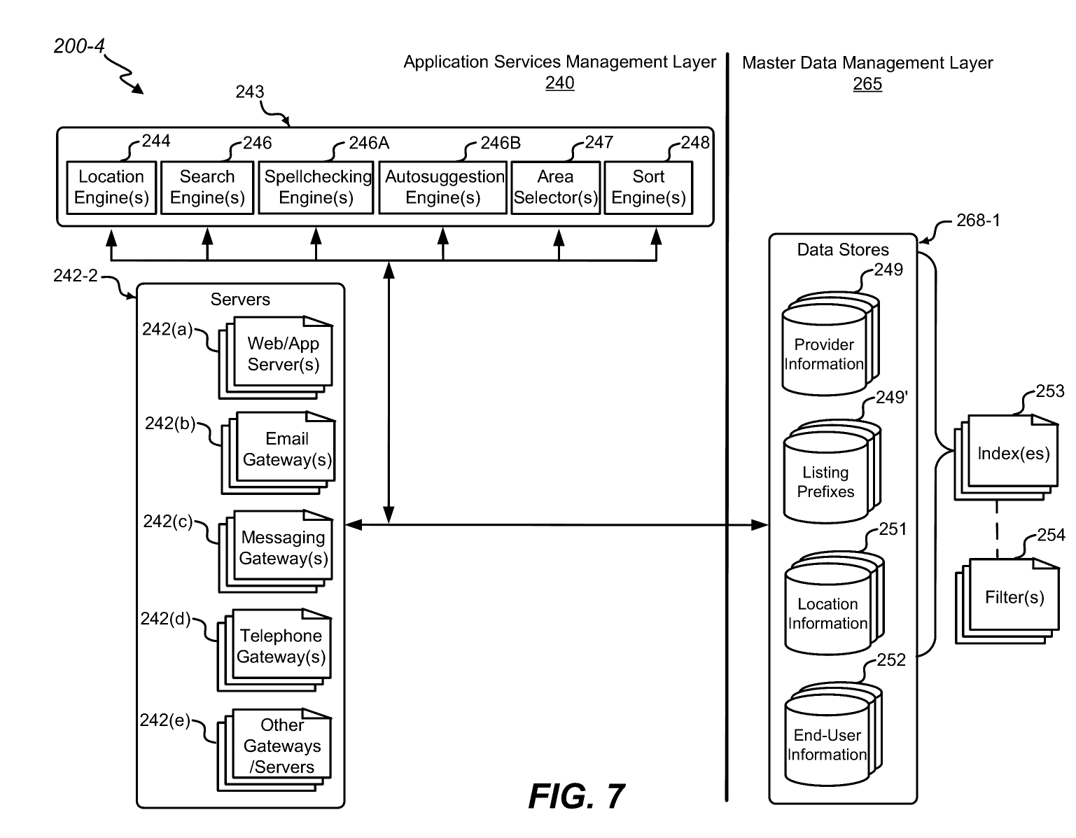

FIG. 7 shows a diagram of another portion 200-4 of the architecture stack 200 of the interaction infrastructure 102, in accordance with certain embodiments of the present disclosure. The portion 200-4 may, in some embodiments, correspond to portions of the application services management layer 240 and the master data management layer 265; and, in accordance with some embodiments, at least part of the application services management layer 240 may at least partially correspond to the search engine services layer 245. As depicted in FIG. 7, the server system 242 may include one or more communication servers. The server system 242 may include one or more web and/or application servers 242(a), one or more email gateways 242(b), one or more instant messaging gateways 242(c), one or more telephone gateways 242(d), one or more other gateways 242(e), such as television gateways, and/or one or more other types of servers, such as an application gateway (not shown) to interface with different servers. Some embodiments may use one type of communication server 242, such as a web server 242(a), to receive search requests and another type of communication server 242 to provide the search results. Some embodiments may use different types of communication servers 242 to service different types of client devices 205, 207.

The web and/or application server(s) 242(a) (referenced hereafter as a web server 242(a)) may include one or more web server and/or one or more application servers, such as mobile app servers. In some embodiments, a web 242(a) may communicate with a client device 205, 207 via HyperText Transfer Protocol (HTTP) and/or other types of communication protocols, such as File Transfer Protocol (FTP), Wireless Application Protocol (WAP), etc. A web and/or application server(s) server 242(a) may provide static web pages, dynamic web pages, and/or web services. In some embodiments, a web server 242(a) may provide web applications to a client device 205, 207 for execution in a web browser running on the client device 205, 207; and the web applications may include scripts, such as Java, JavaScript, etc., for execution within an isolated environment in a browser. In some embodiments, the web server 242(a) may provide rich-client applications to the client device 205, 207; and the rich-client application may be programmed in traditional programming languages to have full access to functions of the operating system running on the client device 205, 207.

In some embodiments, the communication servers 242 provide a user interface for user interaction with content objects. For example, the web servers 242(a) may provide a user interface via static web pages, dynamic web pages, and/or web services, etc. For example, the web servers 242(a) may provide content objects with links to detail information pages of the provider information 249, such as a map, entity hours, driving directions, etc. The web servers 242(a) may provide user interfaces for the users to rate the content, provide reviews, view reviews from other users, etc. The web servers 242(a) may provide user interfaces to complete transactions via the content objects. The web servers 242(a) can track various different types of user interactions with the content objects to determine or estimate the level of user interest in the content. The web servers 242(a) may provide rich client applications for execution in the mobile computing device to provide the user interfaces.

The communications server(s) 242 may be communicatively coupled to one or more information handling engines 243 that may provide functionality when executed by one or more servers to provide enhanced service handling features described herein. In some embodiments, one or more of the engines 243 and/or other modules may be servers communicating with other server(s) of the interaction infrastructure 102. The server communication may be over a network, such as an internal network, a local area network, a wide area network, an intranet, Internet, and/or the like. Any one or combination of the various servers may run on common or separate computers. In some embodiments, there may be one or more layers of application servers between communication servers and the data stores 268 to process the entity logic and data access of the rich client applications.

According to certain embodiments, the information handling engines 243 may be configured to implement any one or combination of the autosuggestion features disclosed herein. The information handling engines 243 may include one or more of a location engine(s) 244, a search engine(s) 246, a geo-aware spellchecking engine(s) 246A, a geo-aware autosuggestion engine(s) 246B, an area selector(s) 247, and/or a sort engine(s) 248 to process the search request and present search results based on the information stored in one or more data repositories 268. Other engines 243 may include and/or utilize the search engine 246 in various embodiments. In some embodiments, the search engine 246 may include logic for implementing searching the data stores 268 according to a search request. The searching may be in response to information received over the network 108 from an end user. Responsive to a query, the search engine 246 may search, retrieve, modify, and/or cause transfer of particular information from one or more information repositories.

The one or more data stores 268 may include provider information 249 about commercial entities or public end-user information, or other types of searchable end-user information. The one or more provider information repositories 249 may retain any local provider information (e.g., listings of provider information) suitable for embodiments of this disclosure, such as entity, product, and service information. In certain embodiments, the local provider information may correspond to directory information of the kind that may be available via Yellow Pages services and the like.

Provider information 249 may have street addresses or other location parameters, such as longitude and latitude coordinates, stored as locations in one or more location information repositories 251. The provider information 249 may include addresses, telephone numbers, descriptive content, notifications, and/or end-user information, etc. Provider information 249 may be associated with locations 251. The locations 251 may be part of the provider information 249, or associated with the provider information 249. In some embodiments, the provider information 249 may include information related to entity entities at corresponding locations 251. The entities may be entities or people. Some of the entities may pay fees to promote their content. Some of the entities may have free promotion. In some embodiments, the provider information 249 may be accessible to the public or to registered members.

In some embodiments, the data repository(ies) 268 may include one or more end-user information repositories 252. In some embodiments, a client device 205, 207 may store end-user information 252. In some embodiments, both the client device 205, 207 and the online data repository(ies) 268 store the end-user information 252 for a particular end user. In some embodiments, when there is a data communication connection between the client device 205, 207 and the online data repository(ies) 268, the client device 205, 207 and the online data repository(ies) 268 may synchronize their copies of the end-user information 252 for the end user. The end-user information 252 may be associated with the corresponding end users. In some embodiments, an end user may create corresponding end-user information 252. The web servers 242(a) may generally limit the access to the end-user information 252 to those who created the corresponding end-user information 252.

In various embodiments, the data repository(ies) 268 may be implemented in various ways. For example, one or more data processing systems may store the information related to the provider information 249, the locations 251, and the end-user information 252. For example, one or more relational or object-oriented databases, or flat files on one or more computers or networked storage devices, may store the information related to the provider information 249, the locations 251, and the end-user information 252. In some embodiments, a centralized system stores the information about the provider information 249, the locations 251, and the end-user information 252; alternatively, a distributed/cloud system, network-based system, such as being implemented with a peer-to-peer network, or Internet, may store the information about the provider information 249, the locations 251, and the end-user information 252.

In various embodiments, one or more of the location engine 244, the search engine 246, the geo-aware spellchecking engine 246A, the geo-aware autosuggestion engine 246B, the area selector 247, the sort engine 248, and/or other modules may be stored in the one or more memories and may include one or more software applications, executable with the processors, for receiving and processing data requests. In some embodiments, one or more of the location engine 244, the search engine 246, the geo-aware spellchecking engine 246A, the geo-aware autosuggestion engine 246B, the area selector 247, the sort engine 248, and/or other modules may be servers communicating with the communication server(s) 242. The server communication may be over a network, such as a local area network, a wide area network, an intranet, Internet, and/or the like. Any one or combination of the various servers may run on common or separate computers. In some embodiments, there may be one or more layers of application servers between the communication server 242 and the data stores 268 to process the entity logic and data access of the rich client applications. Alternatively, application servers may be integrated with the communication servers 242, such as the web servers 242(a). Certain embodiments are not limited to a particular type of connections among the communication servers 242, the location engine 244, the search engine 246, the geo-aware spellchecking engine 246A, the geo-aware autosuggestion engine 246B, the area selector 247, the sort engine 248, the data repository(ies) 268, and/or other modules.

In some embodiments, one computer system implements one or more of the servers 242, the location engine 244, the search engine 246, the geo-aware spellchecking engine 246A, the geo-aware autosuggestion engine 246B, the area selector 247, and the sort engine 248. Alternatively, different processes running on one or more shared computers may implement some of the components 242, 244, 246, 246A, 246B, 247, and/or 248. For example, one computing module, thread, or process may implement multiple of the components. In some embodiments, special purpose data processing systems implement the one or more of the components, such as using Application-Specific Integrated Circuit (ASIC) or Field-Programmable Gate Array (FPGA). In some embodiments, processes running according to software instructions on general purpose data processing systems, such as general purpose personal computers or server computers, can implement the components. Thus, the implementations are not limited to hardware, software, or particular combinations of hardware and software.

One or more of the location engine 244, the search engine 246, the spellchecking engine 246A, the geo-aware spellchecking engine 246A, the geo-aware autosuggestion engine 246B, the sort engine 248, and/or other modules may be configured to perform any of the steps of methods according to the present disclosure. In some embodiments, the location engine(s) 244 may include one or more engines and may use GPS coordinates, cellular tower triangulation techniques, Wi-Fi-based location information, carrier-provided location information, and/or other location determination systems to identify a location of the client device 205, 207. In some embodiments, the location engine 244 determines a location of interest to the end user related to a search request. In some embodiments, the location engine 244 determines a location of interest to the end user related to a phone call initiated with the client device 205, 207. The location of interest may be based on a location of the client device 205, 207. In some embodiments, the end user may explicitly specify the location of interest in a search request; and the location engine 244 extracts the location of interest from the search request. In some embodiments, a location of interest may be based on end-user information 252 stored for a particular end user and associated with identification information of the end user or the client device 205, 207. In some embodiments, the end user may specify some or all of the end-user information 252.

In some embodiments, the location engine 244 may automatically identify the location of interest based on determining the current location of the client device 205, 207 that is used to submit a search request and/or initiate a phone call. For example, the location engine 244 may determine the location of the client device 205, 207 based on a connection point the client device 205, 207 used to access the network 108 (e.g., based on the location of a wireless network access point, a base station of a cellular communication system, or a connection point to a wired network). In some embodiments, the client device 205, 207 automatically determines its current position (e.g., via a satellite positioning system, or a cellular positioning system) and transmits the determined or estimated position to the web server 242(a) with the search request, or provides the position in response to a request from the location engine 244.

In some embodiments, the search engine 246 may retrieve content from the data stores 268 according to a search request. In some embodiments, the search engine 246 may include or otherwise be configured to use the geo-aware spellchecking engine 246A, and/or the geo-aware autosuggestion engine 246B. In some embodiments, the geo-aware spellchecking engine(s) 246A may be used with the string corresponding to the search request to identify corrections for misspellings in search strings and/or to otherwise account for spelling variations in order to provide results with a greater degree of relevance. In some embodiments, the geo-aware spellchecking engine(s) 246A may be used with the string corresponding to the search request to identify corrections for misspellings in search strings and/or to otherwise account for spelling variations in order to provide results with a greater degree of relevance. In some embodiments, the geo-aware autosuggestion engine 246B may be used with the geo-aware spellchecking engine(s) 246A, may include the geo-aware spellchecking engine(s) 246A, and/or may be otherwise configured to account for geo-aware spelling variations and to provide such geo-aware features in conjunction with the geo-aware suggestion features described herein.

In some embodiments, the sort engine 248 may rank content objects pertaining to providers in the search results according to the distance between the location of interest and the locations 251 corresponding to the provider, or according to current levels of user interest in the retrieved content. The web servers 242(a) may track various different types of user interactions with the content objects to determine or estimate the level of user interest in the content objects. The sort engine 248 may rank the content objects according to other criteria, in accordance with other embodiments described herein. In various embodiments, the search engine 246 may be configured to search for and/or correlate user data, provider data, location data, and/or other data, in accordance with various embodiments described herein. In some embodiments, the sort engine 248 may be used to provide sorting features in conjunction with the geo-aware suggestion features described herein.

The client device 205 may indicate a geographic location when submitting the query. Alternatively, the system may determine an indication of the geographic location of the client device 205 based on the submitted query. In various embodiments, the area selector 247 may be configured to select areas of interest, in accordance with various embodiments described herein. In some embodiments, the area selector 247 may select a first geographic area based on the location of interest identified by the location engine 244. The search engine 246 may then retrieve a first set of content objects (which could include service provider information in some embodiments) that have corresponding location(s) within the selected first geographic area and that satisfies the search criteria. In some embodiments, if sufficient results are not found for the first geographic area, a second geographic area may be selected in an iterative process, which second area may or may not include the first geographic area, for searching. The first geographic area could correspond to a service area in some embodiments. In some embodiments, the search engine 246 may search for providers in a target area to obtain a set of search results; the area selector 247 may select geographic areas and selects groups of results that are within the selected geographic areas respectively. In some embodiments, the geo-aware autosuggestion engine 246B may be used with the area selector 247, may include the area selector 247, and/or may be otherwise configured to provide for such area selection features in conjunction with the geo-aware suggestion features described herein.

In some embodiments, the client device 205, 207 includes a web browser which allows the end user to submit a search request to one of the web servers 242(a) for location dependent information, such as a listing 252 of a provider. Alternatively or additionally in some embodiments, the client device 205, 207 includes a mobile application which allows the end user to submit a search request to one of the web servers 242(a) for location dependent information. Alternatively, the client device 205, 207 may provide the search request via other communication channels, such as email, short message service (SMS), instant messaging (IM), telephone connection, etc. For example, the client device 205, 207 may provide the search request to an email gateway 242(b) via email, or to an IM gateway 242(c) via instant messaging, or to a telephone gateway 242(c) via a telephone call, or to a television gateway 242(e) via an interactive television system. Some embodiments may use other types of gateways, such as gateways for SMS. Thus, the disclosure is not limited to the examples or combinations illustrated.

Certain embodiments may provide for associating listing information 249, location information 251, and prefixes 249′ for the listings of provider information. One or more indexes 253 for the associated provider information 249, location information 251, and prefixes 249′ may be built, updated, and maintained in some embodiments. In some embodiments, one or more inverted indexes 253 may be implemented. The one or more inverted indexes 253 may store mapping for the associated provider information 249, location information 251, and prefixes 249′. The one or more inverted indexes 253 may allow for faster information retrieval with search engine(s) 246 according certain embodiments.

In some embodiments, particular words may be stored in indexes 253. In some embodiments, each word may be linked to one or more documents, collections, files, fields, database structure/elements, or other forms of listing information that contain those words. In some embodiments, one or more inverted lists for each n-gram corresponding to the words may be created and may be associated with the words. For example, consider the string of “Max Bar & Grill,” which can be decomposed into 2-gram sets such as {‘ma’, ‘ax’, ‘x#’, ‘#b’, . . . } where # stands for a space; into 3-gram sets such as {‘max’, ‘ax#’, ‘x#b’, . . . }; and/or into other n-grams sets. In some embodiments, the decomposition may include word-level decomposition. Using the same example string of “Max Bar & Grill,” various n-gram sets could include {‘max’, ‘bar’, ‘grill’, ‘max bar’, ‘bar &’, ‘& gril’, ‘max grill’, ‘bar & grill’, . . . }, for example.

An inverted list for a given n-gram may include any and/or all instances of strings from a plurality of strings that contain the n-gram. In some embodiments, a list may include identifiers of strings, in lieu of actual strings, for mapping to actual strings. This may improve efficiency. The string identifiers could be unique identifiers.

In some embodiments, the indexes 253 may allow for approximate string matching at least partially based on decomposition of strings, such as into n-grams or words, and building inverted lists based on the decompositions. In some embodiments, inverted lists may be based on tokens or other identifiers associated with the n-grams or words. In some embodiments, similarity of strings may be measured in terms of similarity of the respective n-grams, words, and/or identifiers. In some embodiments, the indexes 253 may include a multiplicity of possible variations for various strings. For example, the example string of “Max Bar & Grill” can have multiple corresponding strings at the word level, such as “mac's bar & grill,” “mack's bar & grill,” “mac's bar 'n grill,” “max bar 'n grill,” “macs bar & grill,” “maxbar grill,” “maxbargrill,” etc. Thus, misspellings and spelling variations may be anticipated. Stemming may be used to allow for variations such as “sport bar” instead of “sports bar.” Including misspellings and spelling variations may allow for the capture of the relevant information. The same example string of “Max Bar & Grill” can have multiple corresponding strings at the character level for various n-gram sets in some embodiments. Accordingly, the indexes 253 may allow for prefix matching that is not too strict and, more generally, the indexes 253 may allow for fuzzy search engine capabilities.

Various embodiments may employ various similarity measures that may be tailored to facilitate linking to the indexes and/or retrieval of documents and/or listing information retained in any other suitable form, collection, file, field, database structure/element, etc. For example, TF/IDF (term frequency/inverse document frequency) may be used to assess the significance of a particular word/n-gram with respect to a particular document and/or with respect to particular strings. The IDF for each n-gram in one or more strings, such as strings within a database, dataset, or table within a database, may be determined. The IDF of a token or string is the inverse of the total number of times that this token or string appears in a data collection, such as a database. In some embodiments, an IDF may indicate a weight for weighted similarity measures.

In some embodiments, the search engine may employ similarity measures between multiple strings to allow for fuzzy searching. The search engine may process one or more characters corresponding to user input of a search string and parse the search string into sets of n-grams compared the search string with index information. For example, the characters of an incomplete user-entered search string could be “macs b”. The characters could be processed and decomposed into n-grams similar to the examples given above. The sets of characters could be compared to index entries to assess similarity using any suitable algorithm. Some embodiments may identify intersections between multiple sets and assigned a similarity score based on the extent of n-gram intersections between the search string and index entries, with a greater extent of an intersection of common characters indicating a greater degree of potential similarity between corresponding sets. For example, the search string “macs b” may be identified as a having a high extent of intersection with one or more index entries for “Max Bar & Grill,” which may include the variant “macs bar & grill.”

In some embodiments, the string length may be taken into account as a qualification for similar measures in order to allow for anticipatory/predictive auto-suggestion features discussed herein. In other words, the shorter length of the incomplete search string “macs b” with respect to the longer length of the index entries for “Max Bar & Grill” may be accounted for when assessing similarity. The disparity of lengths may not prevent identification of similarity. Hence, the high extent of intersection with n-grams of similar length and ordering associated with the n-grams of the first portion(s) of “Max Bar & Grill” may be identified even though the incomplete search string “macs b” may not have a high extent of intersection with subsequent portion(s) of “Max Bar & Grill.” However, comparable string lengths may also be considered in assigning greater similarity scores. For example, the incomplete search string “macs b” may have high similarity with index entries for “Max Bar & Grill,” but also with index entries for “Mac's Bar.” In such instances, the aspect of comparable lengths of the search string and “Mac's Bar” may be recognized as indicating even greater similarity and thus the similarity score between the two may be higher than the similarity score between the search string and “Max Bar & Grill.”

In some embodiments, a similar order of the intersecting sets may be taken as an additional indication of similarity. For example, a user-entered search string with “grill macs” may have a certain extent of character intersection with index entries corresponding to one entity, “Max Bar & Grill,” and may have a certain extent of characters section with index entries corresponding to another entity, “Grill Max,” however the orders of the intersecting sets may be recognized as being different with respect to these example cases. The ordering of n-grams of the search string “grill macs” has a greater correspondence to the ordering of n-grams of “Grill Max” than it does with respect to “Max Bar & Grill.” Accordingly, the search string “grill macs” may be accorded a greater similarity score with respect to “Grill Max” and a lesser similarity score with respect to “Max Bar & Grill.”

The above examples consider an entity name; however, various embodiments may employ the same methods with respect to other types of listing information. For example, category and/or keyword strings can be decomposed in similar manner. Furthermore, entity names may be associated with various categories and/or keywords. For example, in some embodiments, sets corresponding to a given entity may include associated categories and/or keywords. Shingles of words associated with listings, service areas, and popular queries may be stored. In some embodiments, sets corresponding to a given entity may be linked to other sets of categories and/or keywords, for example, via pointers and/or other look-up tables. It should be understood that any suitable relational database approach may be used to associate the various sets and/or members thereof.

As addressed above, certain embodiments may provide a spellchecker service that is geo-sensitive. For example, for a search in the area of Monrovia, Calif., the geo-aware spellchecker 246A may recognize that an entry of “Plummer” should not be corrected to “Plumber.” To facilitate the geo-sensitive spellchecking, words corresponding to listings, and variations of the words, may be stored and linked to corresponding location information. The linking may be provided by way of the one or more indexes 253, with the word variations and locations being stored in inverted index(es) in some embodiments. Accordingly, with the word variations, the indexes 253 may store corrections for misspelled search strings in order to account for spelling variations. However, not all corrections make sense for a particular area, as in the example given above. To address that reality, the indexes 253 may be configured such that the linked location information allows for spellchecking tailored to a location of interest. The geo-aware spellchecker 246A may determine whether one or more corrections or an original query makes more sense in a particular area. Based on that determination, corrections which do not make sense in that area may be filtered out. Accordingly, the accuracy of spelling corrections may be improved, and false positives may be minimized.

The geo-aware spellchecker 246A may receive the search string and may identify one or more potential corrections for the search string. The geo-aware spellchecker 246A may look up the search string and the one or more potential corrections in the index(es) 253, comparing the search string and the one or more potential corrections to listing information for the identified location. If the search string is identified as a possibility for the particular location, then that may be an indication that the search string should not be corrected. If, however, the search string is not identified as a possibility for the particular location, then that may be an indication that the search string should be corrected. In some embodiments, a decision tree may be employed to check the search string first, then the most likely applicable potential correction, then the next most likely applicable potential correction, and so on until a positive indication is found in the index(es) 253. In some embodiments, the geo-aware spellchecker 246A may identify one or more potential corrections for the search string first in a geo-oblivious manner, and then analyze the potential corrections for applicability to an identified location. In some embodiments, the geo-aware spellchecker 246A may only identify a limited set of one or more potential corrections for the search string that are applicable to an identified location.

Certain embodiments may provide a clustering-based approach to facilitate the geo-sensitive spellchecking Words corresponding to listings, and variations of the words, may be stored and linked to corresponding location information, where the location information may include location identifiers, such as latitude and longitude coordinates, for the listings. For example, entity names may be stored with coordinates for the entities. Then, clusters may be formed based on the location information. For example, when displayed on a map, entities with a given entity name (such as a chain of restaurants) may have multiple locations. Using any suitable clustering algorithm, one or more boundaries may be drawn or otherwise defined to surround one or more clusters of the entities.

The corresponding clusters of data may be used for verification of a search string and one or more potential corrections for the search string. The geo-aware spellchecker 246A may receive the search string and may identify one or more potential corrections for the search string. The geo-aware spellchecker 246A may look up the search string and the one or more potential corrections in the clustered data, comparing the search string and the one or more potential corrections to listing information in the cluster that corresponds to the identified location. Stated otherwise, the geo-aware spellchecker 246A may check if a word and/or n-gram is found in the cluster. If the search string is identified as a possibility for the particular location, then that may be an indication that the search string should not be corrected. If, however, the search string is not identified as a possibility for the particular location, then that may be an indication that the search string should be corrected. In some embodiments, a decision tree may be employed with the cluster, as discussed above.

As addressed above, certain embodiments may provide an autosuggestion service that is geo-sensitive. The autosuggestion service may provide type-ahead suggestions that are geographically relevant. As a user types a search query, the user may be presented with the type-ahead suggestions that are relevant to user's current geography and/or another geography of interest. Though reference is made herein to type-ahead suggestions and in some embodiments one or more suggestions could appear in the query field as a type-ahead suggestion, the term type-ahead suggestion could include other manners of presentation, such as over at least a portion of the query field, or beside the query field so that a user may accept a suggestion via selection of a space key, selection of an enter key, or any other suitable manner of selection. In some embodiments, the search engine 246 may configured with the geo-aware autosuggester 246B to effect a geo-aware autosuggest search engine. In some embodiments, the search engine 246 may include the geo-aware autosuggester 246B. In some embodiments, the search engine 246 may not include, but may be configured to work in conjunction with, the geo-aware autosuggester 246B. In various embodiments, the geo-aware autosuggester 246B may be integral with or independent of the search engine 246. In various embodiments, a geo-aware autosuggester 246B could be implemented separately or without the spellchecking module 246A. In some embodiments, the geo-aware spellchecking module 246A could be configured as a geo-aware autosuggester 246B such that autosuggestion features are an extension of spellchecking features.

The geo-aware autosuggester 246B could receive a series of search string characters and perform a lookup with the reception of each character or set of multiple characters. The lookup could be performed with one or more indexes 253. In some embodiments, one or more filters 254 could be used in conjunction with the one or more indexes 253. To facilitate the geo-aware autosuggestion, words corresponding to suggestions/listings, and variations of the words in some embodiments, may be stored and linked to corresponding location information. For example, suggestions/listings corresponding sets of words and/or n-grams may be linked to location information in the indexes 253.

The autosuggestion service may provide suggestions that are relevant to a geographical area(s) of interest. The suggestions may correspond to listings that in close proximity to an area of interest, as providing suggestions that are too far away from the area of interest may negatively impact the user experience. In providing suggestions, the autosuggestion service may allow for a quick response time so that suggestions are provided between key presses of a user. By way of example, the autosuggestion service may provide suggestions on the order of milliseconds or tens of millisecond in response to each character input. Given such constraints, it may be advantageous to divide geographical areas into multiple smaller areas. A code may be assigned to each small area, and that area code may be assigned to the suggestions relevant to that area.

Accordingly, the location information may include location identifiers. Linked information may be distinguished, segregated, and/or categorized based on location in any suitable manner, with any suitable location identifiers being used to link information to corresponding areas. In various embodiments, the location could have any suitable level of specificity, e.g., including a county, a municipality, zip code, school district, entity directory service area, and/or the like. For example, a zip code, a collection of zip codes, one or more listing service directory codes (which may correspond to particular telephone directory service areas, which service areas could be defined by zip code(s)), and/or the like may be used as a basis for linking information to a location.

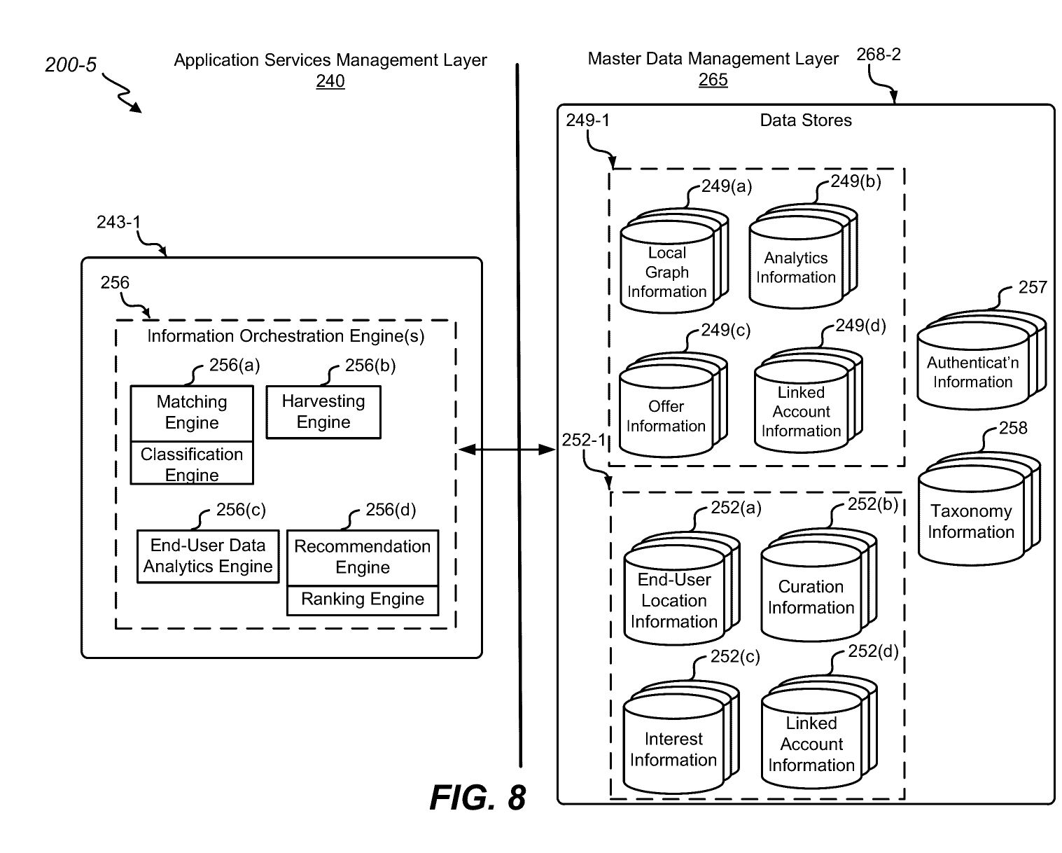

FIG. 8 shows a diagram of another portion 200-5 of the architecture stack 200 of the interaction infrastructure 102, in accordance with certain embodiments of the present disclosure. The portion 200-5 may, in some embodiments, correspond to portions of the application services management layer 240 and the master data management layer 265; and, in accordance with some embodiments, at least part of the application services management layer 240 may at least partially correspond to the customized orchestration layer 250.

The customized orchestration layer 250 may include one or more of the information handling engines 243. The engines 243 may include one or more information orchestration engine(s) 256. In some embodiments, the information orchestration engine(s) 256 may include logic for implementing any features of personalized orchestration of entity information and/or user-specific services in various embodiments disclosed herein. In some embodiments, the information orchestration engine(s) 256 may facilitate an application on the end-user device to provide any such features. In some embodiments, the information orchestration engine(s) 256 may be incorporated in the application.

In certain embodiments, the information orchestration engine(s) 256 may be configured to compile keyword criteria, for example, in an ontology, and could include an ontology reasoner or semantic reasoning module to make logical inferences from a set of facts in the ontology. Accordingly, the information orchestration engine(s) 256 may correspond to a reasoning engine configured to effect one or more features described herein. A pattern-based reasoner could be employed to use various statistical techniques in analyzing interest data in order to make inferences based on the analysis. A transitive reasoner could be employed to infer relationships from a set of relationships related to interest data. In certain embodiments, the information orchestration engine(s) 256 may include logic for implementing workflow features in various embodiments.

In some embodiments, the information orchestration engine(s) 256 may include logic to implement and/or otherwise facilitate any taxonomy, classification, categorization, correlation, mapping, qualification, scoring, organization, and/or the like features discussed herein. In some embodiments, the information orchestration engine(s) 256 may include a matching engine 256(a) configured to facilitate one or more such features. For example, the matching engine 256(a) may be or include a classification engine configured to classify each of a plurality of entities into at least one category of a set of categories that represent classifications of entities based at least in part on one or more sets of attributes defined for classifying various entities. For example, information with respect to a particular entity may be analyzed in order to identify one or more entity attributes. The matching engine 256(a) can receive entity information, identify attributes of the entity based at least in part on the entity information, and match the entity to one or more categories based on category information retained in a repository. The entity may be matched to one or more categories that each represent classifications of entity sharing common attributes. In some embodiments, one or more taxonomies that map particular profile information to particular categories may be used in correlating entity profile information with one or more categories. The entity could be classified according to products and/or services that the entity provides. The entity could be classified according to location, for example, a segment that the entity serves and/or a physical site of the entity. The entity could be linked to location identifier(s) (such as a directory code(s) relevant to the entity listing of the suggestion); geo coordinates corresponding to the entity (e.g., latitude and longitude); and/or the like.

As another example, the matching engine 256(a) may be or include a classification engine configured to classify each of a plurality of end users into at least one category of a set of categories that represent classifications of end users based at least in part on one or more sets of attributes defined for classifying various end users. As a further example, the matching engine 256(a) may be configured to process first information enabling unique identification of a particular end user, process second information about a first location corresponding to the end user, and match the end user to a first category from the set of categories.

In some embodiments, the matching engine 256(a) may be configured to match the user to one or more entities based at least in part on correlating categories. The matching could, in some embodiments, be based at least partially on comparing user attributes/categories with entity attributes/categories. For example, they may be matched according to preferences, certain biographical information, demographic information, interests, location information, etc.

Any suitable correlation process may be employed. A scoring system could be correlated to the category scheme in some embodiments, such that certain scores correspond to matches of certain categories. Some embodiments may score a match with a numerical expression, for example, a match score, with higher scores being assigned to higher correlations of user attributes/categories with entity attributes/categories. A high correlation may be identified using any suitable qualification scheme (e.g., a score threshold, a score ranking, etc.).

In some embodiments, the information orchestration engine(s) 256 may include one or more harvesting engines 256(b). In some embodiments, the harvesting engine 256(b) may include logic for implementing information logging features in various embodiments. In some embodiments, the harvesting engine 256(b) may be configured to gather data about an identified end user from one or more data sources. By way of example without limitation, the harvesting engine 256(b) could process data pulled and/or pushed from various entities. The harvesting engine 256(b) could handle process, extracting, formatting, and/or storing/recording data including data for indicia of interest, preference data, taxonomy data, mapping data, and/or the like. In some embodiments, the harvesting engine 256(b) may work in conjunction with the service monitoring engine 228; in some embodiments, the harvesting engine 256(b) may correspond in whole or in part to the service monitoring engine 228. The harvested data may then be analyzed to determine one or more attributes of the first end user.

In some embodiments, the information orchestration engine(s) 256 may include interest data analytics modules may include logic to retrieve, process, derive, compile, aggregate, handle, store, report, and/or present information relating to interest data. In some embodiments, the information orchestration engine(s) 256 may include one or more end-user data analytics engines 256(c) configured to facilitate one or more such features. In some embodiments, one or more data analytics engines 256(c) may include logic to retrieve, process, derive, compile, aggregate, handle, store, report, and/or present information relating to end-user data. The performance analytics engine(s) 256(c) may be configured to present any desirable information in any desirable manner. With respect to a particular provider, the logging engine(s) 256(b) and end-user data analytics engine(s) 256(c) may facilitate various features of one or more provider interfaces, in accordance with certain embodiments herein.

In some embodiments, the information orchestration engine(s) 256 may include one or more recommendation engines 256(d). The recommendation engine 256(d) may be configured to analyze end-user information 252 for particular end users and aggregated, classified provider information 249 to identify a set of one or more recommendations (e.g., of offers, entities to add to a collection, etc.). The recommendation engine 256(d) may generate one or more recommendations. Certain embodiments may identify recommendations based at least partially on similarities of characteristics of a first end user and characteristics of other users having associations with entities (e.g., having added the entities to their collections). Any suitable algorithm for assessing similarity may be employed. Some embodiments may identify intersections between multiple sets of characteristics. Having set intersections identified, the intersections may be compared. A greater extent of an intersection may be an indication of a greater degree of similarity between the users. In some embodiments, the sets may be ranked according to the extent of the intersections. In some embodiments, the recommendations are used by the infrastructure 102 to personalize the fuzzy autosuggestion embodiments disclosed herein. In various embodiments, data may be mined in order to influence the fuzzy searching, suggestion relevance determinations, and suggestion weighting and scoring.

In some embodiments, the data stores 268 may include one or more authentication information repositories 257 may retain any authentication information suitable to facilitate security for embodiments of this disclosure. The authentication information repositories 257 may include database(s), database management system(s), server(s) to facilitate management/provision/transfer of authentication information, and/or the like. The repositories 257 may retain authentication information of one or more particular end users, providers, and/or other data sources. The authentication information may include information to check credentials of end users, providers, and/or other data sources that may use one of their corresponding interfaces to seek access, transfer information, and/or make entity-related transactions with the interaction infrastructure 102. The authentication information may be used to provide security for transactions, restrict the access granted to a certain set of information and/or features, implement certain control and/or features for certain parties, and/or the like.

In some embodiments, the one or more data stores 268 may include one or more taxonomy information repositories 258 to retain any suitable information associated with taxonomy feature in accordance with various embodiments disclosed herein. For example, one or more taxonomy information repositories 258 may retain mapping information, classification information, scoring criteria, and/or the like. Information retained in one or more taxonomy information repositories 258 may be used to classify user interest data/indicia, classify entities, map user interests, entities, and/or interest categories, and/or otherwise correlate and organize information in accordance with various embodiments disclosed herein.

As described above, the one or more provider information repositories 249 may retain provider information of particular providers. The repositories 249 may retain any information related to providers, including entities and people, which may have street addresses or other location parameters, such as longitude and latitude coordinates, maps, driving directions, and/or the like, stored as locations in one or more location information repositories 251. For example, one or more provider information repositories 249 may retain any information related to provider identification information, provider profiles, provider certification information, entity description, product descriptions, service descriptions, ratings/reviews/comments/preference indicia associated with providers, provider websites, provider authentication information, provider statuses, provider relationships, organization details, payment methods, accounting information, credit information, asset information, collateral information, address information, contact information, entity hours, availability, user account information, descriptive content, notifications, and/or the like.

In some embodiments, provider information may include local graph information 249(a). The local graph information 249(a) may include mapping information about a provider's connections to collections, windows, end users, and/or the like via the orchestration service. The local graph information 249(a) may include classification information about a provider and relation to user interest data and entity categories. Generally, the local graph information 249(a) may include any information to facilitate provider inclusion in the orchestration platform in accordance with various embodiments described herein. In some embodiments, the local graph information 249(a) may be used by the infrastructure 102 to personalize the fuzzy autosuggestion embodiments disclosed herein. In various embodiments, local graph data may be mined for suggestions in order to influence the fuzzy searching, suggestion relevance determinations, and suggestion weighting and scoring.

Provider information may include analytics information 249(b). The analytics information 249(b) may include any performance information related to particular providers, including any end-user data analytics related to particular providers. Provider information may include offer information 249(c) retained for particular providers. The offer information 249(c) may include offers that particular providers have created, entity rules associated with provisioning offers to end users, and/or the like. Provider information may include linked account information 249(d). The linked account information 249(d) may include information about a provider's account(s) that are linked with the orchestration system, such authentication information for linked accounts, which accounts may include email accounts, short messaging accounts, online social/entity networking accounts, and/or the like. The analytics information 249(b), the offer information 249(c), and the linked account information 249(d) may include any information to facilitate various features of one or more provider interfaces, in accordance with certain embodiments herein. In some embodiments, the analytics information 249(b) may be used by the infrastructure 102 to influence the fuzzy autosuggestion embodiments disclosed herein. In various embodiments, performance data may be mined in order to influence the fuzzy searching, suggestion relevance determinations, and suggestion weighting and scoring.

The one or more end-user information repositories 252 may retain any suitable information associated with users in accordance with various embodiments disclosed herein. The end-user information may include end-user identification information, payment methods, accounting information, contact information, user account information, and/or the like. One or more end-user information repositories 252 may retain any information related to end-user location information 252(a), curation information 252(b), interest information 252(c) related to end user (which may include information related to indicia of interest), linked account information 252(d), and/or the like. The curation information 252(b) may include local graph information, which may include information about providers of interest, providers that have been added to a user's collection, geo-specific criteria for end user collections/profile, entity information otherwise associated with the end user (which may include collection followings, e.g.), notes by the end user, photos and/or other images associated with the end user, preferences of the end user, arrangement/organizational particulars for entity information associated with the end user, end-user requests, and/or any suitable information to facilitate any one or combination of the personal curation features described herein. The linked account information 252(d) may include information about an end user's account(s) that are linked with the orchestration system, end-user notification profiles, end-user authentication information, and/or any information to facilitate various features of one or more end-user interfaces, in accordance with certain embodiments herein.

In some embodiments, a client device 205, 207 may store end-user information 252. In some embodiments, both the client device 205, 207 and the online data stores 268 may store the end-user information 252 for a particular end user. In some embodiments, when there is a data communication connection between the client device 205, 207 and the online data stores 268, the client device 205, 207 and the online data stores 268 may synchronize their copies of the end-user information 252 for the end user.

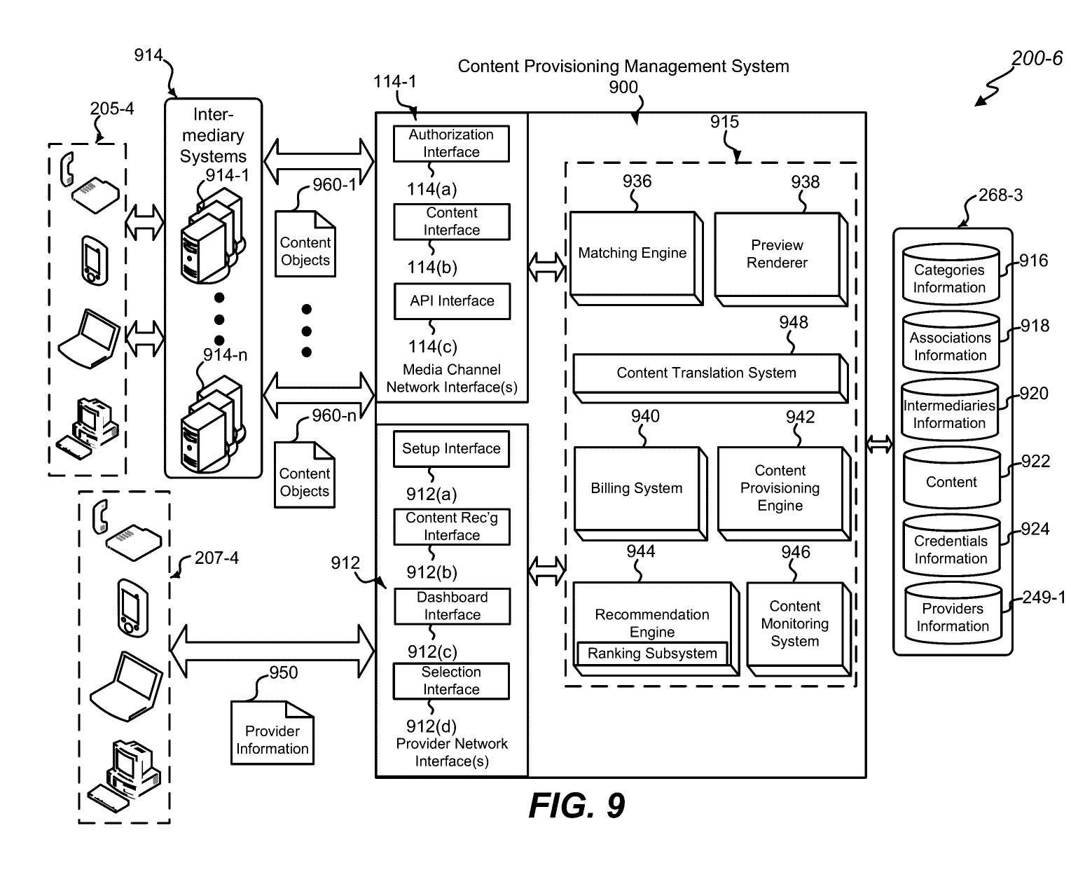

FIG. 9 shows a diagram of another portion 200-6 of the architecture stack 200 of the interaction infrastructure 102, in accordance with certain embodiments of the present disclosure. The portion 200-6 may, in some embodiments, correspond to portions of the application services management layer 240 and the master data management layer 265. In accordance with some embodiments, portion 200-6 may at least partially correspond to the content provisioning management layer 255.

In some embodiments, a content provisioning management system 900 may provide a single interface for a provider to manage content transmitted by intermediary systems 914 to client devices 205 on behalf of a provider. In some embodiments, the content provisioning management system 900 can use categories to customize recommendations to the provider in managing content provided to intermediary systems 914.

The provider may make decisions that can include implementing recommendations provided by the content provisioning management system 900. By using the content provisioning management system 900, the provider does not need to manage each intermediary relationship separately. Further, the provider can be provided more summary information about end user sentiment and/or activity, than could be observed through separate intermediary interactions.

The content provisioning management system 900 can provide a central point to manage information between the provider devices 207, intermediary systems 914, and end-user devices 205. The content provisioning management system 900 monitors and analyzes particularized content served by intermediary systems 914. Some content served by intermediary systems 914 is provided by end-user devices 205, for example, in form of end-user ratings, review, and/or other feedback. The content provisioning management system 900 may provide information about content provided by intermediary systems 914 to the provider devices 207. The content provisioning management system 900 can receive information from the provider devices 207 and translate the information to particularized content objects that can be transmitted to the intermediary systems 914 for use by intermediary systems 914.

The content provisioning management system 900 can analyze the content objects distributed by intermediary systems 914. Based on the analysis, the content provisioning management system 900 can provide recommendations, statistics, identify areas of weakness and/or identify areas of competence. In some embodiments, the content provisioning management system 900 can implement recommendations.

Intermediary systems 914 can distribute content that is accessed by end-user devices 205. In some embodiments, end-user devices 205 provide content to intermediary systems 914 to serve. Some intermediary systems 914 can allow interaction with content through APIs, such as receiving and/or transmitting content and/or notifications. As intermediary systems 914 attract end users, it can be desirable for a provider to interact with end-user devices 205 through intermediary systems 914.

In some embodiments, the content provisioning management system 900 may be configured to match providers to intermediary systems 914 and select particular intermediary systems 914 for serving content 960 of particular providers. In some embodiments, the content provisioning management system 900 can assign intermediary systems 914 to categories. Some intermediaries can be assigned to specific categories. Other intermediaries can be considered generically applicable. In some embodiments, the content provisioning management system 900 can recommend to providers both generic intermediaries and category-specific intermediaries.

When used herein, a category may correspond to a grouping of providers that share common characteristics. Categories can include other categories (sometimes referred to as subcategories). Categories do not have to be mutually exclusive, as a provider can be assigned more than one category.

Provider specifications may be received from the provider device 207. A provider may provide unique identification information to content provisioning management system 900. The provider may specify a specific geographic area for the services provided by the provider device 207. The content provisioning management system 900 may provide distribution information (e.g., about creating a provider listing) for one or more intermediaries to a provider device 207. In some embodiments, the content provisioning management system 900 may determine a category to which the provider belongs. And, based on the category selected, the content provisioning management system 900 may recommend distribution information (e.g., creating a provider listing) for one or more intermediaries.

After receiving a selection of intermediaries, the content provisioning management system 900 may determine a superset of content to request from the provider device 207. Having received client information 950, the content provisioning management system 900 can translate the client information 950 to content 960-1 to 960-n compatible with each intermediary system 960-1 to 960-n. Content 960-1 to 960-n can then be transmitted to matching intermediary systems 960-1 to 960-n.

The content provisioning management system 900 may include provider network interface 912, engines 915, datastores 268, and intermediary network interface 114-1. In various embodiments, the one or more engines 915 may be implemented by one or more servers. In other embodiments, each engine 915 may comprise a set of servers that interact with other servers (e.g., datastores 268, engines 915, provider network interfaces 912, media channel network interfaces 114) through API calls.

The provider network interface 912 can communicate with provider devices 207 and receive client content 206-1 to 206-n. The provider network interface 912 may include interfaces to enable the management system functionality. The provider network interface 912 may include a setup interface 912(a) that enables the content provisioning management system 900 to receive unique identifying information of a provider. The provider network interface 912 may include a content receiving interface 912(b) that enables receipt of provider information 950. The provider network interface 912 may include a dashboard interface 912(c) that enables provisioning of information about content served to provide devices 207 to enable monitoring of intermediary content and changing intermediary content (e.g., add a new address, provide a new posting, etc.). The provider network interface 912 may include a selection interface 912(d) that provides recommendations of intermediaries and receives selections of intermediaries. The provider network interface 912 may include other provider network interfaces 912 and can communicate using various protocols and APIs.

The content provisioning management system 900 can include engines 218 that process information from datastores 208, provider network interface 912 and intermediary network interface 250. The content provisioning management system 900 may include a recommendation engine 244. The recommendation engine 944 may be configured to provide a list of intermediaries retrieved from the associations datastore 918 and intermediaries datastore 920. A ranking subsystem 944 can order the list of intermediaries for recommendation to the provider.

In some embodiments, the content provisioning management system 900 may include a matching engine 936 that may receive unique provider information and match the provider to a category from a category datastore 916. The category datastore 916 may include information about categories and characteristics of providers that may be identified as part of the category. Based on the matched category, the recommendation engine 944 can provide a list of intermediaries associated with the category and generic intermediaries retrieved from the associations datastore 918 and intermediaries datastore 920. The association datastore 918 may include information about provider associations with intermediaries. In some embodiments, the association datastore 918 may include information about provider associations with categories, as well. The intermediaries datastore 920 may include information about intermediaries including content accepted, ranking information, etc. In some embodiments, the intermediary datastore 920 may include category affinities, as well. The ranking subsystem 944 can order the list of intermediaries for recommendation to the provider.

A content provisioning engine 942 may receive a selection of intermediaries from provider device 207 and determine a superset of provider information 950 to receive. The content provisioning engine 942 may receive provider information 950 and may store it in a content repository 922. The content repository 922 may include provider information 950 as well as translated content from content translation system 948. The content provisioning engine 942 may generate content objects 960 based on the provider information 950. In some embodiments, the content provisioning engine 942 may cause the provider information 950 to be translated through translation system 948. The translation system 948 may generate content 960 that matches content requirements (e.g., protocol, format, content type, and/or the like) of the intermediary system 914 in order to distribute the content 960.

A preview renderer 938 may use the provider information 950 to generate a preview of how provider content would appear if served by a particular intermediary system 914. When a preview is approved by a provider, the content provisioning engine 942 may transmit one or more content objects 960 to one or more intermediary systems 914. If needed, content provisioning engine 242 may create accounts with one or more intermediary systems 914 on behalf of a provider, may store credentials in credential store 924. The credential datastore 924 may include credentials that are used on behalf of providers to access one or more accounts of intermediary systems 914. Credentials may include username/passwords, tokens, certificates, etc. The content provisioning engine 942 may use credentials to provide content objects 960 to serve via the intermediary systems 914. Content monitoring system 946 may monitor the intermediary systems 914 for changes to distributed content. Content changes may be reported back to provider device 207 by the content monitoring system 946 with recommendations on fixing any problems. The content provisioning engine 942 may implement recommendations by content monitoring system 246.

A billing system 940 may track usage, billing, and/or authorization to use the management system. The billing system 940 may bill providers based on a number of intermediaries per month, each intermediary interaction, for each service utilized and/or a monthly fee. The billing system 940 may operate in conjunction with payment processors to enable billing and payment for services.

The media channel network interface 114-1 may communicate with intermediary systems 914. The media channel network interface 114-1 may include an authorization interface 114(a) that uses credentials from credential datastore 916 to access intermediary systems 914 on behalf of providers. A content interface 114(b) may be configured to send and receive content objects 960 to/from intermediary systems 914 on behalf of providers. An API interface 114(c) may access intermediary systems 914 using APIs and provide API access to the content provisioning management system 900 by intermediary systems 914.

In one example, a car parts store representative uses a web-browser client 207-2 to connect to the content provisioning management system 900. The representative uses the setup interface 912(a) to provide a provider name, address, and product/service details. The recommendation engine 944 may provide the representative with a list of intermediaries (e.g., Facebook.com™, Google Local Listings™, Yellowpages.com™, and LinkedIn.com™) from intermediary datastore 920. In some embodiments, the matching engine 936 may determine that the car parts store is part of an automotive category based on characteristics from category datastore 916, and the recommendation engine 944 may provide the representative with a list of intermediaries that match the category of automotive (e.g., autosbarter.com) as well as generic intermediaries from intermediary datastore 920. After the representative makes the selection, the billing system 940 may require payment for the services requested (e.g., 10 intermediaries per month). The content provisioning engine 242 may determine a superset of content needed for the 10 intermediaries selected, including hours, photographs, contact information, description and a list of representative products. The content provisioning engine 942 may receive the provider information 950, store it in the content repository 920, and cause the preview renderer 938 to provide a preview of the content to the client device 207. The content provisioning engine 942 may generate content based on the information 950 which may include cause any non-conforming content to be translated through the content translation system 948 (e.g., resizing and reformatting pictures, translating formats of documents, selecting portions of provided information and inserting them into content objects, etc.). The content provisioning engine 942 may receive credentials for access to intermediary systems 914 from the client device 207 or may create them on behalf of the provider and store the credentials in the credential store 224. Using the credentials, the content provisioning engine 942 may use the authorization interface 114(a), the content interface 114(b), and/or the API interface 114(c) to deliver content 960 to intermediary systems 914. The content monitoring system 946 may monitor intermediary activities, responses, and may ensure that the content continues to be correctly provisioned. Corrections may be sent to the content provisioning engine 942 to be corrected.

In some embodiments, the content provisioning management system 900 may alternatively or additionally be configured to direct content 960 directly to client devices 205 without the intermediary of the intermediary systems 914. For example, content objects 960 may be directed to the client devices 205 as results to queries, end-user-initiated and/or system-initiated, serviced by the search engine services layer 245. As another example, content objects 960 may be directed to the client devices 205 as results to queries and/or recommendations, end-user-initiated and/or system-initiated, serviced by the customized orchestration layer 250, which may or may not use the search engine services layer 245 in various embodiments. In various embodiments, content objects 960 may be generated for presentation with various types of media channels (e.g., web page, WAP page, short message, television programs, news articles, etc.).

In some embodiments, one or more of the datastores 268, for example, provider information datastore 249, the content datastore 922, and/or the like, may contain phone numbers of target phones. Typically, the target phones belong to providers. In some embodiments, communication references may be embedded in the content 960 and provided to the client devices 205. The communication references may allow routing of calls from client devices 205 at least partially based on location in accordance with certain embodiments of this disclosure. In some embodiments, a communication reference may be a phone number. The phone number could indicate a category of providers. In some embodiments, a communication reference may facilitate a click-to-call feature.

In embodiments where a client device 205 is a mobile device, content 960 may be transferred to the device 205 through wireless communication connections, such as cellular communication links, wireless access points for wireless local area network, etc. In some embodiments, a client device 205 may be able to initiate a phone call (e.g., automatically dialing according to the encoded phone number embedded in the content information when a user selects the number). In some embodiments, dialing a phone number corresponding to a communication reference may connect the phone call to the call management system 1000, which described further below in reference to FIG. 1

0. The call management system 1000 may include one or more routers 1014, which may include switching equipment. The router 1014 may include one or both of a router and a decoder. In some embodiments, based at least partially on the communication reference selected, such as a phone number dialed and/or a call button selected, the router 1014 may determine one or more corresponding target communication references using the datastores 268 and may connect the phone call to one or more target provider devices 207 through the network(s) 108. The network 108 may include a telephone network that may be circuit switched, package switched, or partially circuit switched and partially package switched. For example, the telephone network may partially use the Internet to carry the phone call (e.g., through VoIP). For example, a connection between a client device 205 and the call management system 1000 may be carried using VoIP; and the connection between a router and a decoder of the router 1014 may be carried using a land-line based, circuit-switched telephone network.

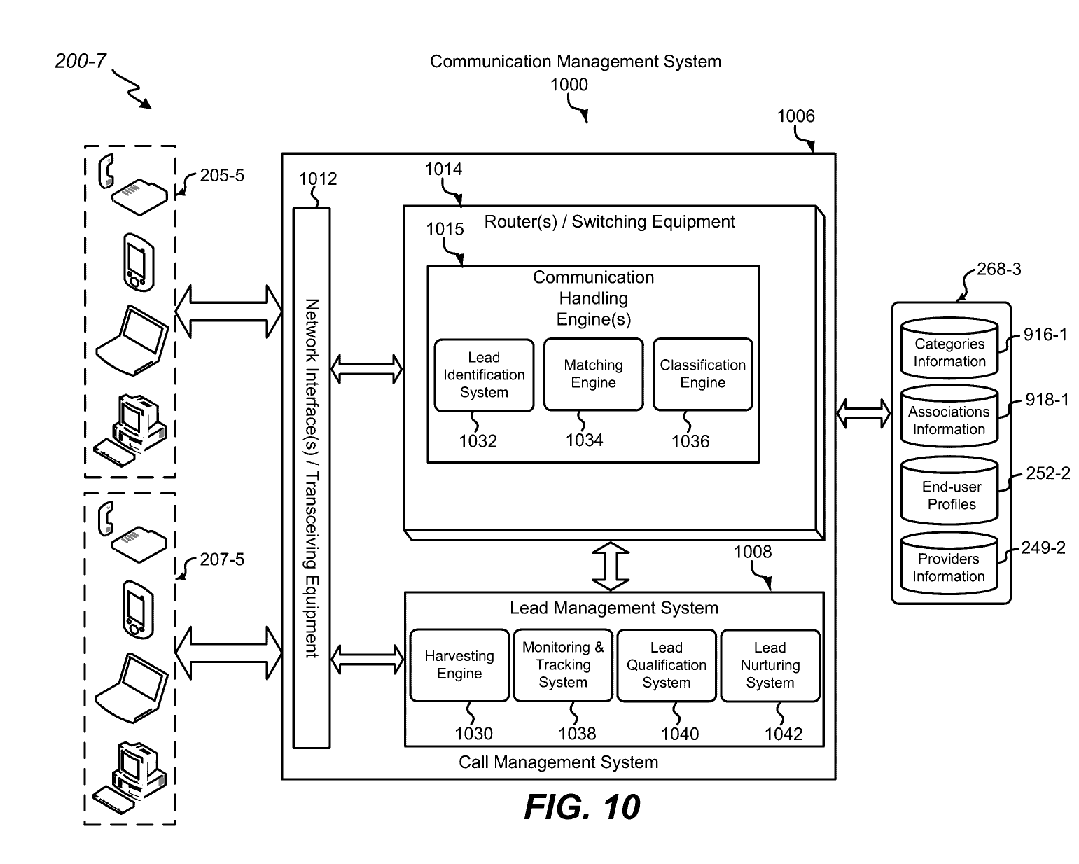

FIG. 10 shows a diagram of another portion 200-7 of the architecture stack 200 of the interaction infrastructure 102, in accordance with certain embodiments of the present disclosure. The portion 200-7 may, in some embodiments, correspond to portions of the application services management layer 240 and the master data management layer 265 and, in accordance with some embodiments, may at least partially correspond to the communication management layer 260.

The communication management system 1000 may be configured to allow for routing communications between different client devices 205 and 207 and for qualifying communications in real time. The communication management system 1000 may include a call management system 1006 and a lead management system 1008. The communication management system 1000 may include may include logic to implement and/or otherwise facilitate any call handling features disclosed herein. By way of example without limitation, the communication management system 1000 may include one or more call handling modules that may be configured to one or more of decode, route, and/or redirect calls to/from subscribers and provider representatives. Similarly, the communication management system 1000 may include one or more message handling modules that may include logic to implement and/or otherwise facilitate any message handling features disclosed herein. While systems, engines, repositories, and other components are described separately herein, it should be appreciated that the components may be combined and/or implemented differently in any combination to provide certain features in various embodiments. In various embodiments, different processes running on one or more shared computers may implement some of the components.

The communication management system 1000 may be, correspond to, and/or include one or more servers that, in various embodiments, may include one or more switches and/or media gateways, such as telephone, messaging, email, application, and/or other types of gateways. The communication management system 1000 may be configured to determine which communications from end users (e.g., calls) go to which providers (and/or vice versa). The communication management system 1000 may include one or more network interfaces 1012, one or more processors and memory. In various embodiments, one or more of the processor(s), memory, and/or network interface(s) 1012 may correspond to the one or more servers. The network interface(s) 1012 may include any suitable input/output module or other system/device operable to serve as an interface between one or more components of the infrastructure 102 and the one or more networks 108. The network interfaces 1012 may be used to communicate over the networks 108 using any suitable transmission protocol and/or standard. The one or more network interfaces 1012 may be configured to facilitate communication between end-user interfaces 205 and provider interfaces 207. In some embodiments, for example, the communications between end-user interface(s) 205 and provider interface(s) 207 could correspond to communication between a set of callers and a set of receivers, respectively.

The communication management system 1000 may include one or more of engines and/or modules that may be stored in the one or more memories and may include one or more software applications, executable with the processors, for receiving and processing requests. The one or more of engines and/or other modules may be configured to perform any of the steps of methods described in the present disclosure. The one or more of engines may include routing engine(s) 1014 that may include logic to implement and/or otherwise facilitate any communication handling features discussed herein. By way of example without limitation, the routing engine 1014 may be configured to one or more of decode, route, and/or redirect calls to/from end users and providers. The communication management system 1000 may make real-time decisions in order to improve end-user experience and provider service. Accordingly, certain embodiments may provide real-time, dynamic routing as a generalized solution.

The routing engine 1014 may include a communication handling engine 1015, in some embodiments. In some embodiments, the routing engine 1014 may be separate from the communication handling engine 1015. The communication handling engine 1015 may include one or more telephony switches in communication with one or more datastores and the network interface 1012. The communication handling engine 1015 may be configured to receive inbound calls from callers, determine caller data pertinent to the calls, perform information analysis of the caller data, gather additional caller data as needed, and match callers to providers. Accordingly, the communication handling engine 1015 may be or include a call handling engine. In some embodiments, the communication handling engine 1015 may include a message handling engine to provide message handling features disclosed herein.

In some embodiments, when a call transmission responsive to a content object is received, the call may be connected to the transceiving equipment 1012. The transceiving equipment 1012 may be connected to the router/switching equipment 1014, which selectively connects incoming connections from client devices 205 and outgoing connections to provider device 207. In some embodiments, the transceiving equipment 1012 and the router/switching equipment 1014 are circuit-switched, including Private Branch Exchange (PBX) and a dedicated voice network. In some embodiments, the transceiving equipment 1012 and the router/switching equipment 1014 may be packet-switched, including Internet Protocol (IP) based PBX, a data communication network and a gateway.

In some embodiments, the data stores 268 may include category information repository 1016, association information repository 1018, and lead profile information repository 252-2, which may retain any suitable information to facilitate certain features disclosed herein. Types of information are disclosed further herein with further description of embodiments using features directed to categories, associations of callers and/or providers with certain categories, associations of callers with providers, providers profiles, lead profiles and qualifications, and/or the like.

A reverse proxy may be used to monitor calls. Phone numbers may be tracked both on the end-user side and on the provider side. This stored information may be used to route calls from particular callers to particular providers. Phone numbers may be tracked to differentiate good, bad, proximate, and unknown leads. The database 252-2 storing lead information allows for a more complete picture regarding the leads that may be used for routing end users. Where a particular provider is not available, the end user could be routed to others. A reference number for the callee may be used to track how the end user interacts with the callee. In some embodiments, a general vanity number (e.g., 1-800-dentist) may be used, for example. In some embodiments, an icon on a webpage, mobile app, etc. may be provided for user selection to be connected to a first available provider that may satisfy the user's request. Accordingly, with certain embodiments, an end user may not see a number. With some embodiments, a user may provide his phone number, and then the communication management system 1000, functioning as a routing system, may call that number to join the call with a provider.

The communication management system 1000 may include a harvesting engine 1030 configured to harvest information about callers, caller areas, and/or providers. In some embodiments, the harvesting engine 1030 may correspond to the harvesting engine 256(b); in some embodiments, the harvesting engine 1030 may be separate and distinct from the harvesting engine 256(b). The harvesting engine 1030 may be configured to perform any one or combination of features directed to facilitating data capture regarding callers, caller areas, and/or providers disclosed herein. For example, the harvesting engine 1030 may gather and process caller data, which may be specific to a particular caller and/or may be generally related to the caller. In some embodiments, the harvesting engine 1030 may determine additional information needed based on caller data for a given caller. The harvesting engine 1030 may gather the additional information. The caller data may be gathered from one or more data stores of the system, such as a lead profile information repository 252-2, and/or one or more data sources via the data acquisition interface(s) 111, which could be third-party data sources.

Particular callers may be qualified based at least in part on the caller data gathered. The caller data may be analyzed with respect to individual callers. The communication management system 1000 may be configured to classify callers into one or more categories based at least in part on caller data.

The call management system 1006 may include a lead identification system 1032 configured to facilitate any one or combination of the lead identification features disclosed herein. For example, responsive to an incoming transmission from a client device 205 corresponding to a lead, the lead identification system 1032 may determine lead information. As indicated further herein with reference to FIG. 10, the lead information may include call information 1104, internal information 1108, area information 1112, specific information 1114, and/or the like. The lead information may be determined from one or more internal data repositories 268 and/or one or more data sources via interfaces 111. In some embodiments, the lead identification system 1032 may include one or more session module controllers that may identify a caller and a callee (e.g., based on the ring-to number), and may initiate SIP processes so then a free switch may determine to which number to route the call.

The communication management system 1000 may include a matching engine 1034 configured to perform any one or combination of features directed to matching or otherwise correlating information about callers, caller areas, and/or providers disclosed herein. For example, in some embodiments, the matching engine 1034 may receive caller information, identify attributes of the caller based at least in part on lead profile information, and match the caller to one or more categories from a category information repository 1016. As another example, in some embodiments, the matching engine 1034 could match a caller to one or more providers based at least in part on correlating categories from the category information repository 1016.

The communication management system 1000 may include a classification engine 1036 configured to perform any one or combination of features directed to classifying or otherwise categorizing callers, caller areas, providers, and/or provider service areas disclosed herein. In some embodiments, the matching engine 1034 may include the classification engine 1036; in other embodiments, the two engines may be separate but work in conjunction with one another.

The communication handling engine 1015 and/or the lead management system 1008 may include a monitoring and tracking system 1038 configured to monitor any suitable aspects pertaining to callers and/or providers. For example, the monitoring system 1038 may monitor calls routed to particular providers in order to assess the success of routing the lead. In some embodiments, the monitoring system 1038 may be configured to identify whether a caller is successfully connected with a provider, whether the call is missed, whether the call is dropped/disconnected/receives a busy tone, whether the call is routed to voicemail, and/or whether a voicemail is left. In some embodiments, the monitoring system 1038 may include Automatic Number Identification (ANI) logic and Caller Name Service (CNS) to identify callers.

In some embodiments, the monitoring system 1038 may be configured to track the length of calls or other calls aspects. In some embodiments, the monitoring system 1038 may be configured to record and/or transcribe calls. In some embodiments, the monitoring system 1038 may be configured to identify and capture keywords from calls. The monitoring system 1038 may be configured to facilitate other tracking features disclosed herein, such as keeping track of confirmed leads, potential leads, confirmed spammers, and conditionally confirmed spammers. The database 252 may include and/or serve as a filtering database to store information on indicia of spam callers, such as originating numbers of spam callers. The monitoring system 1038 may build the dataset of the filtering database 252 based at least in part on who is actually calling one or more providers. The monitoring system 1038 could monitor which numbers fail to overcome the filter processes to start filtering the spam calls automatically for multiple providers serviced by the platform. In some embodiments, the monitoring system 1038 could monitor which numbers successfully overcome the filter processes to build the data set of the filtering database 252 with information on confirmed leads/non-spammers.

In some embodiments, the filtering database 252 may include known numbers and/or codes of confirmed leads. For example, online leads may be tracked with unique codes, communication references, extensions, etc. that are given to the phone system. End users that use a client application of the platform (say, a mobile app) may be identified by phone number and/or other identification reference.

In some embodiments, the monitoring system 1038 may build the filtering database 252 with information about known spammers from data sources via the data acquisition interface(s) 111 (e.g., a website sourcing a list of telemarketer numbers). Many spammers make calls that show up as coming from certain numbers, and oftentimes the numbers are not valid. In some embodiments, the tracking system 1038 may build the filtering database 252 with information about invalid numbers as some spammers spoof numbers with invalid numbers (e.g., invalid area codes, incomplete numbers, unavailable numbers such as 1011, etc.) to allow for number validation. Accordingly, certain embodiments may provide for filtering based on detection of invalid numbers as an indication of spoofing.

The management system 1000 may operate as a lead routing system configured to facilitate any one or combination of the lead routing features disclosed herein. The lead management system 1008 may be configured to facilitate lead management features exposed to providers disclosed herein. A lead qualification system 1040, which could include the matching engine 1034 and/or classification engine 1036 in some embodiments, may qualify the lead. For example, the lead qualification system 1040 may score the lead based at least in part on categories 1016. The lead qualification system 1040 may include logic to implement and/or otherwise facilitate any lead qualification features discussed herein. By way of example without limitation, the lead qualification system 1040 may be configured to one or more of qualify a lead according to a graduated lead scale, categorize a lead according to a category scheme, score a lead according to a lead scoring scheme, and/or the like. Various aspects of lead qualification according to various embodiments are discussed further herein. In certain embodiments, the lead qualification system 1040 may be configured to compile keyword criteria, for example, in an ontology. The lead qualification system 1040 could include an ontology reasoner or semantic reasoning module to make logical inferences from a set of facts in the ontology. Accordingly, the lead qualification system 1040 may correspond to a reasoning engine configured to effect one or more lead qualification features. A pattern-based reasoner could be employed to use various statistical techniques in analyzing call/lead data in order to make inferences based on the analysis. A transitive reasoner could be employed to infer relationships from a set of relationships related to call/lead data.

The management system 1008 may include a lead nurturing system 1042 configured to facilitate any one or combination of the post-routing lead handling features disclosed herein. For example, the lead management system 1008 may route information between a provider mobile app and the backend system for tracking of lead nurturing. In various embodiments, the lead management system 1008 may allow the system to be exposed through a provider mobile app, an online provider portal, and/or through alternate messaging means such as email. In some embodiments, the lead nurturing system 1042 may generate a nurturing scheme based at least in part on the scoring and/or category information and may transmit notifications to provider devices 207 regarding the scheme and acquire input from the providers regarding the scheme options. The lead management system 1008 may manage the nurturing communication with the lead with content objects being transmitted via email, calls, push notifications, etc. to the lead device(s) 205 and/or the like.

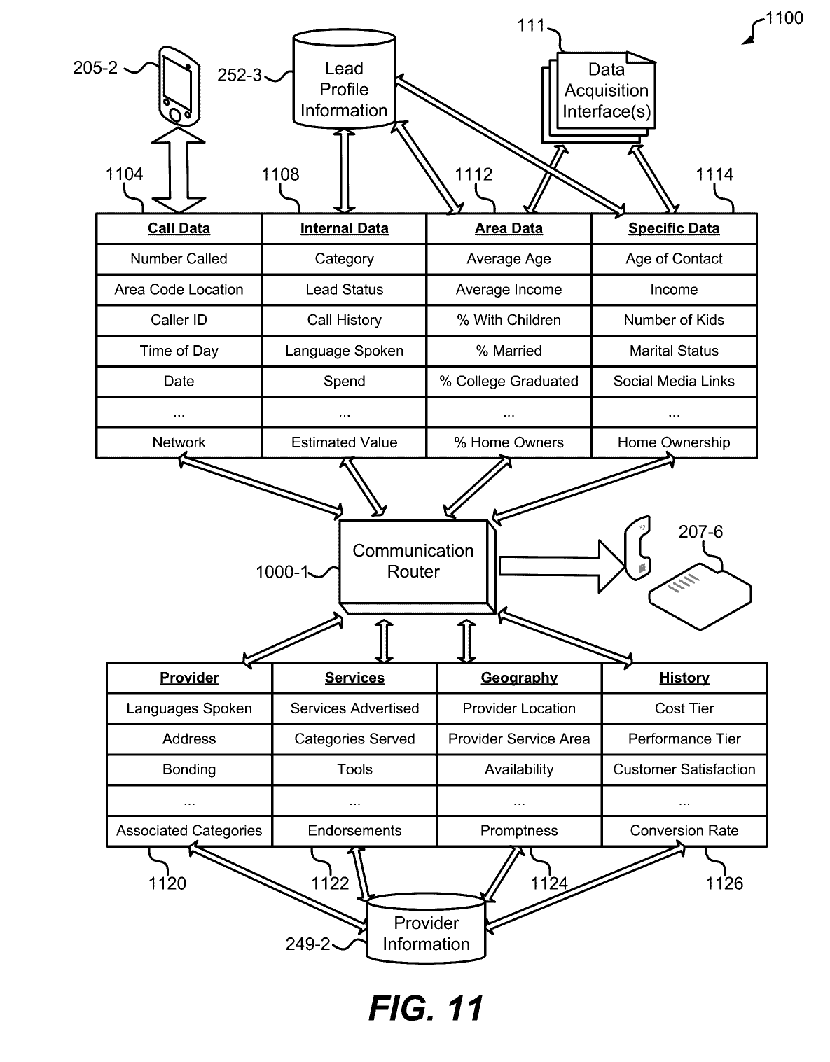

FIG. 11 illustrates certain aspects of routing data flow 1100, in accordance with certain embodiments of the present disclosure. The communication management system 900 operating as a router 900-1 may be configured to gather caller data, which may be specific to a particular caller and/or may be generally related to the caller (e.g., information about the caller's location). The caller data may be gathered from one or more data repositories of the system, such as an end-user profile information repository 252, and/or one or more data sources via data acquisition interface(s) 111, which could be third-party data sources. Any suitable categories may be employed for characterization of callers.

The caller data may include call data 1104, such as information about any one or combination of the number called, area code, caller ID, time of day, data, network, and/or the like. The communication router 1000-1 may identify characteristics corresponding to calls based at least in part on a set of call data 1104. The communication router 1000-1 may determine additional information based at least in part on the call data 1104. The additional set of information may include additional characteristics corresponding to the calls. In some embodiments, the additional information may include additional information, such as call data 1104 and/or another type of data such as data 1108, 1112, 1114, and/or the like.

The caller data may include internal information 1108, such as information about any one or combination of characterizations, qualifications, attributes, etc. determined by the management system 900. By way of example, such information may concern any one or combination of categories, lead status, call history, language, spend, value, and/or the like associated with the caller. Though the example depicts certain other types of information as separate from the internal information 1108, the internal information 1108 may include other types of information.

The caller data may include caller-specific data 1114, such as demographic data. The caller data gathering may further include capturing other end-user-specific data. Any suitable end-user specific information could be harvested in order to allow for characterization of a particular caller. Using the phone number, the area from where call originates, population density, average income, age information for the area, history of calls from area to particular categories in particular time periods, and/or the like, the communication router 1000-1 may determine people in the area are facing a particular problem, have a particular need, preference, interest, and/or inclination. Thus, the caller data may include area data 1112 pertinent to the location identified for the caller.

The communication router 900-1 may identify a need of a caller and then match the caller to a provider. In various embodiments, any one or combination of various types of provider information may be used to match a caller with a provider. The provider information may include provider information 1120. The provider information may include services information 1122. The provider information may include geographical information 1124. The provider information may include history information 1126. Accordingly, data may be captured on the provider side to provide bases for routing calls.

Certain embodiments may provide for identifying the status of a lead after the lead has been routed to a provider. Certain embodiments may add end-user relation management features post lead routing. After the caller goes with a service provider, the lead status may be updated accordingly (to “kill the lead” or graduate it to needing more follow-up or nurturing). Where there has not been follow-up, others may be notified or reminders may be set. If several providers were contacted with the lead, once one provider captures the lead, any others working on the lead would be notified.

Thus, certain embodiments may provide for efficient methods of tracking and nurturing prospective and existing end users on behalf of a provider. Certain embodiments provide strong tools to track end users for provider that interface via phone calls. The system may provide visibility on how a lead is propagating through multiple provider queues. With leads being routed to multiple providers according to some embodiments, there is a need to have an ability to determine when a lead has been converted so that the lead may be taken out of the equation, i.e., so that lead may be taken out of the queue for other providers. Certain embodiments provide valuable aid to providers by identifying their leads, helping the providers know who their leads are, track the leads, and convert the leads.

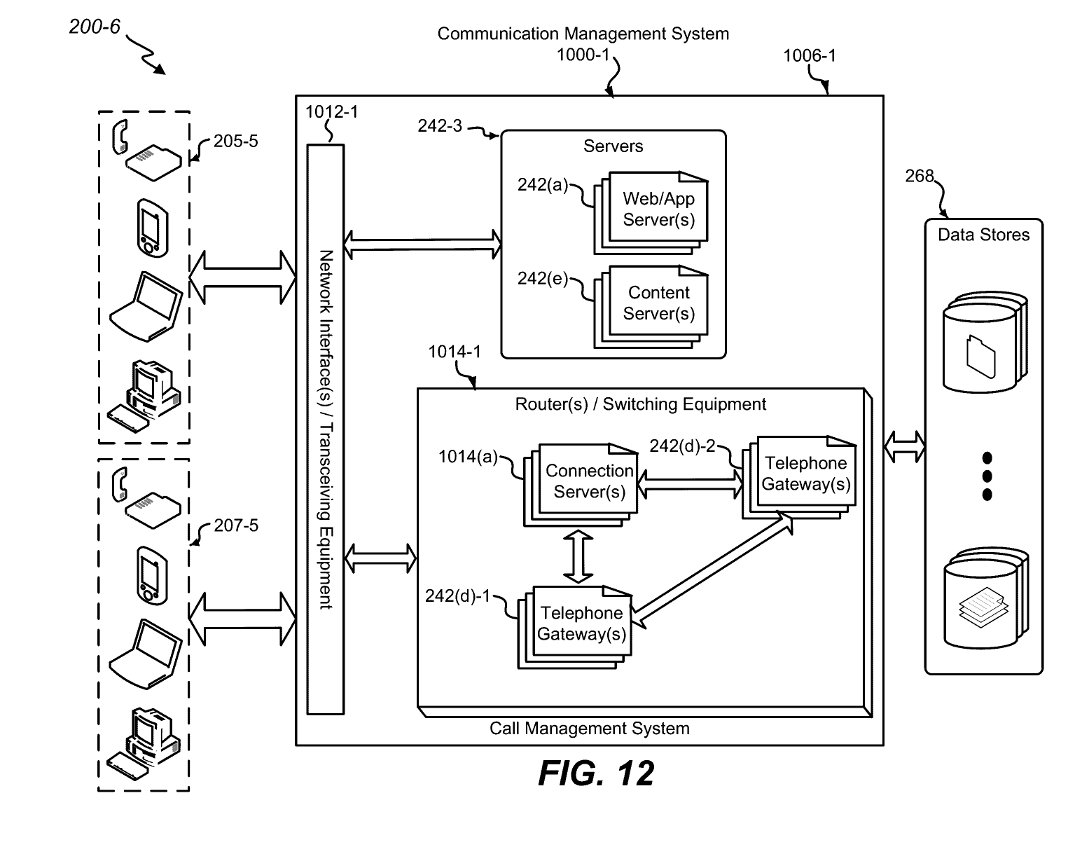

FIG. 12 shows a diagram of aspects of the communication management system 900-1, in accordance with certain embodiments of the present disclosure. In some embodiments, a client device 205 may receive content objects, particularized to certain providers and generated by the application services system 241 based on provider information from the data store 268, via a web and/or application server 242(a) of the application services system 241. In various embodiments, the client device 205 may query the web/app server 242(a) directly or indirectly. In some embodiments, the web server 242(a) or a content server 242(e) may selectively serve content objects obtained from different sources/databases. In some embodiments, one or more of the servers 242 may be included in the communication management system 900, as illustrated in the example depicted. In some embodiments, one or more of the servers 242 may be included in other portions of the infrastructure 102.

In some embodiments, the router(s) and/or switching equipment 1014 may include one or more connection servers 1014(a). In some embodiments, the connection server(s) 1014(a) may be configured to implement one or more engines and/or otherwise facilitate one or more features of the router router(s)/switching equipment 1014.

In some embodiments, when the client device 205 requests the connection server 1014(a) to provide a connection to the provider device 207 via the reference of the connection server 1014(a), the connection server 1014(a) determines whether the client device 205 is within the service area of the provider device 207 before connecting the client device 205 to the provider device 207. In some embodiments, if the location of the client device 205 is outside the service area of the provider, the connection server 1014(a) provides alternative providers who provide services similar to those of the provider and whose service areas cover the location of the client device 205.

In some embodiments, the content objects served by the web/app server 242(a) contain telephonic references, which may be used by the client device 205 to call the connection server 1014(a). The connection server 1014(a) identifies the telephone contact information of the corresponding providers based on the telephonic references called by the client device 205 and then further connects the call to the provider(s).

In some embodiments, the client device 205 may be softphone-implemented at least in part via software, such as an instant messenger, a VoIP client application running on a computer, an applet embedded in a web page, a handheld device, a cellular phone, a cordless phone, a Bluetooth phone, a WiFi phone, etc. In some embodiments, the client device 205 may be implemented via hardwire circuitry, such Application-Specific Integrated Circuit (ASIC); in some embodiments, the client device 205) may be implemented partially via special purpose hardwire circuitry and partially via software, such as Application-Specific Integrated Circuit (ASIC) or Field-Programmable Gate Array (FPGA) with software/firmware; and in some embodiments, the client device 205 may be implemented using a set of general purpose hardwire components that are under the control of software. In some embodiments, the client device 205 is a Plain Old Telephone Set (POTS).

In some embodiments, the telephonic references in the content objects that are retrieved directly or indirectly via the web/app server 242(a) are SIP URIs which contain encrypted information, such as the telephone number of the provider, an identifier of the caller, information about the query (in embodiments where the content is responsive to a query, which may be end user generated or system-generated, such as intermediary system generated), the service geographic area of the provider corresponding to the particularized content object, and/or the position of the content object in the sorted list of the search result, etc. The connection server 1014(a) decrypts the SIP URI that is used to call the connection server 1014(a) to further connect the call to the provider.

In some embodiments, the query of the client device 205 is submitted to the web/app server 242(a) with an identifier of the caller, such as a telephone number of the caller, a user identifier of a telephonic apparatus, an internet address of the telephonic apparatus, a softphone user ID, a number unique to the softphone user ID among different softphone user IDs, etc. In some embodiments, the identifier of the caller is encrypted in the SIP URI. When the client device 205 calls the connection server 1014(a) using the SIP URI, the connection server 1014(a) may determine whether the call is made from the same apparatus or caller that submitted the query. For example, the connection server 1014(a) may prevent other telephonic apparatuses or callers that did not perform the query from calling the provider device 207 using the result of the query. The connection provider may also use the identifier information of the caller to determine whether a query is generated by a machine in an automated fashion and to determine whether the query and/or the calls from the caller should be blocked. For example, after a provider complains about a call from a caller, the connection server may block the queries and/or calls from the caller (e.g., for a period of time) to that provider, a subset of providers or all providers.

In some embodiments, the client device 205 may be capable of making a VoIP call but using a protocol different from the protocol used by the gateway (e.g., SIP); and a gateway 242(d)-1 is used to interface the client device 205 and the connection server 1014(a). In some embodiments, the client device 205 may be capable of making a SIP call using the SIP URI to reach the connection server 1014(a) without the gateway 242(d)-1. In some embodiments, the client device 205 makes a call over a PSTN; and a telecommunication carrier bridges the call from the PSTN to the connection provider on a data network.

In some embodiments, the provider device 207 uses a telephone that is connected on the PSTN; and the connection server 1014(a) uses the gateway 242(d)-2 to reach provider device 207. In some embodiments, the gateway 242(d)-2 is operated by a telecommunication carrier of the connection provider. In some embodiments, the connection server 1014(a) uses the gateways (242(d)-1 and 242(d)-2) to set up the call and direct the gateways (242(d)-1 and 242(d)-2) to make a direct media connection that does not go through the connection server 1014(a) to provide the telephone connection between the client device 205 and the provider device 207. In some embodiments, the provider device 207 uses a telephone that is connected on a data network; and the gateway 242(d)-2 is used to bridge the protocol used by the telephone of the provider device 207 and the protocol used by the connection server 1014(a). In some embodiments, the telephone of the provider device 207 and the connection server 1014(a) may use the same protocol; and the connection server 1014(a) may call the telephone of the provider device 207 directly (e.g., via SIP) without a gateway 242(d)-2.

In some embodiments, the client device 205(a) obtains content objects particularized to providers directly or indirectly via a web server 242(a) of the connection provider. Content obtained from other sources may also be selectively presented with the content objects obtained from the data store 268 in response to a search request from the caller, in some embodiments.

In some embodiments, the connection server 1014(a) encrypts information related to the search, the provider's telephonic contact information, the caller's identification information, the ID of the server 242, etc. in the SIP URI which may be called by the client device 205 to reach the connection server 1014(a). Alternatively, other types of telephonic references may be used, such as telephone numbers with extensions, VoIP user identifiers, etc. In some embodiments, the telephonic reference may be a link to the web server 242(a), which may be visited to cause the connection server 1014(a) to callback the client device 205 at the client device 205.

The information may be encrypted/encoded in the telephonic references provided in the content objects. In some embodiments, the telephonic references may be used in a database to look up the associated information such as the provider's telephonic contact information, the keywords used in the search, caller's identification information, the ID of the distributor of the client device 205(a) or a ID of a partner whose web server caused the user terminal to visit the web server 242(a) for the search, promotions/electronic coupons provided with the content object, etc.

In some embodiments, the SIP URI provided in the content object via the web server 242(a) may be used to call the connection server 1014(a) for a telephone connection to the provider device 207. The SIP URI contains information in an encrypted string (e.g., sip:<Encrypted String>@sip.yp.com), such as information about the provider, information about the user who performed the query, information about the intermediary system that distributes the hardware and/or the software of the telephone apparatus and/or who distributes the content objects to the client device 205, and information about the query, such as a search term used in the query, the timestamp of the search, the order number of the content object in the result set, an identification of the content object, promotions/electronic coupons provided with the content object, etc. The telephone apparatus 205(b) is connected to the connection server 1014(a) at the SIP “end point,” before being further connected by the connection server 1014(a) to the provider device 207.

In some embodiments, the client device 205(a) is configured to have the capability to store or bookmark the SIP URI provided in the content object. For example, the SIP URI may be stored in association with the content object or provider in a contact book maintained on the client device 205(a). In some embodiments, a gateway 242(d) is used to bridge the call from the telephone apparatus 205(b) that is in one VoIP domain (e.g., based on a proprietary protocol for VoIP) and the connection server 1014(a) that is in another VoIP domain (e.g., based on an open standard VoIP protocol).

In some embodiments, the SIP URI is provided as a communication reference which may be used directly by the telephone apparatus 205(b) to call the gateway 242(d) which further connects the call to the connection server 1014(a). For example, when the telephone apparatus is configured generally to initiate calls to traditional telephone numbers or VoIP user IDs (e.g., via a proprietary protocol), the telephone apparatus may be configured to treat the SIP URI as a VoIP user ID associated with the gateway. In some embodiments, a portion of the SIP URI (e.g., the encrypted string) may be used as VoIP user ID to reach the gateway.

In some embodiments, the web server 242(a) provides the particularized content object with a traditional telephone number instead of the SIP URI. The traditional telephone number may or may not include an extension. The telephone apparatus 205(b) uses the gateway 242(d) to access PSTN and reach the connection server 1014(a) via a telecommunication carrier which bridges the call from the PSTN to the connection server 1014(a). The telecommunication carrier may provide the call to the connection server 1014(a) via a SIP call. In some embodiments, the extension is to be dialed by the telephonic apparatus after the telephonic connection between the client device 205 and the connection server 1014(a) is established. In another embodiment, the extension is to be dialed by the gateway 242(d). In a further embodiment, the gateway 242(d) places a SIP call to the connection server 1014(a), bypassing the telecommunication carrier of the connection provider; and the extension is used to construct the SIP URI of the call (or be included in the SIP INVITE message sent from the gateway 242(d)).

In some embodiments, the gateway 242(d) used to bridge the call to the PSTN may prevent the connection server 1014(a) from identifying the caller via ANI service. To provide information to identify the caller, the gateway 242(d) may be further configured to provide the information about the caller to the connection server 1014(a) via call ID information or via extension. In some embodiments, the gateway 242(d) may bypass the telecommunication carrier and connect the call to the connection provider via a SIP call and provide the information about the caller in the FROM header of the SIP INVITE message.

In some embodiments, when a gateway 242(d) is used to bridge one protocol used by the telephone apparatus (e.g., a proprietary protocol) and another protocol used by the connection server (e.g., SIP), the telephone network is configured to route the call to the gateway that is nearest to the connection server to reduce the distance over the Internet between the gateway and the connection server. The client device 205 may use other gateways to reach other callees.

In some embodiments, the client device 205(a) is configured to identify a geographic area to the connection server 1014(a) when submitting a query; and the connection provider may return particularized content objects/listings based on the geographic area and/or selectively block the calls from end users who are outside the service area of the providers. In some embodiments, the client device 205 is configured to identify a geographic area to the connection server 1014(a) when initiating a call to the connection server 1014(a); and the connection server 1014(a) may selectively block the calls from end users who are outside the service area of the providers or provide opportunities to connect to alternative providers (e.g., through prompts provided and input received via a human operator or an Interactive Voice Response (IVR) system).

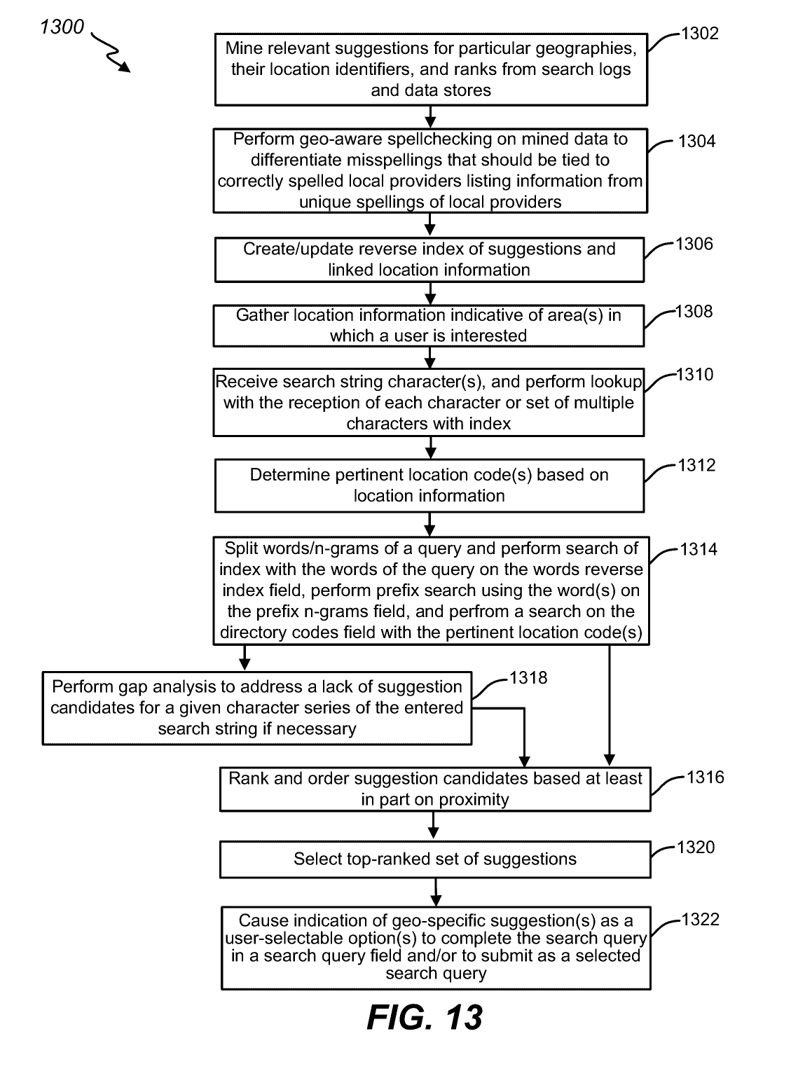

FIG. 13 illustrates an example method 1300 of providing for geo-aware auto-suggestion, in accordance with certain embodiments of the present disclosure. Certain embodiments according to the present disclosure provide for technical improvements in autosuggestion search engine services that redound in certain advantages in efficiency, accuracy, and speed that can be passed on to the user in facilitating optimized user experiences. Certain embodiments may eliminate excessive delay in processing candidate data, analyzing candidate data, selecting candidate suggestion data sets in a geo-aware manner, and transferring candidate suggestion data sets to facilitate presentation of candidate suggestions. Certain embodiments result in increased efficiency of processing, analyzing, selecting, and transferring candidate suggestion data sets. Likewise, certain embodiments resulted in increased accuracy of selected and transferred candidate suggestion data sets. Certain embodiments according to the present disclosure may optimize user experience by improving accuracy of search result matching, by improving personalization of search results, and by improving efficiency of processing operations whilst optimizing balancing of dynamic constraints and fuzzy matching operational variables.

The technical improvements of embodiments according the present disclosure result in optimized user experiences. For example, a couple hundred millisecond time window could negatively impact user experience. Accordingly, certain embodiments may eliminate delay and may process candidate data, analyze candidate data, select candidate suggestion data sets, and transfer candidate suggestion data sets to facilitate presentation of candidate suggestions within time windows less than a couple hundred milliseconds (ms). In various embodiments, the time windows may be approximately 100 ms, 50 ms, and/or less. With some embodiments, an average time window may be approximately 50 ms; in other embodiments, the average time window may be different.

According to certain embodiments, the information handling engines 243 may be configured to implement any one or combination of the autosuggestion features disclosed herein. The information handling engines 243 may include one or more of a location engine(s) 244, a search engine(s) 246, a geo-aware spellchecking engine(s) 246A, a geo-aware autosuggestion engine(s) 246B, an area selector(s) 247, and/or a sort engine(s) 248 to process the search request and present search results based on the information stored in one or more data repositories 268.

Teachings of the present disclosure may be implemented in a variety of configurations that may correspond to systems described herein. As such, the order of the steps comprising the method 1300 and/or the other methods disclosed herein may be shuffled in any suitable manner and may depend on the implementation chosen. Moreover, while the steps of the method 1300 and/or the other methods disclosed herein may be separated for the sake of description, it should be understood that certain steps may be performed simultaneously or substantially simultaneously. According to some embodiments, the method 1300 may begin as indicated by 1302.

As indicated by block 1302, relevant suggestions for particular geographies may be mined from search logs and providers database(s). The search logs may include past click, selection, and/or search information indicative of user interest in providers in the information repositories. The number of clicks, selections, and/or searches over time may be assessed for particular geographical areas and for particular providers. Any suitable basis or bases may be used for mining and selecting geo-aware suggestions in various embodiments. For example, suggestions may be mined from one or more of listings repositories corresponding to subscriber database(s), past click information, frequency of particular queries in a particular locality, trends of particular queries in a particular locality, search logs, popularity of search results corresponding to particular queries in a particular locality, reviews of particular providers, agreements to boost visibility of listings corresponding to particular queries, and/or the like. Any one or combination of such information may be bases for ranking the local providers according to user interest.

Various times periods may be used in various embodiments. For example without limitation, the time period for consideration could be the past year, the past 6 months, the past month, the past week, etc. To facilitate data mining, the infrastructure 102 may include one or more user interest data logging and analytics modules configured to perform logging processes to receive and log user interest data. The one or more logging and analytics modules may include logic to retrieve, process, derive, compile, aggregate, handle, store, report, and/or present information relating to user interest data.

The mining for suggestions may include mining for provider categories (e.g., Japanese restaurants), for provider names, for keywords associated with particular categories, and for geographical information associated with categories, names, and/or keywords. The mining for suggestions may include assessing previously provided suggestions. For example, how many clicks for query x and corresponding suggestion y may be assessed. The mining for suggestions may include assessing entities added to personalized collections and recommendation information such as that disclosed herein with respect to information orchestration engines 256. The mining for suggestions may include assessing categories and classification information, associations information, end-user profiling information, provider information, and/or the like such as that disclosed herein.

As indicated by block 1304, in some embodiments, geo-aware spellchecking may be performed on mined data to differentiate misspellings that should be tied to correctly spelled local provider listing information from unique spellings of local providers. For example, in some locations, “plummer” should be corrected to “plumber,” and, in some locations, “plummer” should be recognized as a correctly spelled provider name, part of a provider name, or other reference to a provider in the local area.

As indicated by block 1306, a reverse index of suggestions and linked location information may be created or updated. The linked suggestions and location information may be provided by way of the one or more indexes 253, which may include inverted/reverse index(es) in some embodiments. By way of example, an index 253 could include fields for one or more of: prefix n-grams of each word in a given suggestion; prefix n-grams of an entire suggestion; each word of a given suggestion; a location identifier(s) for each suggestion (such as a geo code(s), a directory code(s) relevant to the provider listing of the suggestion, etc.); geo coordinates corresponding to each suggestion (e.g., latitude and longitude); and/or the like.

In some embodiments, one or more of the data repositories 268 and/or indexes 253 may be updated periodically. Updating may occur at any suitable time. Updating may capture one or more of listing name changes, new provider openings, provider closings, query distribution changes, and/or the like. Certain embodiments may ensure or improve data integrity based on assessing frequencies for particular queries over time. Thus, the updating can be based on queries. For example, query distribution can change over time. There can be seasonal distribution changes, weekly distribution changes, and daily distribution changes. Analyzing the query distributions may identify popular changes over a particular time period, such as the last 60 or 90 days. For example, analyzing the query distributions may identify: how many queries for a particular provider in a particular area; how many providers correspond to a particular sequence of characters, particular word, and/or particular sequence of words in a particular area; and/or the like. In some embodiments, the frequency distribution can help identify and rectify spelling mistakes. Frequency distribution analysis may identify anomalies that correspond to spelling mistakes.

As indicated by block 1308, the geo-aware autosuggester 246 could gather location information indicative of area(s) in which a user is interested, which is discussed further herein. As indicated by block 1310, the geo-aware autosuggester 246 could receive a series of search string characters, and perform a lookup with the reception of each character or set of multiple characters with the index(es) 253. As indicated by block 1312, pertinent location code(s) may be determined based on the location information. Thus, with location information indicative of area(s) of interest, the geo-aware autosuggester 246 may determine pertinent location code(s) (e.g., directory codes) based on proximity of the query's geography and perform the lookup with a prefix of a search term currently entered (i.e., any characters currently entered for the keyword(s)).

As indicated by block 1314, the geo-aware autosuggester 246 may be configured to split words/n-grams of a query and perform a search of the index 253 with the words of the query on the words reverse index field, perform a prefix search using the word(s) on the prefix n-grams field (e.g., the last partial word entered), and do a search on the directory codes field with the pertinent location code(s). This could yield all the relevant suggestions for that query in the geography. As indicated by block 1316, suggestion candidates per the results could be ranked and ordered based at least in part on proximity. The prefix n-grams of the whole suggestion field and distance calculated from the user's geography (e.g., coordinates) to the suggestion geography could be used to rank the results. The suggestion candidates could be ordered according to rankings.

As indicated by block 1318, in some embodiments, gap analysis may be performed to address a lack of suggestion candidates for a given character series of the entered search string. In certain embodiments, if no local result or too few local results are found for the partially entered query, the search area and/or corresponding listing information may be iteratively modified dependent upon the results. For example, an initial search for an initial search area may yield too few or no results; and the search area may be iteratively expanded to increase the results. When sufficient results are determined, whether by an initial search or an iterative search, distance calculated from the user's geography (e.g., coordinates) to the suggestion geography could be used to rank the results.

In certain embodiments, in addition or in alternative, if no local result or too few local results are found for the partially entered query, fuzzy search methods discussed herein may be employed to loosen the strictness of the searching. Fuzzy searching could, for example, be used after iteratively expanding the search area to a certain threshold (say, for example, an entire metro area corresponding to the area of interest indicated by the location information). The search string could be compared to index entries to assess similarity and to allow for approximate matching.

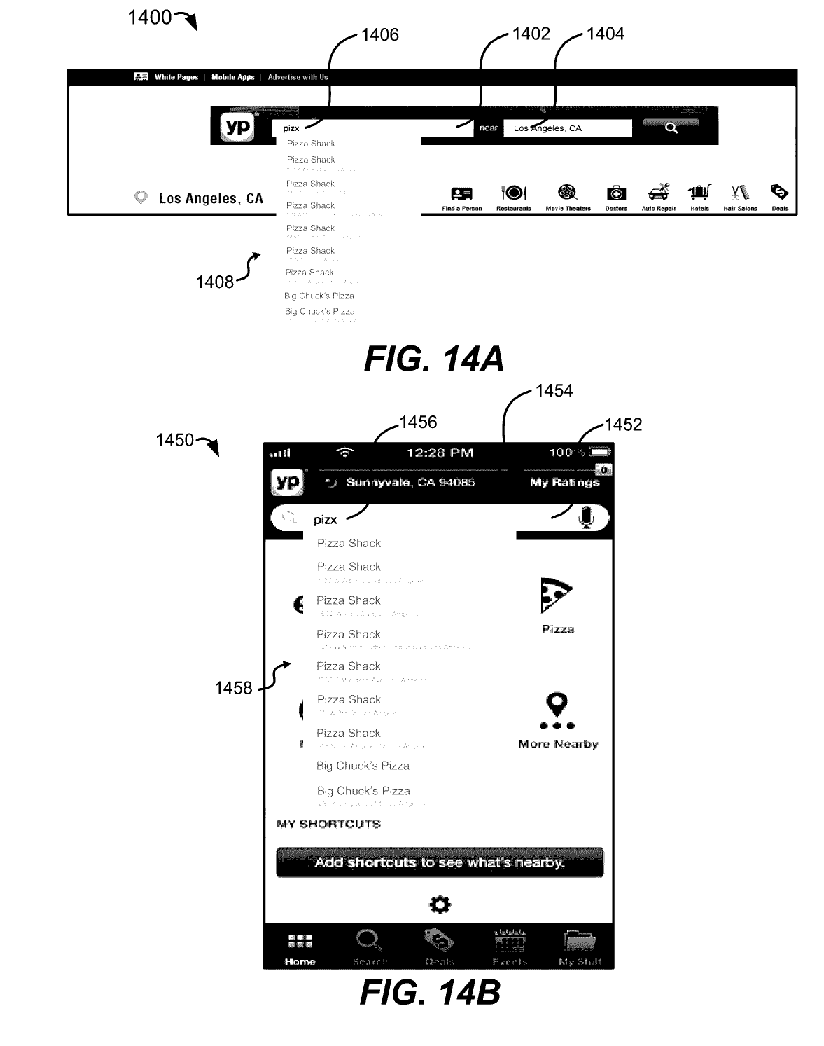

As indicated by block 1320, a top-ranked set of suggestions may be selected. Those results corresponding to distances that are too far (e.g., results corresponding to distances beyond predetermined distance threshold(s), results that are relatively low-ranked, results that are not ranked in the top X number of results, and/or the like) may be pruned away to yield the final suggestion list. As indicated by block 1322, indication of geo-specific suggestion(s) as a user-selectable option(s) to complete the search query in a search query field and/or to submit as a selected search query may be cause. Suggestion information may be sent to the end-user computing device and user-selectable options may be presented by way of the application. By way of example without limitation, geo-specific suggestions may be presented as user-selectable options as illustrated by FIGS. 14A and 14B.

FIG. 14A illustrates a graphical user interface 1400 that may be used in implementations of certain embodiments of the present disclosure. FIG. 14A shows a screenshot, which may be a partial screenshot, of a search interface 1400 that may be displayed via a web page. The search interface 1400 can be displayed at a client device 205. The search interface 1400 includes a query field 1402 for input of a query by a user, for example, via text entry. In some embodiments, the search interface 1400 may also include a location field 1404 for input of a query by a user, for example, via text entry. In some embodiments, a location may be automatically entered by the system into the location field 1404 based on any suitable location identification method, such as one or more of the location identification methods disclosed herein. The fields 1402, 1404 may include portions of a web page that allows the user to enter textual information via a keyboard or other input device. The query field 1402 may receive entry of keyword information for a search. The location field 1404 may receive entry of location information to indicate a location of interest related to the keyword information for the search. Based in part on search string 1406, geo-specific suggestions 1408 may be presented as user-selectable options.

FIG. 14B illustrates another graphical user interface 1450 that may be used in implementations of certain embodiments of the present disclosure. FIG. 14B shows a screenshot of a mobile application search interface 1450 that may be shown on a client device 205 that is a mobile computing device. The search interface 1450 includes a query field 1452 for input of a query by a user, for example, via text entry. In some embodiments, the search interface 1400 may also include a location field 1454 for input of a query by a user, for example, via text entry. In some embodiments, a location may be automatically indicated by the location field 1454 based on any suitable location identification method, such as one or more of the location identification methods disclosed herein. The location field 1454 may allow for a user to change the automatically indicated location to a different location. The fields 1452, 1454 may include portions of an application interface that allows the user to enter textual information via a keyboard or other input device. The query field 1402 may receive entry of keyword information for a search. The location field 1404 may receive entry of location information to indicate a location of interest related to the keyword information for the search. Based in part on search string 1456, geo-specific suggestions 1458 may be presented as user-selectable options.

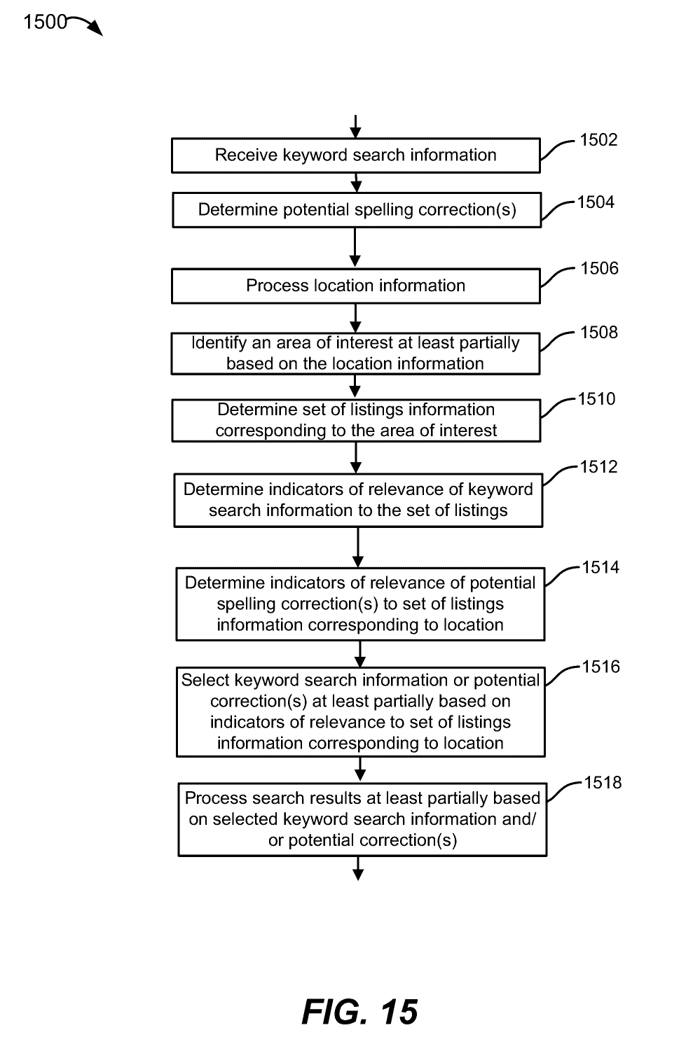

FIG. 15 illustrates an example method 1500 of providing for geo-aware spellchecking in a geographical area of interest to a user of an end-user device 205, in accordance with certain embodiments of the present disclosure. According to some embodiments, the method 1500 may begin as indicated by 1502. Though not depicted in FIG. 15, in some embodiments of the method 1500 and/or other methods disclosed herein, a mobile application 351, which is configured to run on an end-user device 205, may be provided. The mobile application 351 may be provided in any suitable way. For non-limiting example, the mobile application 351 may be made available from the infrastructure 102 or any website for download to the end-user device 205; alternatively, it may be pre-installed on the mobile computing device. The mobile application 351 may be stored in the memory 334 and/or computer-readable media 346.

As indicated by block 1502, keyword search information may be received. In some embodiments, the keyword search string may be processed character by character as the search string is typed, or by character group as the search string is typed. The search string may include any suitable number of characters and may correspond to an incomplete or a complete keyword(s). Accordingly, partial keyword search information may be processed as the user types a search string. In some embodiments, character-by-character transmission to the information handling system 106 is automatically performed prior to subsequent character input by the user and/or the user selection of the search option.

As indicated by block 1504, one or more potential spelling corrections may be determined. In some embodiments, the spellchecker 246A may receive a search string corresponding to the user input into the query field and may use the indexes 253 to identify one or more potential corrections for the search string. According to various embodiments herein, the spellchecker 246A may be configured to employ fuzzy matching operations to capture sufficient results. The fuzzy matching operations may utilize edit distance in order to identify potential corrections. Edit distance may be measure of how many operations are needed for one string and/or word to match another string and/or word. The fuzzy matching operations may utilize fuzzy matching metrics that take into account key distance of letters on a standard keyboard as a basis for determining likely meaning In some embodiments, a combination of edit distance and key distance may be utilized by the fuzzy matching operations to identify potential corrections. In some embodiments, a combination of edit distance and key distance may be utilized by the fuzzy matching operations to identify potential corrections. In addition, the fuzzy matching operations may utilize fuzzy matching metrics that take into account word association metrics. The word association metrics may score word association frequency (i.e., how often words go together) and such scores may be stored in the indexes 253. Relatively higher word association frequency scores may indicate that certain words are more frequently associated with each other (e.g., immigration attorney), whereas relatively lower word association frequency scores may indicate that certain words are less frequently associated with each other (e.g., immigration car). Scoring and classification of word associations may be performed in conjunction with the suggestion mining and ranking features disclosed herein.

In some embodiments, the spellchecker 246A may decompose the search string at the word level and search the indexes 253 for one or more sets with one or more words in common with the search string. With some embodiments, the spellchecker 246A may decompose the search string into n-grams of any suitable length and search the indexes 253 for one or more sets with one or more n-grams in common with the search string. In some embodiments, the search string may be analyzed at least in part by identifying one or more corresponding prefixes. For example, a prefix of the search string may be identified for comparison, and one or more corresponding prefixes in the listing prefixes repository 249′ may be identified based on the prefix of the search string as discussed herein. With various embodiments, the spellchecker 246A may utilize fuzzy matching to find not only words/n-grams/prefixes in common with the search string per exact matching, but also words/n-grams/prefixes similar to the search string per fuzzy matching.

As indicated by block 1506, location information may be processed. The information may be processed at, by, and/or with the end-user device 205 and/or the system 102. In some embodiments, the location engine 244 may process information about a first location. The information may be automatically gathered and may correspond to the location of the end-user device 205. In some embodiments, the end-user device 205 automatically determines its current position (e.g., via a satellite positioning system, or a cellular positioning system) and transmits the determined or estimated position to the location engine 244. The end-user device 205 could provide the position in response to a request from the location engine 244. The processing of location information could be performed prior to and/or during the entry of keyword search information in some embodiments.

For example, in the case of a cellular number, the user device may be a wireless mobile device, and the location of the wireless mobile device can be determined using a number of ways. For example, the end-user device 205 may include one or more GPS receivers 338, one or more accelerometers, one or more magnetometers, and/or one or more gyroscopes that enable determination of its position based on data provided by these components and/or signals received by these components, such as received satellite signals. In certain embodiments, triangulation methods (e.g., triangulation based on cellular towers, Wi-Fi-based location, carrier-provided location, or any suitable cloud-based location method, service, source, and/or technique) may be employed to identify the location of the computing device. In the case of GPS, the GPS receiver 338 may facilitate the identification of GPS coordinates.

In some embodiments, the cellular site in which the mobile device can communicate to a based station can be used to determine a rough position of the cellular phone. In general, any method used by a cellular phone provider to get location information (e.g., for emergency service) can be used. An access point for a wireless local area network or a wireless personal area network typically has a small coverage area. Based on the location of the access point, location information (e.g., the city, or more precise location information) can be obtained. Location information may be obtained from a cellular location server, in some embodiments. The location may be based at least in part on and/or determined at the mobile station or determined at a server station. In some embodiments, a third party data source, such as a cellular provider, may provide indication of a location from which the call originates.

In some embodiments, the location of the mobile device may be determined via a satellite positioning system or a pseudolite positioning system. The location of the mobile device may be determined automatically through a Global Positioning System (GPS) receiver that is connected to, or built within, the mobile device. Pseudolites are ground-based transmitters of signals similar to a GPS. Pseudolites are useful in situations where signals from an orbiting satellite might be unavailable, such as tunnels, mines, buildings or other enclosed areas. A satellite/pseudolite signal receiver may determine its location and transmit the location through the cellular phone to a cellular communication system, or transmit the received signals to a location server which computes the location. In some embodiments, an IP address of computing device, for example, a mobile computing device, such as a tablet, may be a basis for location information. In the case that the user device is accessing the Internet through an internet service provider, location information for the user device can be obtained automatically from the internet service provider.

In addition or in the alternative to automatically-gathered location information, a user may enter location information with the end-user device 205, e.g., with the location field. The user may identify any location of interest by entering location information into the mobile computing device. The user may enter an address, a partial address, a city, a zip code, a location keyword, or any suitable location-indicating information. As noted previously, the user may enter location information corresponding to a place of work, the user's home, or other locations of interest.

In some embodiments, location information can be obtained from user preference data. In some embodiments, when the user searches for information without explicitly specifying a geographic area, the geographic area of interest can be determined based on typical geographic radius of interest on the topic and the location of the user. Thus, the location information can be inferred from the search information.

As indicated by block 1508, an area of interest may be identified at least partially based on the location information. In some embodiments, the area of interest can be determined prior to and/or during the entry of keyword search information. In some embodiments, the area of interest can be determined based on a geographic radius of interest. The area of interest can correspond to, for example, a zip code, a collection of zip codes, and/or one or more service areas. As discussed further herein, some embodiments may take into account the specific needs of the user (e.g., if the user is traveling) and/or specific aspects of the area (e.g., travel routes, high-crime areas, etc.) when tailoring the form of an area of interest. As indicated by block 1510, a set of listings information corresponding to the area of interest may be determined. As discussed herein, the set of listings information could be determined at least in part by searching location identifiers, such as directory codes, in the index 253.

As indicated by block 1512, one or more indications of relevance of the keyword search information may be determined. The indications may bear on how relevant the keyword search information is to the set of listings information. As indicated by block 1514, one or more indications of relevance of the potential spelling correction(s) may be determined. The indications may bear on how relevant the potential spelling correction(s) are to the set of listings information. For example, the spellchecker 246A may look up the keyword search string and the one or more potential corrections in the index(es) 253. The spellchecker 246A may compare the search string and the one or more potential corrections to the set of listings information. If the search string is identified as a possibility for the particular location, then that may be an indication that the search string should not be corrected. If, however, the search string is not identified as a possibility for the particular location, then that may be an indication that the search string should be corrected.

As indicated by block 1516, the original keyword search string and/or the potential correction(s) may be selected at least partially based on indicators of relevance to set of listings information corresponding to location. In some embodiments, a decision tree may be employed to check the search string first, then the most likely applicable potential correction, then the next most likely applicable potential correction, and so on until a positive indication is found in the index(es) 253. In some embodiments, the first positive indication, whether it be the search string or a potential correction, found is used.

In some embodiments, the significance of the keyword search string and the one or more potential corrections to the set of listings information may be determined and assigned weights accordingly. In some embodiments, a TF/IDF may indicate a weight for significance measures. Thus, in some instances, even though the search string is identified as a possibility for the particular location, the significance of the search string to the set of listings may be lower than the significance of a potential correction. In such cases, the potential correction may be used in addition or in alternative to the search string in some embodiments. In some embodiments, the potential correction may be used only if a differential threshold as between the two significance measures is met. Any suitable threshold may be employed.

In some embodiments, the potential correction and the search string may be used in instances where the differential in significance measures is within a first range or distance and/or if a first differential threshold is met. Any suitable number of thresholds may be implemented in some embodiments. The multiple thresholds may correspond to various weights. In some embodiments, only the potential correction may be used in instances where a second differential threshold is met, indicating the significance measure of the potential correction is significantly higher than the significance of the search string.

In some embodiments, an indication of whether or not the search string should be corrected may be based on past click, selection, and/or search information. For example, past click, selection, and/or search data for the original keyword search string and potential corrections could be mined from click, selection, and/or search logs. The number of clicks, selections, and/or searches over time may be assessed for each of the keyword search string and potential corrections.

Any of various times periods may be used in various embodiments. For example without limitation, the time period for consideration could be the past year, the past 7 months, the past month, the past week, etc. Any suitable threshold may also be employed in conjunction with the past click, selection, and/or search information. For example, a minimum threshold of X number of clicks, selections, and/or search per Y time period may be imposed. Even if a potential correction is found in a set of listings for a particular location, the past data for the potential correction may be required to the meet the threshold. Any suitable number of thresholds may be implemented in some embodiments. The multiple thresholds may correspond to various weights. The weights could contribute to scoring the original keyword search string and potential corrections. The original keyword search string and the potential corrections could be ranked, and the one with the greatest score may be selected. In some embodiments, the original keyword search string and the potential correction(s) could be selected for searching. As indicated by block 1518, search results may be processed at least partially based on the selected keyword search information and/or the potential correction(s).

In some embodiments, keyword search information may be processed character-by-character, and any one or combination of the method steps may be performed as the search string is being input into the query field. In some embodiments, search results may be pre-loaded as the search string is being input into the query field. As each character is input into the query field, subsets of the documents may be identified, and documents may be stored in cache for faster retrieval. The documents identified for pre-loading may correspond to one or more of the original search string and/or the one or more potential corrections. In various embodiments, various method steps may be performed on the basis of any number of characters as the characters are input into the query field.

Certain embodiments may employ any suitable compression method. For example, in some embodiments, information for a particular provider, such as a provider name, may need only be stored once for a particular area. A concomitant frequency field may indicate the number of sites for that particular provider in that particular area.

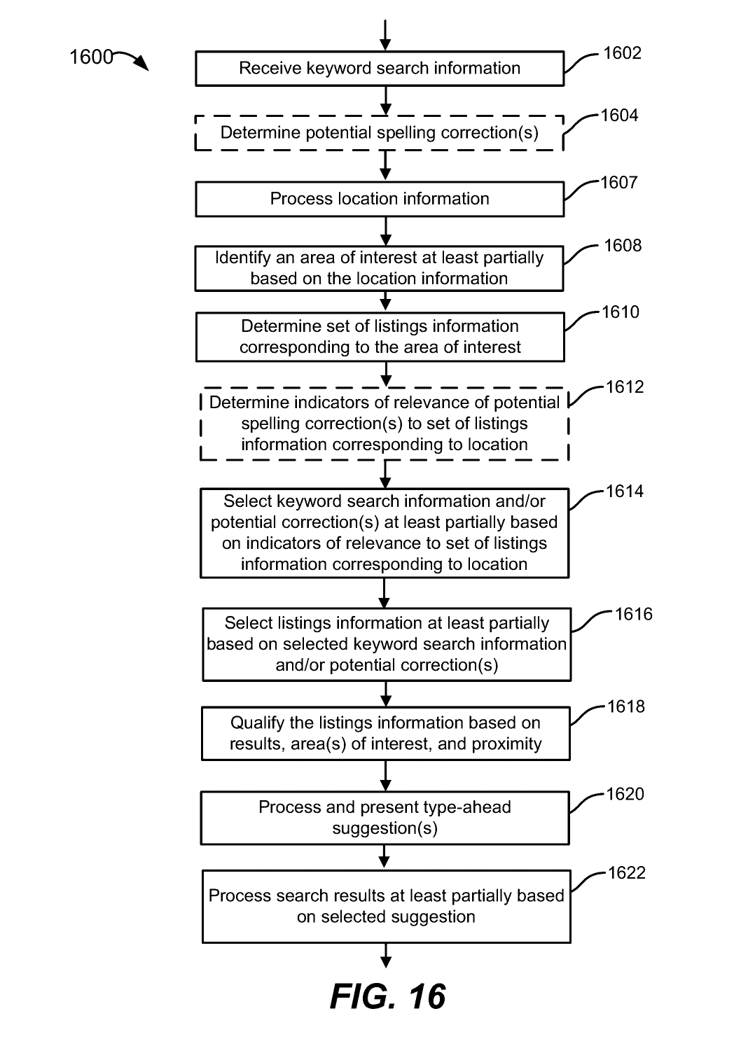

FIG. 16 illustrates an example method 1600 of providing for geo-aware search features corresponding to a geographical area of interest to a user of an end-user device 205, in accordance with certain embodiments of the present disclosure. In some embodiments, geo-aware spellchecking features may be implemented in conjunction with fuzzy autosuggestion features. According to some embodiments, the method 1600 may begin as indicated by 1602.

As indicated by block 1602, keyword search information may be received as discussed herein. And as discussed herein, in some embodiments, the keyword search string may be processed character by character as the search string is typed, or by character group as the search string is typed. Character-by-character processing may allow for type-ahead suggestions and/or suggestions that are otherwise presented to the end user prior to subsequent character input by the user and/or user selection of the search query submission option.

As indicated by block 1604, in some embodiments, one or more potential spelling corrections may be determined in one or more various ways in accordance with various embodiments discussed herein. As indicated by block 1606, location information may be processed in one or more various ways in accordance with various embodiments discussed herein. As indicated by block 1608, an area of interest may be identified at least partially based on the location information in one or more various ways in accordance with various embodiments discussed herein.

As indicated by block 1610, a set of listings information corresponding to the area of interest may be determined. The set of listings information may include location-specific suggestions. As discussed herein, a location-specific set of suggested listing information could be determined at least in part by searching location identifiers, such as directory codes, in the index 253. In some embodiments, such a lookup could generally identify suggestions relevant to the area of interest.

As indicated by block 1612, in some embodiments where geo-aware spellchecking is employed in conjunction with auto-suggestion features, one or more indications of relevance of the potential spelling correction(s) may be determined, as discussed herein. As indicated by block 1614, in some embodiments where geo-aware spellchecking is employed in conjunction with auto-suggestion features, either the original keyword search string and/or the potential correction(s) may be selected at least partially based on indicators of relevance to set of listings information corresponding to location. In some embodiments, a decision tree may be employed to check the search string first, then the most likely applicable potential correction, then the next most likely applicable potential correction, and so on until a positive indication is found in the index(es) 253.

As indicated by block 1616, listings information may be processed at least partially based on the selected keyword search information and/or the potential correction(s). For example, a subset of the set of listing information may be selected using the selected keyword search information and/or the potential correction(s) as criteria. In some embodiments, where the listings information is or includes suggestion information, the suggestion information may be processed at least partially based on the selected keyword search information and/or the potential correction(s).

As indicated by block 1618, in some embodiments, the listings information may be qualified based at least in part on one or more of results, area(s) of interest, and/or proximity. The qualification may bear on how relevant the listings information is to the area(s) of interest. In certain embodiments, the search area and/or corresponding listing information may be iteratively modified dependent upon the results of one or more searches. For example, an initial search for an initial search area may yield too few or no results; and the search area may be iteratively expanded to increase the results. With certain embodiments, fuzzy matching operations, disclosed further herein, may be initiated to capture more results. When sufficient results are determined, whether by an initial search or an iterative search, distance calculated from the user's geography (e.g., coordinates) to the suggestion geography could be used to rank the results.

In some embodiments, as indicated by block 1620, suggestions may be processed. For example, suggestions from the index(es) 253 may be selected based on rankings discussed herein. Selected suggestions may be presented for user selection in, proximate, or otherwise in a manner associated with the query field based on the selected keyword search information and/or the potential correction(s). For example, a top-ranked suggestion could appear in the query field as a type-ahead suggestion, over at least a portion of the query filed, or beside the query field so that a user may accept the top-ranked suggestion via selection of a space key, selection of an enter key, or any other suitable manner of selection. Additional suggestions could appear beside the query field (e.g., in a drop-down listing) for user selection in any suitable manner. The additional suggestions could be presented in a ranked order according to their suggestion ranking, which, as discussed herein, may be based on mined user interest data.

As indicated by block 1622, the search may be performed, and search results may be processed at least partially based on the selected suggestion. In some embodiments where keyword search information may be processed character by character (or character group by character group), any one or combination of the method steps may be performed as the search string is being input into the query field. In some embodiments, search results may be pre-loaded as the search string is being input into the query field. The search results may correspond to the one or more suggestions. As each character is input into the query field subsets of the listing information may be identified and may be stored in cache for faster retrieval. The listing information identified for pre-loading may correspond to one or more of the original search string, the one or more potential corrections, and/or the one or more suggestions. In various embodiments, various method steps may be performed on the basis of any number of characters as the characters are input into the query field.

Certain embodiments may employ any suitable compression method. For example, in some embodiments, information for a particular provider, such as a provider name, may need only be stored once for a particular area. A concomitant frequency field may indicate the number of sites for that particular provider in that particular area.

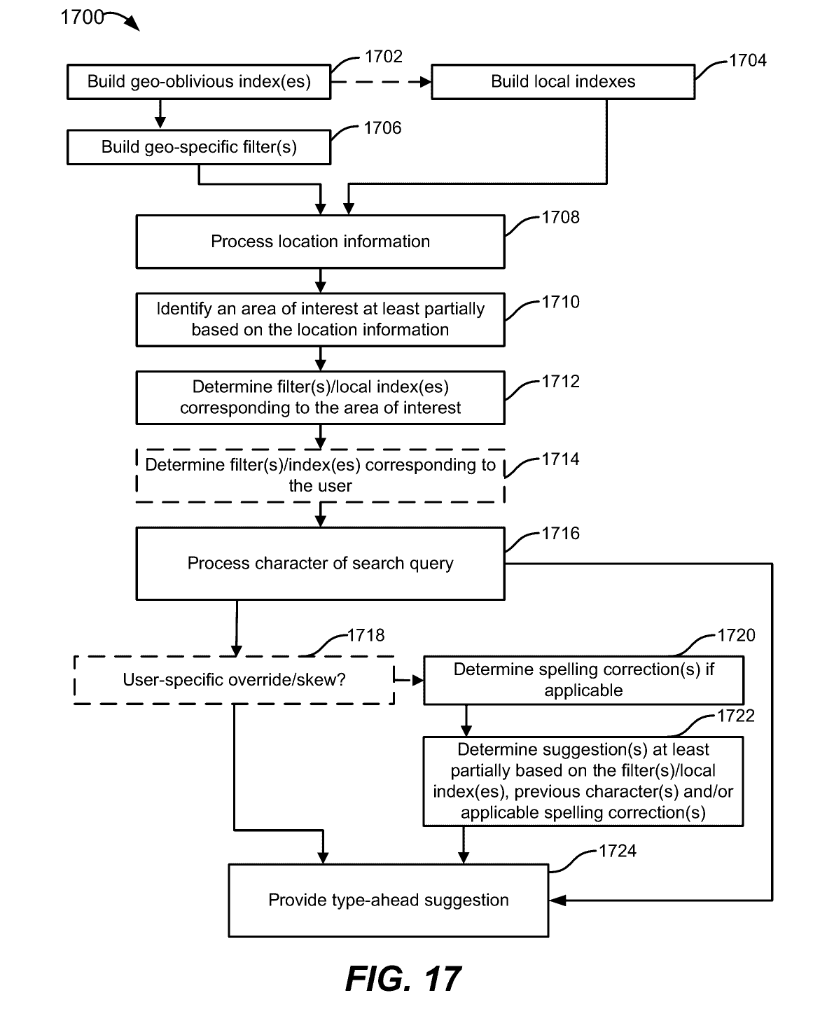

FIG. 17 illustrates an example method 1700 of providing for geo-aware autosuggestion in a geographical area of interest to a user of an end-user device 205, in accordance with certain embodiments of the present disclosure. According to some embodiments, the method 1700 may begin as indicated by 1702. As indicated by block 1702, one or more geo-oblivious indexes may be constructed. The one or more geo-oblivious indexes may correspond to a master index of embodiments.

As indicated by block 1704, in some embodiments, local indexes may be constructed. As previously disclosed, one or more indexes 253 may be constructed and linked to particular localities. Strings corresponding to listing information may be decomposed, and an inverted list may be generated for each n-gram. Corresponding strings may be determined and linked, which corresponding strings may include one or more of similar strings, synonymous strings, spelling variants (which may include phonetic variants, punctuation variants, symbol variants, spacing variants, capitalization variants, and/or the like), and/or the like. TF/IDF may be determined. Suggestions for a locality may be ranked and sorted according to alphabetical order based on character(s). For example without limitation, a top-ranked suggestion or set of suggestions for the locality may be identified for a single character input C1, and top-ranked suggestions for the locality may be identified for character strings stemming from the first character input C1 (C1C1, C1C2, C1C3, . . . C1C1C1, C1C1C2, . . . etc.) so that, as a user types a query character by character, corresponding geo-aware suggestions may be selected character by character. The most relevant suggestion(s) for each prefix or other character string input may be identified and, in the case of multiple suggestions for a given input, sorted according to relevancy. Accordingly, a small number of the most relevant suggestion(s) corresponding a user input may be identified for presentation to a user, which small number may be compatible with limited presentation space and maximum ease for user skimming (i.e., a user may not be interested in reviewing a long list of decreasingly relevant suggestions).

As discussed herein, any suitable basis or bases may be used for scoring and ranking geo-aware suggestions in various embodiments, including one or more of past click information, frequency of particular queries in a particular locality, trends of particular queries in a particular locality, popularity of search results corresponding to particular queries in a particular locality, agreements with other providers to boost visibility of listings corresponding to particular queries, relevance/correspondence of query strings to listings, and/or the like. Some embodiments may assess relevance of a suggestion in accordance with one or more aspects of assigning weights and an overall relevance score as discussed herein with respect to method 2000, for example. Some embodiments may qualify a suggestion according to a graduated scoring scale. Any suitable suggestion scoring scale may be used in various embodiments. Some embodiments may score a suggestion with a numerical expression. A suggestion scoring scale could include a range of suggestion scores from 0 to 100, with the higher end corresponding to higher percentiles of user interest indicia. Some embodiments may use methods of statistical analysis to derive a suggestion score.

In some embodiments, geo-aware spellchecking features discussed herein may be applied to the geo-aware suggestions in order to capture variants and to handle unusual character combinations. Thus, with variants and/or unusual character combinations, variants may be selected automatically, and, in some embodiments, options may be presented to the user (e.g., “Did you mean <insert variant>?” or “How about <insert variant>”?) that may be particularly appropriate if the variance of the suggestion is significantly different, such as having a different starting character(s).

As indicated by block 1706, in some embodiments, alternatively or additionally, one or more geo-specific filters may be constructed in addition to or in alternative to building local indexes. The one or more geo-specific filters may be used to refine the master index to select a geo-specific subset of index components in a manner similar to the construction of local indexes, without actually creating local indexes. For example, in some embodiments, a geo-specific filter may employ a pointer method to only identify those index components of the master index that are geo-relevant. As another example, in some embodiments, a geo-specific filter may deselect, hide, or otherwise indicate certain index components of the master index as not being geo-relevant. Certain columns and/or rows of tabulated index data, for example, could be hidden. Any suitable method may be employed to refine the master index and or otherwise create a temporary or permanent custom index with one or more geo-specific filters. Thus, the one or more geo-specific filters may function as an overlay for the master index.

As indicated a block 1708, location information may be processed in one or more ways in accordance with various embodiments discussed herein. As indicated by block 1710, an area of interest may be identified at least partially based on the location information, as discussed herein. As indicated by block 1712, one or more geo-specific filters and/or local indexes corresponding to the area of interest may be determined.

As indicated by block 1714, in some embodiments, one or more filters and/or indexes corresponding to the user may be determined. In some embodiments, the mobile application and/or the information handling system may include features for automatically identifying potential queries and/or listings of interest to a specific user based at least in part on user history information. A particular user could have a history and/or profile associated with using search features facilitated by the information handling system, for example, via a client application, a webpage, a mobile application, and/or the like. For example, queries and/or listings of interest may be identified from query and/or web browsing history information retained on the user computing device. Some embodiments may provide for options for user initiation of gathering indicia from user history information; some embodiments may perform the process automatically. Some embodiments may skew suggestions in view of user history by creating a user-specific filter. For example, a user history may indicate the level of interest in certain types of listings, say types of venues, and suggestions may be accordingly skewed in view of that interest. As another example, a user is to indicate a level of interest corresponding to a particular location, and suggestions likewise may be accordingly skewed in view of that interest.

As indicated a block 1716, one or more characters of the search query may be processed. In some embodiments, character-by-character transmission the information handling system 102 is automatically performed prior to the user selection of the search option. In some embodiments, suggestion information may be available locally on the device of the user such that character-by-character transmission is minimized or not necessary.

As indicated by block 1718, in some embodiments, a user-specific override and/or skew may be employed. It may be determined whether such user-specific qualifications are to be employed in a given implementation. In the case that it is determined that such user-specific qualifications are to be employed, user-specific suggestions could be provided in lieu suggestions that would otherwise be selected. For example, previous queries of a specific user could supplant suggestions that would otherwise be provided. Additionally or alternatively, previous queries of a specific user could be used to rank suggestions differently. For example, a user's level of interest in a particular type of listing may be used to score listings differently; say the user has had a previous interest in a particular category of venues, suggestions of venues in that particular category could be weighted more heavily in view of that interest.

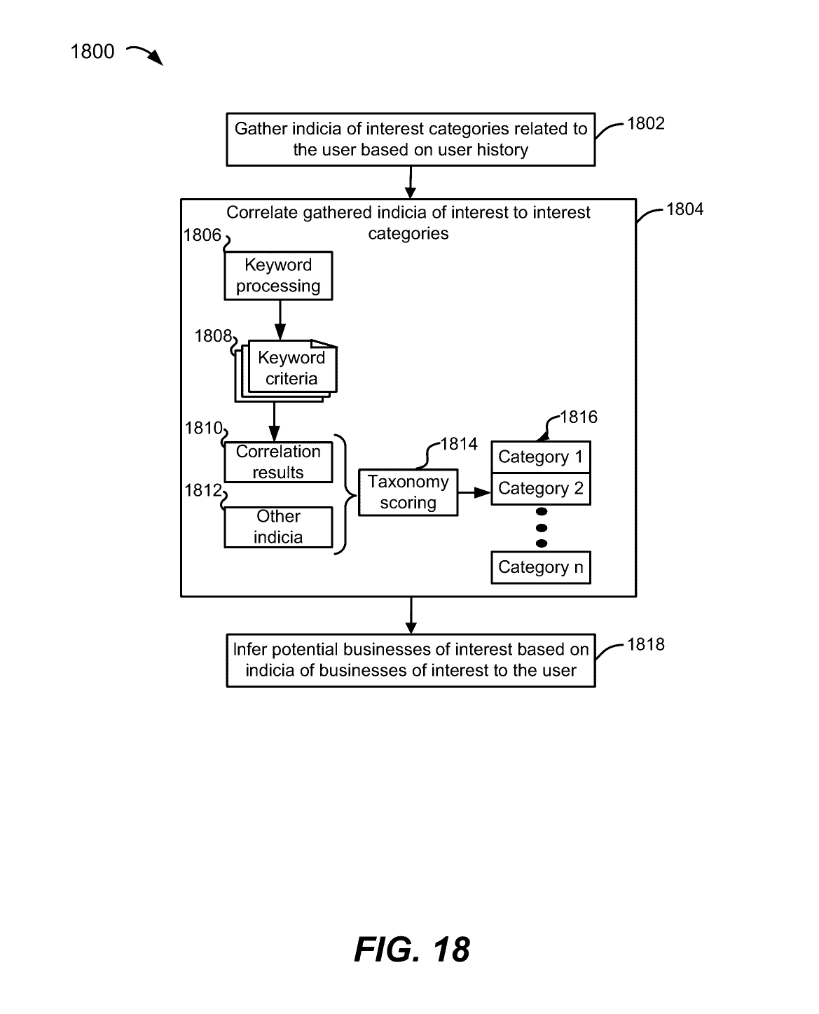

FIG. 18 is a block diagram that illustrates an example method 1800 of gathering indicia of user interests, in accordance with certain embodiments of the present disclosure. The method 1800 may illustrate certain aspects as a predicate to user-specific adaptation in various embodiments such as, for example, the user-specific override, skew of method 1700, and/or weight/scoring relevance of suggestions to facilitate fuzzy autosuggestion searching. As indicated by block 1802, indicia of user interests may be gathered. Interest data may include any suitable information that may be captured to indicate, infer, and/or determine interest categories and/or providers of interest.

Certain embodiments may use a client application installed on the user's computing device to facilitate data capture. In some embodiments, the client application may qualify captured data in part or in whole and/or send captured data to the information handling system 102 for qualification. In some embodiments, an interest indicia gathering utility may include features for identifying potential providers of interest to a specific user based at least in part on user history information. A particular user could have a history and/or profile associated with using search features facilitated by the system 102, for example, via a client application, a webpage, a mobile application, and/or the like. For example, providers of potential interest may be identified from web browsing history information retained on the user computing device. Some embodiments may identify providers of potential interest based on user indications of preference (such as positive rating provider, an indication of liking the provider, friending or otherwise linking to a provider, sharing provider information with others, etc.) that the user has made via webpages and/or social media. Such indications of reference may be garnered from information associated with application on the user's computing device and/or via other data sources. The interest indicia gathering utility may include features for automatically identifying potential providers of interest to a specific user based at least in part on one or more other accounts of the user. A user's account with the searching service could be linked (e.g., via API) to one or more other accounts of the user, including an account associated with online social/provider networking services (which may include microblogging/short messaging services), an email account, and/or any other suitable data source. In some cases, a user could be prompted to login to the user's other account(s) to allow for the harvesting. In some cases, previously provided authentication information stored by the system 102 may be used so that logging in is not necessary to enable the harvest. Providers of interest could be identified by approval/disapproval indicators, which may be in form of likes, dislikes, thumbs-up, thumbs-down, star-scale ratings, number-scale ratings, fan indications, affinity group association, messages to providers, and/or the like. The approval/disapproval indicators could be those associated with the user's profile and/or profiles of friends/associates/connections of the user.

In some embodiments, the gathering of indicia of interest may support the generation of user profiles, and could be used to refine user profiles. In some embodiments, user profiles may be transferred from the application to the information handling system 102. In other embodiments, only information related to the profiles may be transferred to the backend system 102. The information handling system 102 may have profiles for providers. As indicated by block 1804, the gathered indicia of interest may be correlated to interest categories and/or specific suggestions. In some embodiments, the provider profiles may include or be linked to one or more taxonomies that map particular providers/provider categories and particular interests/interest categories.

Having interest data, the information handling system 102 and/or the application may implement a qualification process. Some embodiments may qualify an interest according to a graduated scale. Any suitable scale may be used in various embodiments. In some embodiments, a scale could entail a categorization scheme 1816, with any suitable categories. In some embodiments, a taxonomy scoring system 1814 could be correlated to the category scheme, such that certain scores may correspond to certain categories so that, based on a given set of interest data, a high correlation score to a particular category may indicate the category is more appropriate. Some embodiments may score with a numerical expression. Accordingly, a taxonomy score may indicate which categories are more/most likely to be appropriate for a user, thus providing a quantitative estimate of a user interest. By way of example without limitation, a scale could include a range of scores from 0 to 100, or from 0 to 1,000, with the high end of the scale indicating greater probability. Some embodiments may use methods of statistical analysis to derive a score. Various embodiments may determine a score based on any one or more suitable quantifiers.

Some embodiments may employ a decision tree, checklist, workflow, and/or the like to capture various aspects of interest data and assess those aspects to infer interest qualification. Such a decision tree, checklist, and/or workflow may incorporate any one or combination of the depicted aspects and/or similar aspects in any desired order, according to various embodiments. Interest data can be consolidated and processed to yield a taxonomy score 1814.

Certain embodiments may provide for keyword processing 1806 of gathered interest data, such as any data related to indicia of interest discussed herein. In some embodiments, an impression engine, which could be included in the autosuggestion engine in some embodiments, could perform keyword identification. The impression engine could be configured to recognize evidence of interest potential. Taxonomy scores 1814 may be based at least in part on keywords gathered. The impression engine may identify keywords as distinctive markings and could compile the keywords for the purposes of characterization from the perspective of interest potential. The keywords could be correlated with keyword criteria 1808 to characterize the data from the perspective of interest potential and to generate correlation results 1810 that can be taken into account with scoring 1814. In some embodiments, the correlation results 1810 can be taken into account in conjunction with other indicia 1812, which could correspond to any one or combination of the other indicia of interest potential discussed herein such as location information and/or the like.

In some embodiments, information harvested regarding a user may be used to infer potential providers of interest to the user, as indicated by block 1818. For example, if interest data indicates that a user has a pet, local providers related to pets and/or that otherwise would only be of interest if one has a pet could be identified/suggested as potential providers of interest. Similarly, if interest data indicates that a user is a parent, providers that would only be of interest to parents could be identified/suggested as potential providers of interest. Accordingly, in some embodiments, user-specific override/skew may be used to modify the one or more geo-specific filters and/or local indexes. In some embodiments, the fuzzy search algorithms may be based at least in part on the user-specific override/skew.

Referring again to FIG. 17, as indicated by block 1720, applicable spelling correction(s) may be determined in accordance with any one or combination of embodiments discussed herein. As indicated by block 1722, one or more geo-aware suggestions may be determined at least partially based on the one or more filters and/or local indexes and previous character(s) that the user has typed search query, if any. In some cases, the one or more geo-aware suggestions may be determined at least partially based on applicable spelling correction(s). In embodiments where one or more local indexes are employed, a lookup in the one or more local indexes may be performed with the current state of the search string.

In embodiments using one or more geo-oblivious indexes that correspond to a master index, a lookup in the one or more geo-oblivious indexes may be performed with the current state of the search string. Then, the results of the lookup may be screened with the one or more geo-specific filters. Alternatively, the one or more geo-specific filters may be used to refine the master index to select a geo-specific subset of index components. For example, in some embodiments, a geo-specific filter may employ a pointer method to only identify those index components of the master index that are geo-relevant. As another example, in some embodiments, a geo-specific filter may deselect, hide, or otherwise indicate certain index components of the master index as not being geo-relevant. Any suitable method may be employed to refine the master index and or otherwise create a temporary or permanent custom index with one or more geo-specific filters. Thus, the one or more geo-specific filters may function as an overlay for the master index. Then, with the geo-specific filter(s) applied to the master index, a lookup with the current state of the search string and the refined geo-specific subset of index components may be performed. As indicated by block 1724, the one or more geo-aware suggestions may be may be processed and presented as type-ahead suggestion(s) for user selection in, proximate, or otherwise in a manner associated with the query field.

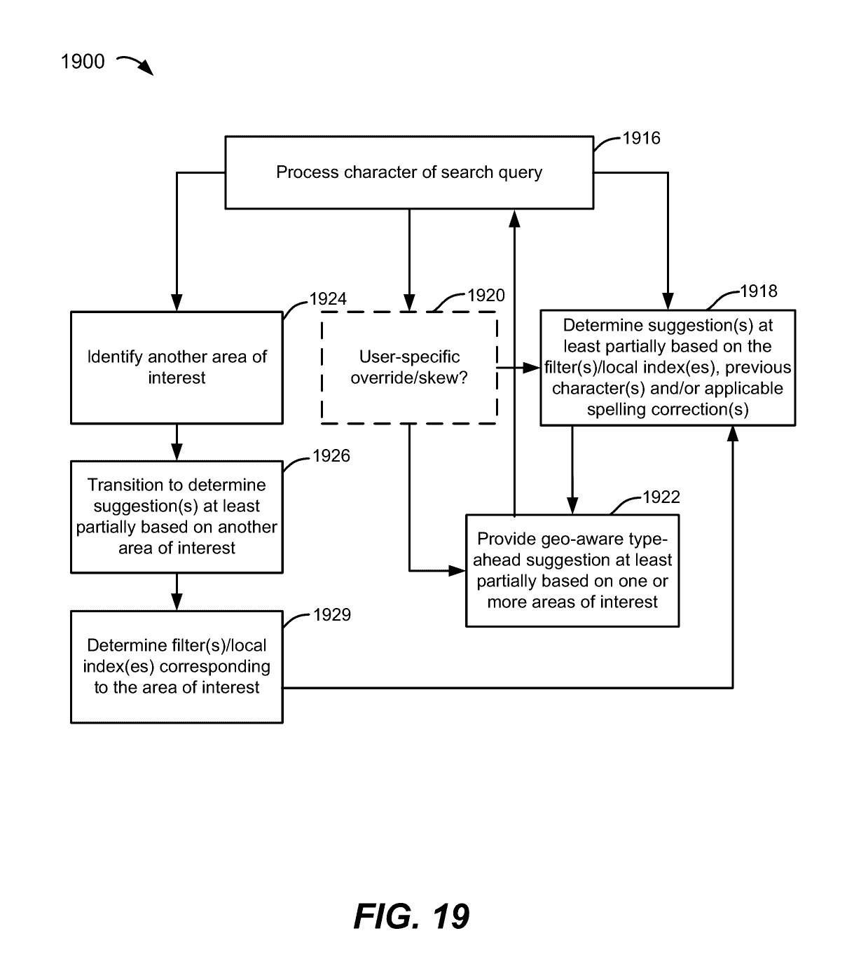

FIG. 19 illustrates an example method 1900 directed to further features for geo-aware autosuggestion in a geographical area of interest to a user of an end-user device 205, in accordance with certain embodiments of the present disclosure. The method could correspond to a subprocess of method 1700 in some embodiments, with step 1916 of method 1900 corresponding to step 1716 of method 1700. The method could correspond to a subprocess of other methods disclosed herein. The method 1900 may allow for type-ahead geo-aware suggestions to transition midstream as a query is entered character by character from a first area(s) of interest to a second area (s) of interest based at least in part on real-time determination that the second area(s) of interest are relevant.

As indicated by block 1916, one or more characters of the search query may be processed. As indicated by blocks 1918, 1920, and 1922, the process may proceed as previously discussed with respect to a first set of one or more areas of interest. However, as indicated by block 1924, a second set of one or more areas of interest may be identified as the process proceeds. For example, while a first set of location information may have been previously processed, a second set of location information may be subsequently processed. The second set of location information may be subsequently processed in any suitable manner as discussed previously. In some embodiments, the first set of location information may have been identified by default, for example, based on a past user interaction, and the second set of location information may be based on updated information. In some embodiments, the second set of location information may be due to a change in locations as the user is traveling. Say, for example, the user begins a query while in one location, gets interrupted, and then completes the query in another location. In some embodiments, the second set of location information may be derived from the search query itself. For example, the suggestion engine may check the progressing query string for location relevance. The user may enter location information as a search query and/or the search query may be relevant to one or more particular locations. For example, the search query may form a location-indicative keyword, either explicitly or implicitly.

As indicated by block 1926, the process may transition to determine one or more geo-aware suggestions at least partially based on the second set of one or more areas of interest that have been identified. In some cases, the suggestion engine may eliminate a previously identified area of interest in view of the new information. For example, a previously identified area may have been based on automatically-gathered location information about the user's whereabouts, but a newly identified area of interest may not be related to the user's current whereabouts; a user may be located in Los Angeles while searching for something in New York, for example. Accordingly, the suggestion engine may deselect previously identified filters and/or local indexes.

As indicated by block 1928, one or more filters and/or local indexes corresponding to the second set of one or more areas of interest may be determined. The process flow may then transition back to block 1918. And the process may continue in view of the newly selected filters and/or local indexes. Though not depicted, in some embodiments, the applicable spelling correction(s) may be determined in view of the different area of interest, in accordance with any one or combination of embodiments discussed herein. Thus, the one or more geo-aware suggestions may be determined at least partially based on applicable spelling correction(s) specific to the second area of interest. Then, in embodiments where one or more local indexes are employed, a lookup in the one or more local indexes may be performed with the current state of the search string.

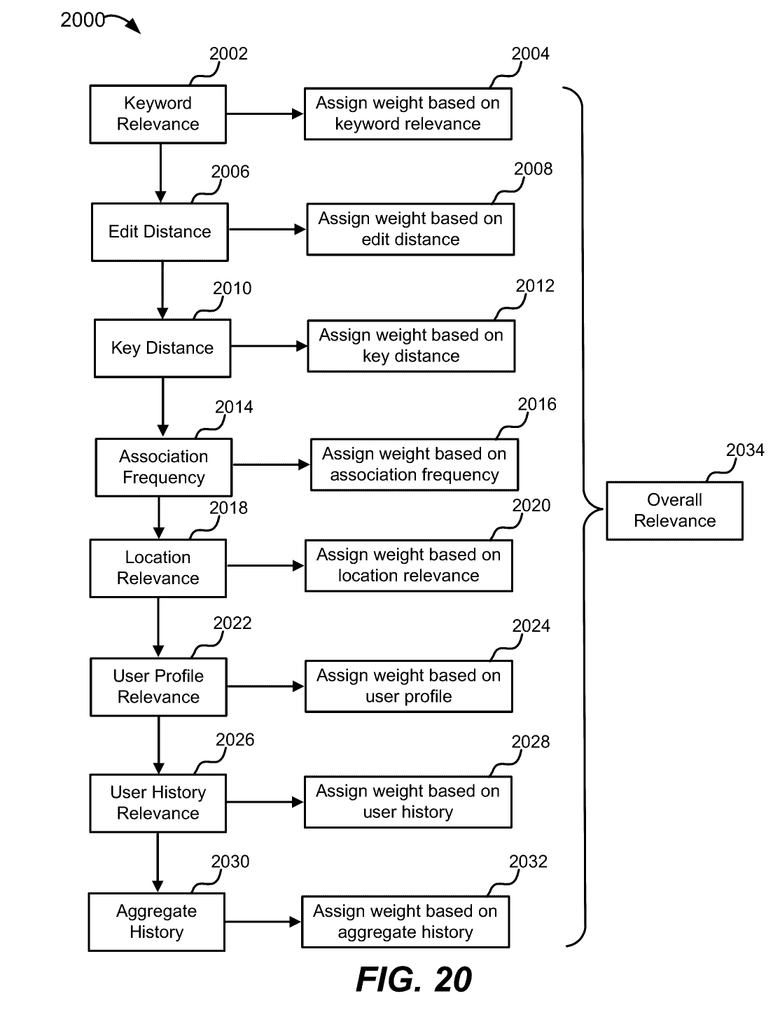

FIG. 20 illustrates an example functional model 2000 for assessing, scoring, and ranking suggestions, in accordance with certain embodiments of the present disclosure. According to some embodiments, the functional model 2000 may begin as indicated by 2002. In some embodiments, the functional model 2000 may be implemented as a decision tree. As indicated by block 2002, keyword relevance may be determined for one or more datasets. For example, a dataset corresponding to a particular search result may be identified with the indexes 253. A given dataset may be identified by keyword and/or n-gram. In some embodiments, TF/IDF may be used to assess a particular dataset, such as a document, based on the inclusion of a particular word and/or n-gram in the particular dataset.

In some embodiments, the indexes 253 may be used to identify one or more potential keyword search results. In some embodiments, a search string corresponding to the keyword search information may be decomposed at the word level, and the indexes 253 may be searched for one or more datasets with one or more words in common with the search string. In some embodiments, the search string may be decomposed into n-grams of any suitable length, and the indexes 253 may be searched for one or more datasets with one or more n-grams in common with the search string. With various embodiments, fuzzy matching may be utilized to find not only words/n-grams/prefixes in common with the search string per exact matching, but also words/n-grams/prefixes similar to the search string per fuzzy matching. In some embodiments, the search string may be analyzed at least in part by identifying one or more corresponding prefixes. For example, a prefix of the search string may be identified for comparison, and one or more corresponding prefixes in the listing prefixes repository 249′ may be identified based on the prefix of the search string. A TF/IDF may be determined with respect to the identified datasets.

Any suitable algorithm for assessing similarity may be employed. Some embodiments may identify intersections between multiple sets. Having set intersections identified, the intersections may be compared. A greater extent of an intersection, that is, a larger intersection, may be an indication of a greater degree of potential similarity between the corresponding sets. In some embodiments, the sets may be ranked according to the extent of the intersections.

As indicated by block 2004, a weight may be assigned to the one or more datasets based on keyword relevance. For example, a dataset corresponding to a particular search result may be associated with a relevancy score. The relevancy score may be result at least partially based on TF/IDF in some embodiments. An overall relevance may take into account the weight assigned to a search result based on the keyword relevance, as indicated by block 2034. And, thus, the ranking of the search results may be at least partially based on TF/IDF associated with the search results. In some embodiments, a TF/IDF may indicate a weight for weighted similarity measures. For example, sets of ranked intersections may be weighted in view of TF/IDF measures for each of the sets.

As indicated by block 2006, come embodiments may identify edit distance between multiple sets. Lesser edit distance may be correlated to indicating greater similarity. The edit distance may be utilized to as an indication of potential similarity with one or more edit distance thresholds. As indicated by block 2010, fuzzy matching metrics that take into account key distance of letters on a standard keyboard may be used as a basis for assessing relevance. As indicated by block 2014, word association frequency (i.e., how often words are used together) may be used as a basis for assessing relevance. As indicated by blocks 2008, 2012, 2016, respective weights may be assigned to the one or more datasets based on edit distance, key distance, and/or association frequency. Any suitable criteria may be used to identify and assign a weight.

As indicated by block 2018, location relevance may be determined for one or more datasets. Location information may be processed at, by, and/or with the end-user device 205 and/or the system 102. In some embodiments, the location engine 244 may process information about a first location. The information may be gathered in any one or combination of ways in accordance with various embodiments discussed herein.

As indicated by block 2016, a weight may be assigned to the one or more datasets based on location relevance, and the weight may be taken into account with the overall relevance score, as indicated by block 2030. Any suitable criteria may be used to identify and assign a weight. In some embodiments, the weighting may be at least partially based on the degree of matching between the geographic area of interest to the user and a service area of an provider. For example, in some embodiments, when other conditions are the same, the further the provider is from the geographic area of interest, the lower the weight of the corresponding provider may be. In some embodiments, the weighting may be at least partially based on proximity of a provider to an area of interest that may encompass and/or be defined by/with respect to a metropolitan area, provider district, and/or the like. In some embodiments, an area of interest may be defined at least in part by political, physical, and/or topographical map characteristics.

In various embodiments, the form of an area of interest may be more tailored to the specific needs of the user in some embodiments, e.g., by taking into account a user's direction of travel. An area of interest may be based on the user's direction of travel. The area of interest may be based on the likely routes the user may take. An area of interest may be defined at least in part by deviation. For example, the deviation could be a maximum distance from one or more routes from the origin. The deviation could be quantified in distance as the crow flies (i.e., the shortest distance between the origin and the destination), driving distance, and/or driving time. For example, the area of interest may exclude an area that, while being close to the main highway, would involve relatively greater deviation in driving time and distance.

As another example of taking into account a user's direction of travel, the area of interest may be a triangular or funnel-like shape, e.g., generally extending outward from the user's current location along the user's direction of travel may be most convenient for the user to minimize deviation from the user's currently traveled route. Such an area of interest may appropriate for relatively long and/or straight stretches of highway. An area of interest could exclude certain locales for any of a variety of reasons. For example, a high-crime area could be excluded. For example, the area of interest may exclude an area because it has a high rate of crime relative to other areas nearby or because of any suitable reason. Accordingly, one or more areas of interest may be used to assign a weight based on location relevance. For example, a weight may correspond to a proximity of an provider to one or more areas of interest, with greater extents of correspondence associated with greater weights.

As indicated by block 2022, a relevance to a user profile may be determined for one or more datasets. For example, in some embodiments, location information can be obtained from user preference data. The user profile may include user-indicated location information corresponding to a place of work, the user's home, or other locations of interest. The user profile may include other user-indicated information, such as preferences with respect to particular provider categories and/or particular providers that correspond to particular provider categories. The user profile may include demographic information such as a sex, age or age range, and/or other suitable characteristics.

As indicated by block 2024, a weight may be assigned to the one or more datasets based on relevance to the user profile, and the weight may be taken into account with the overall relevance score, as indicated by block 2034. Any suitable criteria may be used to identify and assign a weight. In some embodiments, the weighting is partially based on the degree of matching between user-indicated location information and a service area of an provider. In some embodiments, the weighting is partially based on the degree of keyword matching between other user-indicated profile information and a search result.

As indicated by block 2026, a relevance to a user history may be determined for one or more datasets. A history of past interactions for a particular user and/or computing device may be compiled. In some embodiments, location information can be based at least partially on past experience with a particular user and/or computing device. For example, past inquiries may be stored and used for inferring location information. As another example, the last X number of inquiries from a particular user over a certain time period may have related to a particular geographic area or set of geographic areas, and such information may be stored as an indication of relevance. As yet another example, the past location information, automatically gathered and/or user-indicated, may be stored as an indication of relevance. If it is determined from a user history that the user has associated with a particular part of town, the association may be stored as an indication of relevance. For example, the user has associated with a particular affluent part of town, that association may be stored as an indication of relevance. If it is determined from a user history that the user has an interest in a particular listings category, such as restaurants, that interest may be stored as an indication of relevance.

As indicated by block 2030, a relevance to an aggregate history may be determined for one or more datasets. For example, in some embodiments, the one or more data repositories 268 may store statistics of the tracked user interactions to determine an indicator of the level of user interest in a listing or category of listings. For example, query distribution can change over time. There can be seasonal distribution changes, weekly distribution changes, and daily distribution changes. Analyzing the query distributions may identify popular changes over a particular time period, such as any number of recent hours or days. For example, user interactions in a particular area may indicate an interest in a listing or category of listings and/or that a certain listing or category of listings is more popular than others. In some embodiments, popularity of a listing among a set or subset of users, such as users of specific mobile computing device products, of a particular sex, of a particular age or age range, and/or having other suitable characteristics. The data repository 268 may store the statistics as logs of web access to the listings and/or other information related to the listings. The data repository 268 may store the statistics in the form of counts of user interaction with listings.

In some embodiments, an indication of relevance of a search result may be based on past click information. For example, past click data for the original keyword search string could be mined from click logs. The number of clicks over time may be assessed for the search result(s) corresponding to the keyword search string. The clicks could correspond to one or more of clicks through to a particular website, invocation of a mapping application in view of a particular search result, a call to an provider or other contact derived from the search result, and/or the like. Any of various times periods may be used in various embodiments. For example without limitation, the time period for consideration could be the past year, the past 6 months, the past month, the past week, etc.

As indicated by block 2028, a weight may be assigned to the one or more datasets based on relevance to the user history. As indicated by block 2032, a weight may be assigned to the one or more datasets based on relevance to the aggregate history. Any suitable criteria being used to identify and assign a weight. In some embodiments, the weighting is partially based on the degree of matching, such as keyword matching, between user history information and a particular search result.

As indicated by block 2034, any one or combination of the weights assigned as indicated by blocks 2004, 2008, 2012, 2016, 2020, 2024, 2028, 2032 may be summed or otherwise used at least as a partial basis for deriving an overall relevance score. Any suitable scale may be used for the scoring. The overall relevance score(s) for one or more search results may be used for the assessing/ranking/scoring of suggestions and/or corrections in any one or combination of embodiments discussed herein.

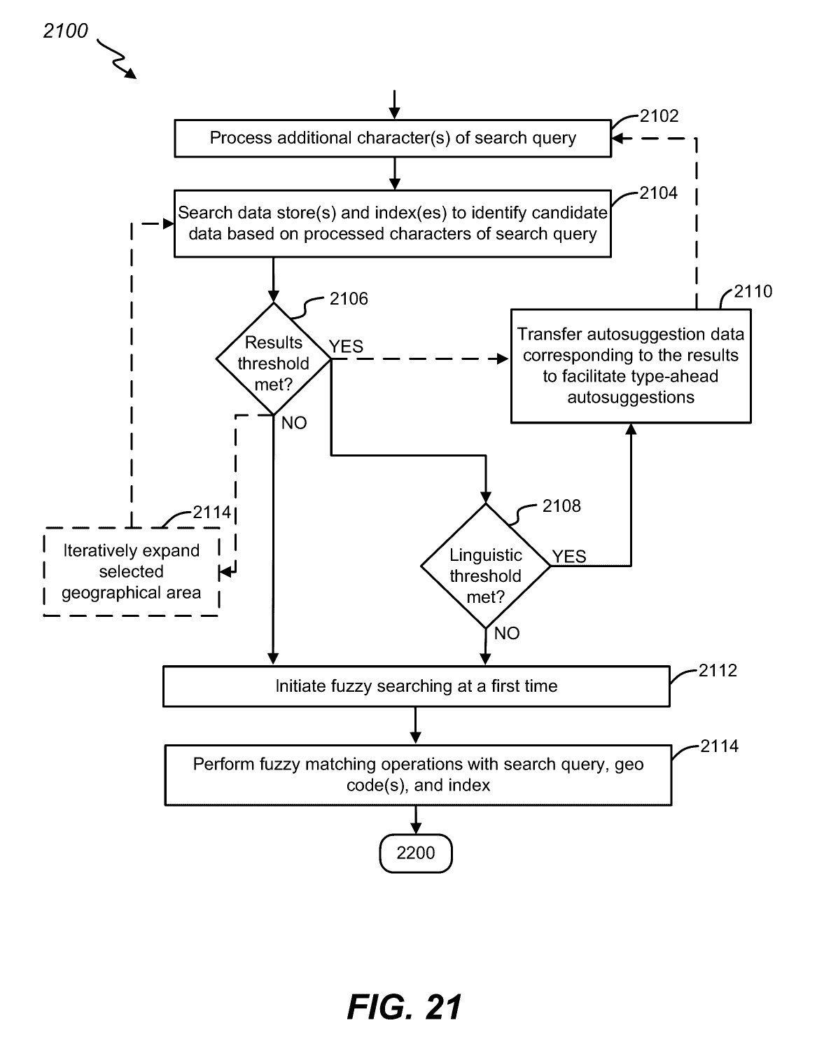

FIG. 21 illustrates an example method 2100 of generating geo-refined fuzzy autosuggestions for a search engine, in accordance with certain embodiments of the present disclosure. In some embodiments, the method 2100 may correspond to other aspects of autosuggestion features disclosed herein and, in some embodiments, may correspond to a subprocess of autosuggestion methods disclosed herein. While not illustrated in FIG. 21, information about a geographical location may be processed, a geographical area may be identified at least partially based on the information about the geographical location, and other steps previously described may be performed.

As indicated by block 2102, one or more characters of the search query may be processed. As indicated by block 2104, one or more information handling engines 243 may search one or more data stores 256 to identify candidate data based at least in part on the one or more characters of the search query. For example, one or more indexes 253 may be searched based on the processed characters of a developing search query. In various embodiments, such a search may incorporate various features disclosed herein such as utilizing selected keyword search information, filters, local indexes, spelling corrections, and/or the like.

As indicated by block 2102, the results of the search for candidate data may be assessed, and it may be determined whether a results threshold has been met. Consequent to a determination that the results threshold has not been met, the process may flow to block 2112. As indicated by block 2112, fuzzy searching may be initiated at a first time.

Various results thresholds may be employed to trigger fuzzy searching in various embodiments. For example, certain embodiments may employ results threshold corresponding to at least one result. In such cases, as long as one autosuggestion candidate has been identified per the search, the results threshold has been satisfied. In other embodiments, the results threshold may correspond to two, three, four, or more results. Accordingly, in some embodiments, fuzzy searching may be initiated to address a lack of autosuggestion candidates for a given character series of the entered search string.

In certain embodiments, as indicated by block 2114, if no local result or too few local results are found for the partially entered query, the search area and/or the corresponding listing information may be iteratively modified dependent upon the results. For example, an initial search for an initial search area may yield too few or no results; and the search area may be iteratively expanded to increase the results. In some embodiments, such an expansion may be used in parallel with fuzzy searching. Thus, where the results threshold has not been met, fuzzy searching and iterative expansion may be initiated. In other embodiments, iterative expansion may be employed as a preliminary step before fuzzy searching is initiated. Fuzzy searching could, for example, be used after iteratively expanding the search area to a certain threshold (say, for example, an entire metro area corresponding to the area of interest indicated by the location information). And, in some embodiments, a first iterative expansion may be employed as a preliminary step before fuzzy searching is initiated, and, if the results threshold still has not been met as a result of the first iterative expansion, fuzzy searching may be initiated along with a subsequent iterative expansion.

In some embodiments, consequent to a determination indicated by block 2102 that the results threshold has been met, the process may flow to block 2110. As indicated by block 2110, autosuggestion data corresponding to the results of the search for candidate data may be transferred to facilitate type-ahead autosuggestions, in accordance with embodiments disclosed herein.

However, in some embodiments, consequent to a determination indicated by block 2102 that the results threshold has been met, the process may flow to block 2108. As indicated by block 2108, it may be determined whether a linguistic threshold has been met. Consequent to a determination indicated by block 2108 that the linguistic threshold has been met, the process may flow to block 2110. When the linguistic threshold has not been met, the process may flow to block 2112 and fuzzy searching may be initiated at a first time.

In some embodiments, a linguistic assessment may be performed to identify a query having one or more invalid words. Hence, the linguistic threshold may specify a number of invalid words. Invalid word identification may be based at least in part on the results of the search not matching one or more of the query words. For example, one or more of the query words may have been omitted by the search to yield the search results; one or more of the query words may not have matched any candidate data. Invalid word identification may be based at least in part on one or more of the query words not being found in one or more indexes and/or dictionaries searched by the information handling engine 246. In some embodiments, the spellchecking engine 246A may identify invalid words based at least in part on the index(es) 253 and/or filter(s) 254. In some embodiments, the infrastructure 102 may maintain other local and/or global dictionaries accessible for linguistic assessment.

In some embodiments, alternatively or in combination, a linguistic assessment may be performed to identify a query having two or more infrequently associated words. The linguistic assessment may capture instances where the query may include a valid word, but not the word intended or most appropriate/relevant. Indexes and/or dictionaries of the infrastructure 102 may include word association metrics that score word association frequency (i.e., how often words go together). Relatively higher word association frequency scores may indicate that certain words are more frequently associated with each other (e.g., immigration attorney), whereas relatively lower word association frequency scores may indicate that certain words are less frequently associated with each other (e.g., immigration car). Scoring and classification of word associations may be performed in conjunction with the suggestion mining and ranking features disclosed herein. Hence, the linguistic threshold may specify a word association frequency score.

In some embodiments, fuzzy searching may be a default process that is not triggered by a results threshold for a linguistic threshold. In some embodiments, fuzzy searching may be shared after a certain number of characters and/or words of the partially entered search query have been received and processed. This could facilitate diversity in autosuggestions. And, in some embodiments, fuzzy searching may be performed in parallel with exact match searching in order to provide diverse results. For example, a first set of autosuggestion candidates resulting from exact match searching may be combined with a second set of autosuggestion candidates resulting from fuzzy searching in order to provide diversity of suggestions. In such embodiments, the autosuggestions could be sorted and ordered such that the first set of autosuggestion candidates is presented as having a higher priority than the second set of autosuggestion candidates.

In certain embodiments, fuzzy searching may be triggered by a diversity threshold that specifies a similarity score. For example, if a set of autosuggestion candidates resulting from exact match searching all correspond to the same or similar providers (e.g., multiple venues corresponding to a provider chain and having different geolocations), the candidates may have a high similarity score such that the diversity threshold is satisfied and fuzzy matching is triggered in order to provide a more diverse results set of auto suggestions. Any suitable similarity scoring methodology such as those disclosed herein may be employed.

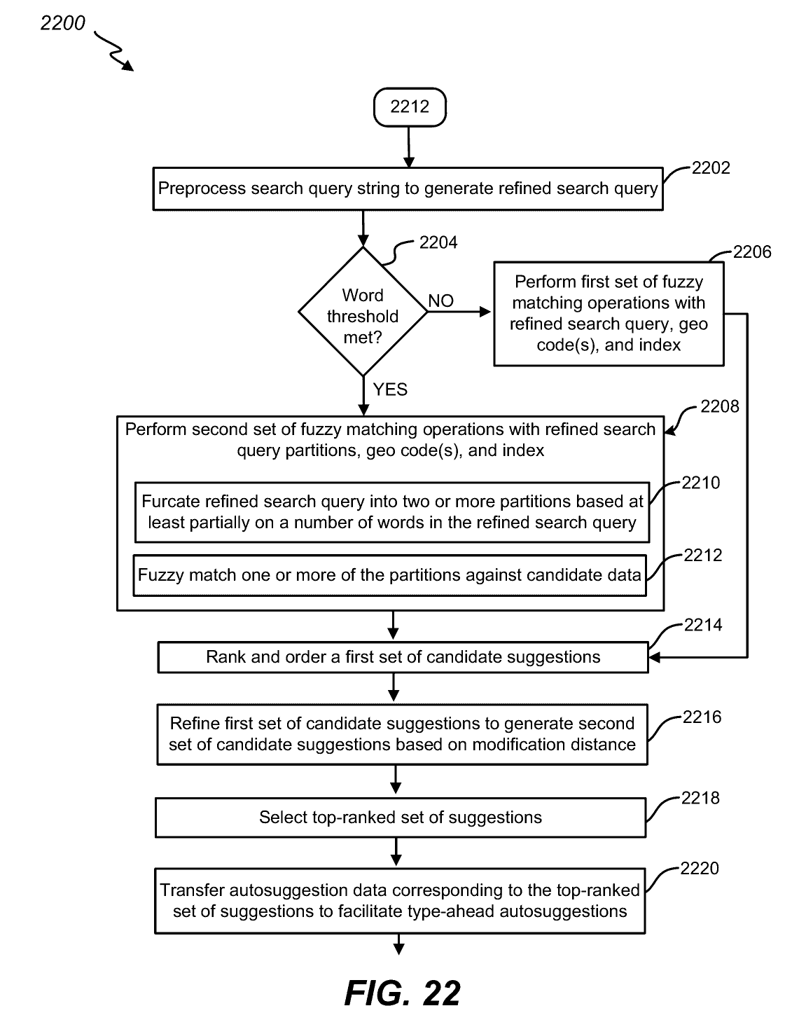

Following initiation of fuzzy searching, fuzzy matching operations may be performed, as indicated by block 2114. The fuzzy matching operations may be based at least in part on the search query, one or more geocodes, and the index(es) 253. Further details of certain embodiments generating geo-refined fuzzy autosuggestions are disclosed in conjunction with FIG. 22 and method 2200.

FIG. 22 illustrates an example method 2200 of generating geo-refined fuzzy autosuggestions for a search engine following initiation of fuzzy searching, in accordance with certain embodiments of the present disclosure. In some embodiments, the method 2200 may correspond to other aspects of autosuggestion features disclosed herein and, in some embodiments, may correspond to a subprocess of autosuggestion methods disclosed herein. For example, with certain embodiments, the method 2200 may flow from the initiation of fuzzy searching at a first time as indicated by block 2212 of the method 2100 as depicted.

As indicated by block 2202, the at least partially entered search query string may be preprocessed to generate a refined search query. For example, redundant spaces may be removed. Stop words may be removed. Any single characters may be removed. In some embodiments, a single character may not be removed if it corresponds to the last word of the query string, but other single characters may be removed.

In some embodiments, fuzzy matching operations may be contingent on the number of words in the query string. With some embodiments, different fuzzy matching methods may be used and the determination of which one or more particular fuzzy matching methods are to be used may be a function of query string length. In certain embodiments, the determination of which one or more particular fuzzy matching methods are to be used may be a function of the number of words in the query string. Hence, as indicated by block 2204, it may be determined whether a word threshold has been met.

Consequent to a determination that the word threshold has not been met, the process may flow to block 2206. As indicated by block 2206, a first set of matching operations may be performed based at least in part on the refined search query, one or more geocodes, and the index(es) 253. In some embodiments, the first set of matching operations may be triggered by the condition of the query containing only one word or another number of words. The first set of matching operations may be performed according to a first fuzzy matching method. In some embodiments, the first fuzzy matching method may include performing phonetic matching against candidate data in the index(es) 253. For example, “jax” and “jacks,” having same phonetic expression, could be matched via phonetic matching.

Consequent to a determination that the word threshold has been met, the process may flow to block 2208. As indicated by block 2208, a second set of fuzzy matching operations may be performed based at least in part on the refined search query, one or more geocodes, and the index(es) 253. In some embodiments, the second set of fuzzy matching operations may be triggered by the condition of the query containing more than one word or another number of words. The second set of fuzzy matching operations may include multiple subsets of matching operations and may be performed according to one or more fuzzy matching methods different from the first fuzzy matching method.

As indicated by block 2210, the refined search query may be furcated into two or more partitions. In some embodiments, the number of partitions may be based at least in part on a number of words in the refined search query. In some embodiments, the query may be divided into two parts: q0 and q1. q0 may include the words before the last space; q1 may include the leading characters in the last word. The characters to be included in q0 may be based on the number of words in the query.

As indicated by block 2212, one or more of the partitions may be matched against candidate data in the index(es) 253. Continuing the example, q0 and q1 may be used to match suggestions in the index(es) 253. In some embodiments, matched candidate suggestions may either match with words in q0 to a certain extent or match with q0 from its beginning In some embodiments, q1 may not be used to match or may be used to match candidate suggestions match against candidate data separately. In some embodiments, q1 may be used for performing phonetic matching against candidate data in the index(es) 253. Matched candidate suggestions may be restricted to having corresponding geo-locations within a certain distance with the input geolocation. This would yield all the relevant suggestions for that query in the geography.

In some embodiments, edit distance may be included in fuzzy matching metrics used in matching operations as part of the process of identifying a first set of candidate suggestions. Edit distance (which may be referenced as modification distance) may be measure of how many operations are needed for one string and/or word to match another string and/or word. For example, a modification distance between the character string, pizca, and the word, pizza, may correspond to a distance of 1, as there is a one character difference between pizca and pizza. In some embodiments, modification distance may be a function of string length. For example, in certain implementations, a modification distance of 3 may not be acceptable for a 3-character string, but may be acceptable for a longer string as the query.

In some embodiments, the fuzzy matching metrics may include fuzzy matching metrics that take into account key distance of letters on a standard keyboard as a basis for determining likely meaning In some embodiments, a combination of edit distance and key distance may be utilized by the fuzzy matching operations to identify potential corrections. For example, key distance may be utilized first in order to identify a certain set of possibilities, and edit distance may be utilized to refine the set of possibilities and select a subset thereof.

As indicated by block 2214, a first set of candidate suggestions may be ranked and sorted based at least in part on any one or combination of bases disclosed herein. In some embodiments, the first set of candidate suggestions may be ranked and sorted based at least in part on similarity scores between the candidate suggestions and the search query and/or the refined search query. In some embodiments, the first set of candidate suggestions may be ranked and sorted based at least in part on mined data, such as mined user interest data, as disclosed herein. In some embodiments, the first set of candidate suggestions may be ranked and sorted based at least in part on other bases for assessing, scoring, and ranking suggestions as disclosed herein.

As indicated by block 2216, the first set of candidate suggestions may be refined to generate a second set of candidate suggestions. In some embodiments, the refinement of the first set of candidate suggestions may include filtering out candidate suggestions based at least in part on modification distance. Accordingly, the refinement of the first set of candidate suggestions may include filtering out candidate suggestions at least partially by comparing the modification distance between each word in the user query with the corresponding word in the suggestion and removing candidate suggestions that are very different from the search query and/or the refined search query. However, as noted above, in some embodiments, modification distance may be included in fuzzy matching metrics used in matching operations as part of the process of identifying a first set of candidate suggestions.

As indicated by block 2218, a top-ranked set of suggestions may be selected. As indicated by block 2220, autosuggestion data corresponding to the top-ranked set of suggestions may be transferred to facilitate type-ahead autosuggestions, in accordance with embodiments disclosed herein.

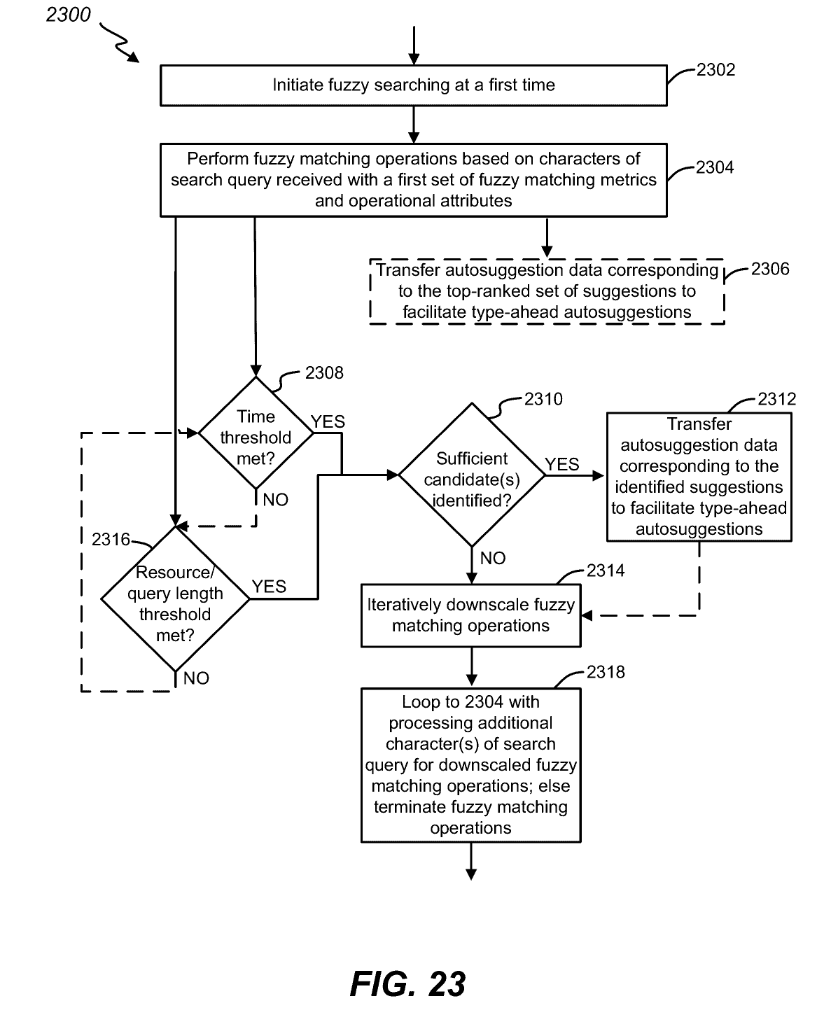

FIG. 23 illustrates an example method 2300 of fuzzy matching operational dynamics to generate geo-refined fuzzy autosuggestions for a search engine following initiation of fuzzy searching, in accordance with certain embodiments of the present disclosure. In some embodiments, the method 2300 may correspond to other aspects of autosuggestion features disclosed herein and, in some embodiments, may correspond to a subprocess of autosuggestion methods disclosed herein. For example, with certain embodiments, the method 2300 may flow from the initiation of fuzzy searching at a first time as indicated by block 2212 of the method 2100.

As indicated by block 2302, fuzzy searching may be initiated at a first time. The fuzzy searching may be triggered in a manner previously disclosed. As discussed previously, some embodiments provide for technical improvements that facilitate fuzzy autosuggestion within tight time windows. Certain embodiments may process candidate data, analyze candidate data, select candidate suggestion data sets, and transfer candidate suggestion data sets to facilitate presentation of candidate suggestions within time windows less than a couple hundred milliseconds so that the user experience is not negatively impacted. In various embodiments, the operational time windows for facilitating fuzzy autosuggestion may be approximately 100 ms, 50 ms, and/or less. With some embodiments, an average time window may be approximately 50 ms; in other embodiments, the average time window may be different.

As indicated by block 2304, the fuzzy matching operations may proceed based at least in part on the characters of the search query received and a first set of fuzzy matching metrics and operational attributes. The fuzzy matching operations may correspond to any one or combination of embodiments disclosed herein. Fuzzy match searching may typically more time-consuming than exact match searching. Similarly, fuzzy match searching may tend to be more demanding of resources. Certain embodiments balancing the extent and/or complexity of time-consuming fuzzy matching to find candidate suggestions in order to meet time constraints. In some embodiments, the system can dynamically adjust a balancing of fuzzy matching metrics and operational attributes to meet time and/or resource constraints. While in some embodiments the balancing may be dynamically adjusted in real time as the fuzzy searching operations proceed, the balancing may be predetermined in some embodiments.

The fuzzy matching metrics may include, for example, fuzzy matching conditions and thresholds. For example, a set of fuzzy matching metrics may include fuzzy distance metrics based on modification distance. In some embodiments, the fuzzy matching metrics may be particularized to a specific geolocation. Different geo-locations have different provider landscapes. For example, providers of a certain category may be prevalent in New York City, but far from prevalent in a primarily residential area. Thus, differences in geolocations may be taken into account with the fuzzy matching. In some embodiments, the geo-specific fuzzy matching metrics may be specified by a schema corresponding to a particular geolocation. The operational attributes may include, for example, candidate restrictions, a number of conditions, and/or type of conditions, such as conditions of various data processing method steps disclosed herein.

In certain instances, the fuzzy matching operations may proceed normally and autosuggestion data may be transferred within the time constraint. Thus, as indicated by block 2306, autosuggestion data corresponding to the top-ranked set of suggestions may be transferred to facilitate type-ahead auto suggestions. However, in certain instances, balancing of fuzzy matching metrics and operational attributes may be needed in order to perform within time and/or resource constraints. Such instances may correspond to situations where a threshold number of identified candidate suggestions has not been satisfied. Various embodiments may utilize various threshold numbers of identified candidate suggestions for provisioning for presentation to end users. Instances were balancing may be needed may additionally or alternatively correspond to situations where further processing of identified candidate suggestions (e.g., ranking, sorting, refining, etc.) is still ongoing and not performing within time and/or resource constraints.

As indicated by block 2308, it may be determined whether a time threshold is met. In some embodiments, the time threshold may be determined with reference to the first time when fuzzy searching was initiated. In some embodiments, the time threshold may be a predetermined trigger configured to initiate balancing of fuzzy matching metrics and operational attributes. In some embodiments, the time threshold may be determined with reference to a first time when a current character of the query string has been received and/or processed. In some embodiments, the time threshold may be determined with reference to a first time when previous autosuggestion data corresponding to a previous character of the query string was transferred. In other embodiments, the time threshold may be determined with reference to other time bases.

In various embodiments, various upper limits of the time threshold may be employed. With some cases, the upper limit may correspond to the operational time windows for facilitating fuzzy autosuggestion may be approximately 100 ms, 50 ms, and/or less. With some cases, the upper limit may correspond to time thresholds less than the operational time window limits in order to initiate balancing adjustments prior to the operational time window limits.

If the time threshold has not been met, previous fuzzy matching operations may continue. And, in certain embodiments, the process flow may transition to a resource usage check. However, consequent to a determination that the time threshold has been met, it may be determined whether sufficient candidate suggestions have been identified, as indicated by block 2310. In the case of sufficient candidate suggestions not having been identified pursuant to the determination indicated by block 2310, the flow may transition to block 2314, where fuzzy matching operations may be iteratively downscaled.

Various embodiments may employ various thresholds to determine whether sufficient candidate suggestions have been identified. In some embodiments, having at least one candidate suggestion identified is sufficient. Other embodiments may require a greater number of identified candidate suggestions. If it is been determined that sufficient candidate suggestions have been identified, autosuggestion data corresponding to the identified suggestions may be transferred to facilitate type-ahead autosuggestions, as indicated by block 2312. Such suggestions may correspond to the best-efforts results for a particular iteration of character processing, processing candidate data, analyzing candidate data, selecting candidate suggestion data sets, and transferring the selected data sets. In a set of embodiments, the flow may transition to block 2314 and fuzzy matching operations may be terminated or downscaled.

With certain embodiments, as indicated by block 2316, it may be determined whether a resource threshold and/or a query length threshold have been met. Some embodiments may employ a resource threshold that corresponds to a usage metric (e.g., a processing usage metric). Some embodiments may employ a query length threshold (e.g., a number of characters and/or a number of words). Because longer and more complicated queries require greater processing, the query length threshold could be used as a proxy for the resource threshold in certain embodiments. However, certain embodiments may employ both a resource threshold based on a usage metric and a query length threshold. If one or both of thresholds have been met, process flow may transition to block 2310. Absent a threshold being satisfied, the process may proceed normally and, in some embodiments, flow may transition to the time check.

As indicated by block 2314, fuzzy matching operations may be downscaled. The fuzzy matching operations may be downscaled at least in part by using a second set of fuzzy matching metrics and/or operational attributes, different from the first set of fuzzy matching metrics and operational attributes. As indicated by block 2318, downscaling measures could be implemented by the system iteratively until the time and/or resource constraints are satisfied. The iterative measures may include using one or more additional sets of fuzzy matching metrics and/or operational attributes, different from the first set of fuzzy matching metrics and operational attributes. In some embodiments, the downscaling measures may be implemented with the next query character reception. In some embodiments, the downscaling measures may be implemented with the current query character processing iteration, and fuzzy matching operations may continue until a subsequent user input is received. In some embodiments, fuzzy searching may simply be terminated, no fuzzy autosuggestions are generated, and the autosuggestion engine reverts back to simply exact match searching without the benefit of fuzzy searching. In some embodiments, termination may be a last resort after one or more downscaling adjustments have been made and the system still is not able to transfer fuzzy autosuggestions within the time and/or resource constraints.

The downscaling may include adjusting the operational attributes. Restrictions may be placed on the candidate sets so as to avoid introducing too many candidates. In some embodiments, the restrictions may include a quantity restriction imposed on candidate quantities. The greater the number of the candidates processed, analyzed, selected, and/or transferred is, the greater the response time is. Accordingly, certain embodiments reduce the number of candidates as a downscaling measure and consequently only identify the most likely candidates.

In some embodiments, the restrictions may include a condition restriction imposed on condition quantity and/or condition type. When matching, only a limited number of conditions may be imposed in some embodiments. Only certain types of conditions may be imposed in some embodiments. Some embodiments may impose different condition quantity restrictions on different condition types. In some embodiments, modification distance conditions, which may be a function of string length, may be adjusted to decrease required response time and resource usage.

In some embodiments, the downscaling may include utilizing a first set of fuzzy matching operations employing a first set of one or more conditions may yield a first result set and eliminating a subsequent set of post-processing operations employing another set of one or more conditions may be executed to filter out less optimal candidates. While the first result set may include less optimal candidates, the adjustment may decrease required response time and resource usage.

In some embodiments, the downscaling may include selecting a subset of the query string for fuzzy matching operations. Various embodiments may utilize various subset selection schemas. One subset selection schema may include using only completed words of the query for fuzzy matching operations, disregarding partial words that the end user in the process of completing. A subset selection schema may include using only early words in the query string, disregarding later words in the query string. Another subset selection schema may include using only the latest words in the query string. Still another subset selection schema may include using middle words in the query string. Some embodiments may change subset selection schemas with each one, two, or more added characters as the query string input progresses. Progressive subset selection schema may iteratively progress from the start of the string to the end of the string with additional query string input.

The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. Special-purpose computer systems disclosed herein include a computer-program product(s) stored in tangible computer-readable memory that directs the systems to perform the above-described methods. The systems include one or more processors that communicate with a number of peripheral devices via a bus subsystem. These peripheral devices may include user output device(s), user input device(s), communications interface(s), and a storage subsystem, such as random access memory (RAM) and non-volatile storage drive (e.g., disk drive, drive, solid state drive), which are forms of tangible computer-readable memory.

The computer-program products may be stored in non-volatile storage drive or another computer-readable medium and loaded into memory. Each processor may comprise a microprocessor, such as a microprocessor from Intel® or Advanced Micro Devices, Inc.®, or the like. To support computer-program products, the systems may run an operating system that handles the communications of the product with the noted components, as well as the communications between the noted components in support of the computer-program product. Exemplary operating systems may include Windows® or the like from Microsoft® Corporation, Solaris® from Oracle, LINUX, UNIX, and/or the like.

The communications interface(s) may provide an interface to other communication networks and devices and may serve as an interface to receive data from and transmit data to other systems, WANs and/or the Internet. Embodiments of communications interface typically include an Ethernet card, a modem (telephone, satellite, cable, ISDN), a (asynchronous) digital subscriber line (DSL) unit, a FireWire® interface, a USB® interface, a wireless network adapter, and the like. For example, the communications interface may be coupled to a computer network, to a FireWire® bus, or the like. In other embodiments, the communications interface may be physically integrated on a motherboard, and/or may be a software program, or the like.

RAM and non-volatile storage drive are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM and non-volatile storage drive may be configured to store the basic programming and data constructs that provide the functionality of various embodiments of the present invention, as described above.

Software instruction sets that provide the functionality of the present invention may be stored in RAM and non-volatile storage drive. These instruction sets or code may be executed by the processor(s). RAM and non-volatile storage drive may also provide a repository to store data and data structures used in accordance with the present invention. RAM and non-volatile storage drive may include a number of memories including a main random access memory (RAM) to store of instructions and data during program execution and a read-only memory (ROM) in which fixed instructions are stored. RAM and non-volatile storage drive may include a file storage subsystem providing persistent (non-volatile) storage of program and/or data files. RAM and non-volatile storage drive may also include removable storage systems, such as removable flash memory.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations may be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” and variations of the term may represent one or more devices for storing data, including read only memory (ROM), random access memory (RAM), magnetic RAM, core memory, magnetic disk storage mediums, optical storage mediums, flash memory devices and/or other machine readable mediums for storing information. The terms, computer-readable media, processor-readable media, and variations of the term, include, but are not limited to portable or fixed storage devices, optical storage devices, wireless channels and various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

1. A method of generating geo-aware fuzzy autosuggestions for a search engine, the method comprising:
processing a first set of transmissions from an end-user device and received by a server system, the first set of transmissions indicating a first set of characters that are received via a user interface as user input for a search query to a searching service, wherein the processing is prior to completion of the search query and prior to entry of one or more additional characters subsequent to the first set of characters;
processing information about a geographical location received by the server system and identifying a geographical area at least partially based on the information about the geographical location;
based at least in part on one or more identifiers for the geographical area, searching a data store of the server system with an exact matching method to identify exact matches of the first set of characters with candidate data from the data store for one or more geo-specific suggestions, where each geo-specific suggestion of the one or more geo-specific suggestions corresponds to one or more respective geolocations within the geographical area;
comparing results of the searching to a predetermined numeric value results threshold and, consequent to determining that the results threshold is not satisfied, initiating by the server system fuzzy searching of the data store based at least in part on the first set of characters to generate a first set of one or more geo-specific suggestions corresponding to at least one geolocation within the identified geographical area;
performing a first set of fuzzy searching operations by the server system, in response to determining that the threshold is not satisfied, based at least in part on the identifiers for the geographical area and the first set of characters, wherein the first set of fuzzy searching operations is at least partially a function of a number of characters corresponding to the search query, the first set of fuzzy searching operations comprising:
selecting, based at least in part on the number of characters corresponding to the user input for the search query, a first fuzzy matching method from a plurality of fuzzy matching methods;
searching the data store of the server system with the first fuzzy matching method to identify non-exact matches of the first set of characters with the candidate data from the data store, and, based at least in part on the non-exact matches, selecting candidate data sets corresponding to the first set of one or more geo-specific suggestions, where each geo-specific suggestion of the first set of one or more geo-specific suggestions corresponds to one or more respective geolocations within the geographical area;
ranking the candidate data sets corresponding to the first set of one or more geo-specific suggestions based at least in part on a respective modification distance between each geo-specific suggestion of first set of one or more geo-specific suggestions and the user input for the search query; and
selecting a second set of candidate data sets corresponding to a second set of one or more geo-specific suggestions based at least in part on the ranking; and
transmitting by the server system at least one geo-specific suggestion of the second set of one or more geo-specific suggestions to the end-user device to cause indication of the at least one geo-specific suggestion as a user-selectable option via the user interface to complete the search query with the at least one geo-specific suggestion in a search query field for a search engine or to submit the at least one geo-specific suggestion to the search engine as a selected search query.

2. The method of generating geo-aware fuzzy autosuggestions for the search engine of claim 1, wherein the transmitting the at least one geo-specific suggestion of the second set of one or more geo-specific suggestions to the end-user device is performed prior to entry of additional characters subsequent to the first set of characters.

3. The method of generating geo-aware fuzzy autosuggestions for the search engine of claim 1, wherein the user-selectable option is presented as a type-ahead user-selectable option in the search query field.

4. The method of generating geo-aware fuzzy autosuggestions for the search engine of claim 1, wherein the information about the geographical location corresponds to at least one of:
location information automatically gathered based at least in part on communication of a wireless device component;
user-indicated information received via the user interface as indicative of the geographical location for the search query;
location information previously associated with one or both of an end-user identifier and an end-user device identifier; and
location information inferred from the one or more characters corresponding to the search query.

5. The method of generating geo-aware fuzzy autosuggestions for the search engine of claim 1, the method further comprising:
after entry of the first set of characters, consequent to a time threshold for the server system to transmit geo-specific suggestions being satisfied, performing a second set of fuzzy searching operations by the server system based at least in part on the identifiers for the geographical area and the first set of characters, wherein the second set of fuzzy searching operations is different from first set of fuzzy searching operations;
based at least in part on the second set of fuzzy searching operations, selecting candidate data sets corresponding to a third set of one or more geo-specific suggestions; and
transmitting by the server system at least a second geo-specific suggestion of the third set of one or more geo-specific suggestions to the end-user device to cause indication of the second geo-specific suggestion as a second user-selectable option via the user interface to complete the search query with the second geo-specific suggestion in the search query field for the search engine or to submit the second geo-specific suggestion to the search engine as the selected search query.

6. The method of generating geo-aware fuzzy autosuggestions for the search engine of claim 5, the method further comprising:
after entry of a second set of characters, the second set of characters including the first set of characters, consequent to a resource threshold for the server system to transmit geo-specific suggestions being satisfied, performing a third set of fuzzy searching operations by the server system based at least in part on the identifiers for the geographical area and the second set of characters, wherein the third set of fuzzy searching operations is different from first set of fuzzy searching operations and the second set of fuzzy searching operations;
based at least in part on the third set of fuzzy searching operations, selecting candidate data sets corresponding to a fourth set of one or more geo-specific suggestions; and
transmitting by the server system at least a third geo-specific suggestion of the fourth set of one or more geo-specific suggestions to the end-user device to cause indication of the third geo-specific suggestion as a second user-selectable option via the user interface to complete the search query with the third geo-specific suggestion in the search query field for the search engine or to submit the second geo-specific suggestion to the search engine as the selected search query.

7. The method of generating geo-aware fuzzy autosuggestions for the search engine of claim 1, the method further comprising:
processing a second transmission from the end-user device and received by the server system subsequent to the first set of transmissions, the second transmission indicating an additional character received via the user interface as user input for the search query to the searching service, wherein the processing the second transmission is prior to completion of the search query and prior to entry of one or more additional characters subsequent to the additional character;
performing a second set of fuzzy searching operations by the server system based at least in part on the identifiers for the geographical area, the first set of characters, and the additional character, wherein the second set of fuzzy searching operations is at least partially a function of a second number of characters corresponding to the first set of characters and the additional character, the second set of fuzzy searching operations comprising:
selecting, based at least in part on the second number of characters, a second fuzzy matching method from the plurality of fuzzy matching methods, the second fuzzy matching method being different from the first fuzzy matching method; and
based at least in part on the second set of fuzzy searching operations and the second fuzzy matching method, selecting candidate data sets corresponding to a third set of one or more geo-specific suggestions; and
transmitting by the server system at least a second geo-specific suggestion of the third set of one or more geo-specific suggestions to the end-user device to cause indication of the second geo-specific suggestion as a second user-selectable option via the user interface to complete the search query with the second geo-specific suggestion in the search query field for the search engine or to submit the second geo-specific suggestion to the search engine as the selected search query.

8. One or more non-transitory, processor-readable media having processor-readable instructions thereon which, when executed by one or more computers or other processing devices of a server system, cause the server system to:
process a first set of transmissions from an end-user device and received by the server system, the first set of transmissions indicating a first set of characters that are received via a user interface as user input for a search query to a searching service, wherein the processing is prior to completion of the search query and prior to entry of one or more additional characters subsequent to the first set of characters;
process information about a geographical location received by the server system and identifying a geographical area at least partially based on the information about the geographical location;
based at least in part on one or more identifiers for the geographical area, search a data store of the server system with an exact matching method to identify exact matches of the first set of characters with candidate data from the data store for one or more geo-specific suggestions, where each geo-specific suggestion of the one or more geo-specific suggestions corresponds to one or more respective geolocations within the geographical area;
compare results of the searching to a predetermined numeric value results threshold and, consequent to determining that the results threshold is not satisfied, initiate by the server system fuzzy searching of the data store based at least in part on the first set of characters to generate a first set of one or more geo-specific suggestions corresponding to at least one geolocation within the identified geographical area;
perform a first set of fuzzy searching operations by the server system, in response to determining that the threshold is not satisfied, based at least in part on the identifiers for the geographical area and the first set of characters, wherein the first set of fuzzy searching operations is at least partially a function of a number of characters corresponding to the search query, the first set of fuzzy searching operations comprising:
selecting, based at least in part on the number of characters corresponding to the user input for the search query, a first fuzzy matching method from a plurality of fuzzy matching methods;
searching the data store of the server system with the first fuzzy matching method to identify non-exact matches of the first set of characters with the candidate data from the data store, and, based at least in part on the non-exact matches, selecting candidate data sets corresponding to the first set of one or more geo-specific suggestions, where each geo-specific suggestion of the first set of one or more geo-specific suggestions corresponds to one or more respective geolocations within the geographical area;
ranking the candidate data sets corresponding to the first set of one or more geo-specific suggestions based at least in part on a respective modification distance between each geo-specific suggestion of first set of one or more geo-specific suggestions and the user input for the search query; and
selecting a second set of candidate data sets corresponding to a second set of one or more geo-specific suggestions based at least in part on the ranking; and
transmit by the server system at least one geo-specific suggestion of the second set of one or more geo-specific suggestions to the end-user device to cause indication of the at least one geo-specific suggestion as a user-selectable option via the user interface to complete the search query with the at least one geo-specific suggestion in a search query field for a search engine or to submit the at least one geo-specific suggestion to the search engine as a selected search query.

9. The one or more non-transitory, processor-readable media of claim 8, wherein the transmitting the at least one geo-specific suggestion of the second set of one or more geo-specific suggestions to the end-user device is performed prior to entry of additional characters subsequent to the first set of characters.

10. The one or more non-transitory, processor-readable media of claim 8, wherein the user-selectable option is presented as a type-ahead user-selectable option in the search query field.

11. The one or more non-transitory, processor-readable media of claim 8, wherein the information about the geographical location corresponds to at least one of:
location information automatically gathered based at least in part on communication of a wireless device component;
user-indicated information received via the user interface as indicative of the geographical location for the search query;
location information previously associated with one or both of an end-user identifier and an end-user device identifier; and
location information inferred from the one or more characters corresponding to the search query.

12. The one or more non-transitory, processor-readable media of claim 8, the processor-readable instructions further causing the server system to:
after entry of the first set of characters, consequent to a time threshold for the server system to transmit geo-specific suggestions being satisfied, perform a second set of fuzzy searching operations by the server system based at least in part on the identifiers for the geographical area and the first set of characters, wherein the second set of fuzzy searching operations is different from first set of fuzzy searching operations;
based at least in part on the second set of fuzzy searching operations, select candidate data sets corresponding to a third set of one or more geo-specific suggestions; and
transmit by the server system at least a second geo-specific suggestion of the third set of one or more geo-specific suggestions to the end-user device to cause indication of the second geo-specific suggestion as a second user-selectable option via the user interface to complete the search query with the second geo-specific suggestion in the search query field for the search engine or to submit the second geo-specific suggestion to the search engine as the selected search query.

13. The one or more non-transitory, processor-readable media of claim 12, the processor-readable instructions further causing the server system to:
after entry of a second set of characters, the second set of characters including the first set of characters, consequent to a resource threshold for the server system to transmit geo-specific suggestions being satisfied, perform a third set of fuzzy searching operations by the server system based at least in part on the identifiers for the geographical area and the second set of characters, wherein the third set of fuzzy searching operations is different from first set of fuzzy searching operations and the second set of fuzzy searching operations;
based at least in part on the third set of fuzzy searching operations, select candidate data sets corresponding to a fourth set of one or more geo-specific suggestions; and
transmit by the server system at least a third geo-specific suggestion of the fourth set of one or more geo-specific suggestions to the end-user device to cause indication of the third geo-specific suggestion as a second user-selectable option via the user interface to complete the search query with the third geo-specific suggestion in the search query field for the search engine or to submit the second geo-specific suggestion to the search engine as the selected search query.

14. The one or more non-transitory, processor-readable media of claim 8, the processor-readable instructions further causing the server system to:
process a second transmission from the end-user device and received by the server system subsequent to the first set of transmissions, the second transmission indicating an additional character received via the user interface as user input for the search query to the searching service, wherein the processing the second transmission is prior to completion of the search query and prior to entry of one or more additional characters subsequent to the additional character;
perform a second set of fuzzy searching operations by the server system based at least in part on the identifiers for the geographical area, the first set of characters, and the additional character, wherein the second set of fuzzy searching operations is at least partially a function of a second number of characters corresponding to the first set of characters and the additional character, the second set of fuzzy searching operations comprising:
select, based at least in part on the second number of characters, a second fuzzy matching method from the plurality of fuzzy matching methods, the second fuzzy matching method being different from the first fuzzy matching method; and
based at least in part on the second set of fuzzy searching operations and the second fuzzy matching method, select candidate data sets corresponding to a third set of one or more geo-specific suggestions; and
transmit by the server system at least a second geo-specific suggestion of the third set of one or more geo-specific suggestions to the end-user device to cause indication of the second geo-specific suggestion as a second user-selectable option via the user interface to complete the search query with the second geo-specific suggestion in the search query field for the search engine or to submit the second geo-specific suggestion to the search engine as the selected search query.

15. A system to generate geo-aware fuzzy autosuggestions for a search engine, the system comprising:
a server system comprising one or more servers communicatively coupled to one or more network interfaces to facilitate access to a network, the server system comprising one or more data stores communicatively coupled to the one or more servers, the one or more data stores storing candidate data for geo-specific suggestions, the one or more servers to:
process a first set of transmissions from an end-user device and received by a server system, the first set of transmissions indicating a first set of characters that are received via a user interface as user input for a search query to a searching service, wherein the processing is prior to completion of the search query and prior to entry of one or more additional characters subsequent to the first set of characters;
process information about a geographical location received by the server system and identifying a geographical area at least partially based on the information about the geographical location;
based at least in part on one or more identifiers for the geographical area, search the one or more data stores with an exact matching method to identify exact matches of the first set of characters with the candidate data from the data store for one or more geo-specific suggestions, where each geo-specific suggestion of the one or more geo-specific suggestions corresponds to one or more respective geolocations within the geographical area;
compare results of the searching to a predetermined numeric value results threshold and, consequent to determining that the results threshold is not satisfied, initiating fuzzy searching of the data store based at least in part on the first set of characters to generate a first set of one or more geo-specific suggestions corresponding to at least one geolocation within the identified geographical area;
perform a first set of fuzzy searching operations, in response to determining that the threshold is not satisfied, based at least in part on the identifiers for the geographical area and the first set of characters, wherein the first set of fuzzy searching operations is at least partially a function of a number of characters corresponding to the search query, the first set of fuzzy searching operations comprising:
selecting, based at least in part on the number of characters corresponding to the user input for the search query, a first fuzzy matching method from a plurality of fuzzy matching methods;
searching the data store of the server system with the first fuzzy matching method to identify non-exact matches of the first set of characters with the candidate data from the data store, and, based at least in part on the non-exact matches, selecting candidate data sets corresponding to the first set of one or more geo-specific suggestions, where each geo-specific suggestion of the first set of one or more geo-specific suggestions corresponds to one or more respective geolocations within the geographical area;
ranking the candidate data sets corresponding to the first set of one or more geo-specific suggestions based at least in part on a respective modification distance between each geo-specific suggestion of first set of one or more geo-specific suggestions and the user input for the search query; and
selecting a second set of candidate data sets corresponding to a second set of one or more geo-specific suggestions based at least in part on the ranking; and
transmitting at least one geo-specific suggestion of the second set of one or more geo-specific suggestions to the end-user device to cause indication of the at least one geo-specific suggestion as a user-selectable option via the user interface to complete the search query with the at least one geo-specific suggestion in a search query field for a search engine or to submit the at least one geo-specific suggestion to the search engine as a selected search query.

16. The system to generate geo-aware fuzzy autosuggestions for the search engine of claim 15, wherein the transmitting the at least one geo-specific suggestion of the second set of one or more geo-specific suggestions to the end-user device is performed prior to entry of additional characters subsequent to the first set of characters.

17. The system to generate geo-aware fuzzy autosuggestions for the search engine of claim 15, wherein the user-selectable option is presented as a type-ahead user-selectable option in the search query field.

18. The system to generate geo-aware fuzzy autosuggestions for the search engine of claim 15, wherein the information about the geographical location corresponds to at least one of:
location information automatically gathered based at least in part on communication of a wireless device component;
user-indicated information received via the user interface as indicative of the geographical location for the search query;
location information previously associated with one or both of an end-user identifier and an end-user device identifier; and location information inferred from the one or more characters corresponding to the search query.

19. The system to generate geo-aware fuzzy autosuggestions for the search engine of claim 15, the server system further to:
after entry of the first set of characters, consequent to a time threshold for the server system to transmit geo-specific suggestions being satisfied, perform a second set of fuzzy searching operations based at least in part on the identifiers for the geographical area and the first set of characters, wherein the second set of fuzzy searching operations is different from first set of fuzzy searching operations;
based at least in part on the second set of fuzzy searching operations, select candidate data sets corresponding to a third set of one or more geo-specific suggestions; and
transmit at least a second geo-specific suggestion of the third set of one or more geo-specific suggestions to the end-user device to cause indication of the second geo-specific suggestion as a second user-selectable option via the user interface to complete the search query with the second geo-specific suggestion in the search query field for the search engine or to submit the second geo-specific suggestion to the search engine as the selected search query.

20. The system to generate geo-aware fuzzy autosuggestions for the search engine of claim 19, the server system further to:
after entry of a second set of characters, the second set of characters including the first set of characters, consequent to a resource threshold for the server system to transmit geo-specific suggestions being satisfied, perform a third set of fuzzy searching operations based at least in part on the identifiers for the geographical area and the second set of characters, wherein the third set of fuzzy searching operations is different from first set of fuzzy searching operations and the second set of fuzzy searching operations;
based at least in part on the third set of fuzzy searching operations, select candidate data sets corresponding to a fourth set of one or more geo-specific suggestions; and
transmit at least a third geo-specific suggestion of the fourth set of one or more geo-specific suggestions to the end-user device to cause indication of the third geo-specific suggestion as a second user-selectable option via the user interface to complete the search query with the third geo-specific suggestion in the search query field for the search engine or to submit the second geo-specific suggestion to the search engine as the selected search query.

21. The method of claim 1, wherein prior to performing the first set of fuzzy searching operations, the method further comprises:
comparing the results of the searching to a predefined linguistic threshold corresponding to a predetermined number of predefined invalid words and, consequent to determining that the predefined linguistic threshold is satisfied, transfer autosuggestion data corresponding to the results of the searching to facilitate type-ahead autosuggestions.

22. The one or more non-transitory, processor-readable media of claim 8, wherein prior to perform the first set of fuzzy searching operations, the processor-readable instructions further causing the server system to:
compare the results of the searching to a predefined linguistic threshold corresponding to a predetermined number of predefined invalid words and, consequent to determining that the predefined linguistic threshold is satisfied, transfer autosuggestion data corresponding to the results of the searching to facilitate type-ahead autosuggestions.

23. The system to generate geo-aware fuzzy autosuggestions for the search engine of claim 15, wherein prior to perform the first set of fuzzy searching operations, the server system further to:
compare the results of the searching to a predefined linguistic threshold corresponding to a predetermined number of predefined invalid words and, consequent to determining that the predefined linguistic threshold is satisfied, transfer autosuggestion data corresponding to the results of the searching to facilitate type-ahead autosuggestions.
